(19) United States
(12) Patent Application Publication
(10) Pub. No.: US 2011/0082744 A1
(43) Pub. Date: Apr. 7, 2011

(54) OPTICAL DISK REPRODUCING DEVICE AND REPRODUCING METHOD

(76) Inventors: Hiromi Iida, Osaka (JP); Yuzo Kawamura, Osaka (JP); Shohji Ohtsubo, Osaka (JP); Rinako Kamei, Osaka (JP); Renji Honda, Nara (JP)

(21) Appl. No.: 12/996,850

(22) PCT Filed: Jun. 5, 2009
(86) PCT No.: PCT/JP2009/002540

§ 371 Date: Dec. 8, 2010

(30) Foreign Application Priority Data
Jun. 17, 2008 (JP) 2008-157736

(51) Int. Cl. G06Q 30/00

(52) U.S. Cl. 705/14.53; 705/14.4

(57) ABSTRACT

A playback device has a function of playing back, at the time of playing back a playlist from an optical disc, a playitem that is different from a playitem representing an advertisement and embedded in the playlist. In the playback device, a supplying unit holds a desired playitem therein and supplies a requested one of the desired playitem and a playitem that is contained in a playlist stored on an optical disc. A playback unit plays back the playitem supplied from the supplying unit. A judging unit reads playlist information from the optical disc and judges whether or not the playlist information includes a playitem representing an advertisement. If such a playitem is included, a playback path replacing unit rewrites the playlist information to replace the playitem representing the advertisement with playitem representing the desired playitem. A playback target request unit selects a playitem to be played back according to the replaced playlist information and requests the supplying unit to supply the selected playitem.

### TECHNICAL FIELD

The present invention relates to a technology for playing back content such as video content and audio content from an optical disc such as a BD-ROM.

### BACKGROUND ART

The technology for real-time playback of moving images such as a movie via networks is rapidly becoming widespread, with the improvement in the technology for data distribution via a wide area network such as the Internet. On the other hand, the quality of video images is more and more enhanced, and in recent years, the development relating to stereoscopic video images is underway. Real-time playback of content of such video images via networks is not yet practical in view of the currently available bandwidths of the networks. Accordingly, it is considered that recording movie contents of high-definition or stereoscopic images on optical discs such as non-rewritable Blu-ray discs (BD-ROM discs), i.e., media packages, remains the mainstream method for selling/distributing the movie contents by movie companies, for example.

Note that content distributed over networks generally includes an advertisement. In addition, details of the advertisement may vary each time the content is distributed. In that case, either of a server device and a client terminal may select details of the advertisement. (See for example Patent Literature 1 and 2.)

Similarly, content such as a movie recorded on media packages to be sold or distributed generally includes an advertisement. Such advertisements include, for example, an advertisement for media packages of another movie or for a movie being released. An advertisement is embedded in part of movie content or the like in the form of sounds, video images, or subtitles. Specifically, the content is recorded in the form of a “playlist” in a media package. When the media package is a BD-ROM disc, the playlist includes a combination of a clip AV stream and movie playlist information. The clip AV stream includes a digital stream representing video images/sounds. The playlist information defines a playback path of the clip AV stream and generally includes a plurality of pieces of playback section information, i.e., playitem information. Each piece of playitem information indicates a portion of the clip AV stream that is to be actually played back. In a playlist, a portion containing a combination of playitem information and a corresponding portion of a clip AV stream is referred to as a “playitem”. To play back a playlist from a media package is to sequentially play back playitems included in the playlist by sequentially referencing the pieces of playitem information included in the playlist information. Therefore, an advertisement is embedded in a media package as one playitem in a playlist.

### CITATION LIST

### Patent Literature

[Patent literature 1] JP patent application publication No. 2005-209098
[Patent literature 2] JP patent application publication No. 2007-536763

### SUMMARY OF INVENTION

### Technical Problem

Generally when an advertisement embedded in a playlist such as a movie is of more interest to viewers of the playlist, the advertisement is expected to involve a lower risk of disturbing the entertaining effect of the playlist and achieve a higher advertising effect. The level of the viewers' interest in the advertisement generally varies with factors such as the relevance of the advertisement to the playlist, the preferences of the viewers, the numbers of times the viewers have watched the playlist, and the viewing environments. It is therefore preferable that a playitem representing an advertisement (which may also be referred to as “advertisement playitem”) to be embedded in a playlist is selectable depending on such factors.

However, unlike the technology for playing back content via networks, conventional technologies for playing back a playlist from a media package cannot change an advertisement playitem embedded in the playlist to a different playitem. Accordingly, the technologies cannot reduce the possibility that an advertisement of low interest to the viewer is played back when the playlist is played back. As a result, it is difficult to further reduce the risk that insertion of an advertisement disturbs the entertaining effect of the playlist. It is also difficult to further improve the advertising effect of the advertisement.

An object of the present invention is to provide a playback device that, when playing back a playlist from an optical disc, can play back a playitem different from an advertisement playitem embedded in the playlist.

### Solution to Problem

The playback device according to one embodiment of the present invention comprises a supplying unit, a playback unit, a judging unit, a playback path replacing unit, and a playback target request unit. The supplying unit holds a desired playitem therein and supplies a requested one of the desired playitem and a playitem that is contained in a playlist stored on an optical disc. The playback unit plays back the playitem supplied from the supplying unit. The judging unit reads first playback path information defining a playback path of the playlist from the optical disc and judges whether or not the first playback path information includes playback section information for a playitem representing an advertisement. The playback path replacing unit performs a playback section rewriting process when the judging unit judges affirmatively. The playback section rewriting process involves rewriting the playback section information for the playitem representing the advertisement with playback section information for the desired playitem, so that the first playback path information is replaced with second playback path information. The playback target request unit selects a playitem to be played back according to the second playback path information and requests the supplying unit to supply the selected playitem as the requested playitem.

### ADVANTAGEOUS EFFECTS OF INVENTION

When playing back a playlist from an optical disc, the playback device according to the present invention can play back a desired playitem during the playback section of an advertisement playitem embedded in the playlist. Accordingly, embedding, for example, an advertisement playitem that is more relevant to the playlist as the desired playitem, can reduce the possibility that an advertisement of low interest to viewers is played back when the playlist is played back. As a result, the playback device of the present invention can further reduce the risk that insertion of an advertisement disturbs the entertaining effect of the playlist. Furthermore, the playback device of the present invention can also improve the advertising effect of the advertisement.

### BRIEF DESCRIPTION OF DRAWINGS

FIG. 1 is a schematic view showing a usage pattern of an optical disc and a playback device for the optical disc, according to Embodiment 1 of the present invention.

FIG. 2 is a schematic view showing the structure of data recorded on a BD-ROM disc shown in FIG. 1.

FIG. 3 is a schematic view showing the data structure of an index file shown in FIG. 2.

FIGS. 4A, 4B, and 4C are schematic views showing the data structures of a movie object file, a BD-J object file, and a service object file shown in FIG. 2, respectively.

FIG. 5A is a schematic view showing in the order of playback time a plurality of elementary streams constituting an AV clip file shown in FIG. 2, and FIG. 5B is a schematic view showing in the order of playback time a text subtitle stream constituting another AV clip file shown in FIG. 2.

FIG. 6 is a schematic view showing the arrangement of TS packets of the respective elementary streams included in the AV clip file shown in FIG. 2.

FIG. 7 is a schematic view showing the arrangement of video frames in the sequence of PES packets converted from a video stream shown in FIG. 6.

FIG. 8 is a schematic view showing the formats of each TS packet and source packet shown in FIG. 6.

FIG. 9 is a schematic view showing the data structure of a clip information file shown in FIG. 2.

FIG. 10 is a schematic view showing the data structure of stream attribute information shown in FIG. 9.

FIG. 11A is a schematic view showing the data structure of mark table information shown in FIG. 9, and FIG. 11B is a schematic view showing source packets of the AV clip file each having an SPN associated with an M_ID by clip mark information shown in FIG. 11A.

FIG. 12 is a schematic view showing the data structure of a playlist file shown in FIG. 2.

FIG. 13 is a schematic view showing the data structure of playitem information shown in FIG. 12.

FIG. 14 is a schematic view showing portions of the AV clip file to be played back according to the main path and two sub-paths defined by playlist information shown in FIG. 12.

FIG. 15A is a schematic view showing the data structure of playlist mark information shown in FIG. 12, and FIG. 15B is a schematic view showing playitems specified by a playlist mark shown in FIG. 15A.

FIG. 16 is a block diagram showing the hardware structure of the playback device according to Embodiment 1 of the present invention.

FIG. 17A is a schematic view showing the directory structure of an update kit stored in a local storage shown in FIG. 16, and FIG. 17B is a schematic view showing the data structure of a merge management information file shown in FIG. 17A.

FIG. 18 is a functional block diagram showing a system LSI shown in FIG. 16.

FIG. 19 is a schematic view showing the process of creating a virtual package by a virtual file control unit shown in FIG. 18.

FIG. 20 is a functional block diagram showing a playback control unit shown in FIG. 18.

FIG. 21 is a block diagram showing a system target decoder shown in FIG. 18.

FIG. 22 is a flowchart of the playback process of a playlist according to Embodiment 1 of the present invention.

FIG. 23 is a flowchart of the process of rewriting an advertisement playitem; the process is performed in Step S4 shown in FIG. 22.

FIG. 24 is a table that shows the correspondence between content IDs and advertisement IDs and is stored in a server device shown in FIG. 1.

FIG. 25A is a schematic view showing a playlist that is played back in Step S5 after Step S4 is skipped in the flowchart shown in FIG. 22, and FIG. 25B is a schematic view showing a playlist that is played back in Step S5 after a virtual package is created in Step S4 in the flowchart.

FIG. 26 is a flowchart of the process of replacing an advertisement playitem, according to Embodiment 2 of the present invention.

FIG. 27 is a flowchart showing the process of rewriting playitem information; the process is performed in Step S50 shown in FIG. 26.

FIG. 28A is a schematic view showing a playlist that is played back in Step S5 after Step S4 is skipped in the flowchart shown in FIG. 26, and FIG. 28B is a schematic view showing a playlist that is played back in Step S5 after a virtual package is created in Step S4 in the flowchart.

FIG. 29 is a flowchart of the playback process of a playlist according to Embodiment 3 of the present invention.

FIG. 30A is a table showing a playback history recorded in Step S53 shown in FIG. 29, FIG. 30B is a table showing the total usage hours calculated from the playback history for each coding method of audio data, and FIG. 30C is a table showing the total usage hours calculated from the playback history for each language of audio/subtitles.

FIG. 31 is a flowchart of the process of replacing an advertisement playitem, according to Embodiment 3 of the present invention.

FIG. 32 is a schematic view showing data exchange between the server device and the playback device performed in Steps S41-S47 shown in FIG. 31.

FIG. 33 is a functional block diagram of an authoring device according to Embodiment 4 of the present invention and showing functions relating to disc image creation for BD-ROM disc.

FIG. 34 is a flowchart of a process of disc image creation for a BD-ROM disc, according to Embodiment 4 of the present invention.

FIG. 35 is a functional block diagram of an authoring device according to Embodiment 4 of the present invention and showing functions relating to creation of an update kit.

FIG. 36 is a flowchart of a process of creating an update kit, according to Embodiment 4 of the present invention.

### DESCRIPTION OF EMBODIMENTS

The following describes preferred embodiments of the present invention, with reference to the drawings.

### Embodiment 1

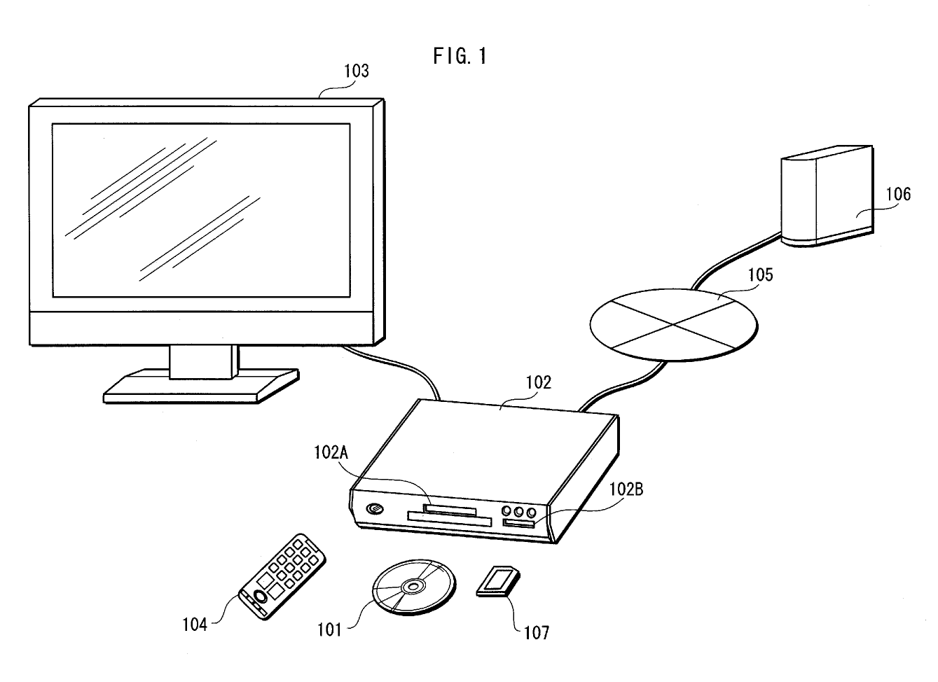

FIG. 1 is a schematic view showing a usage pattern of an optical disc and a playback device for the optical disc, according to Embodiment 1 of the present invention. In FIG. 1, a BD-ROM disc 101 is an optical disc according to Embodiment 1 of the present invention, and a playback device 102 according to Embodiment 1 of the present invention constitutes a home theater system with a display 103 and a remote control 104. To reproduce on the display 103 a playlist such as a movie recorded on the BD-ROM disc 101, the BD-ROM disc 101 is inserted into a BD-ROM drive 102A of the playback device 102. Then, the playback device 102 and the display 103 are remotely controlled by a user via the remote control 104. In accordance with user operations, the playback device 102 plays back a playlist from the BD-ROM disc 101 and supplies the playback to the display 103. Note that the optical disc according to the present invention may be a non-rewritable optical disc of a format different from the BD-ROM disc 101. One example of such an alternative optical disc is a BD-R.

Furthermore, the playback device 102 can communicate via a network 105, such as the Internet, with a server device 106 located on the network 105. Additionally, the playback device 102 may include a card reader 102B for a memory card 107. The playback device 102 reads an update kit for the BD-ROM disc 101 from the server device 106 or the memory card 107. The update kit is composed of data to be used as replacement for the data on the BD-ROM disc 101. Specifically, the update kit includes a playitem representing a new advertisement to be used as replacement for an advertisement playitem recorded on the BD-ROM disc 101. At the time of playing back a playlist from the BD-ROM disc 101, the playback device 102 uses the update kit to conduct a process of replacing the advertisement playitem recorded on the BD-ROM disc 101 with the new advertisement playitem. The replacement process will be described later in detail.

### <Structure of Data on BD-ROM Disc 101>

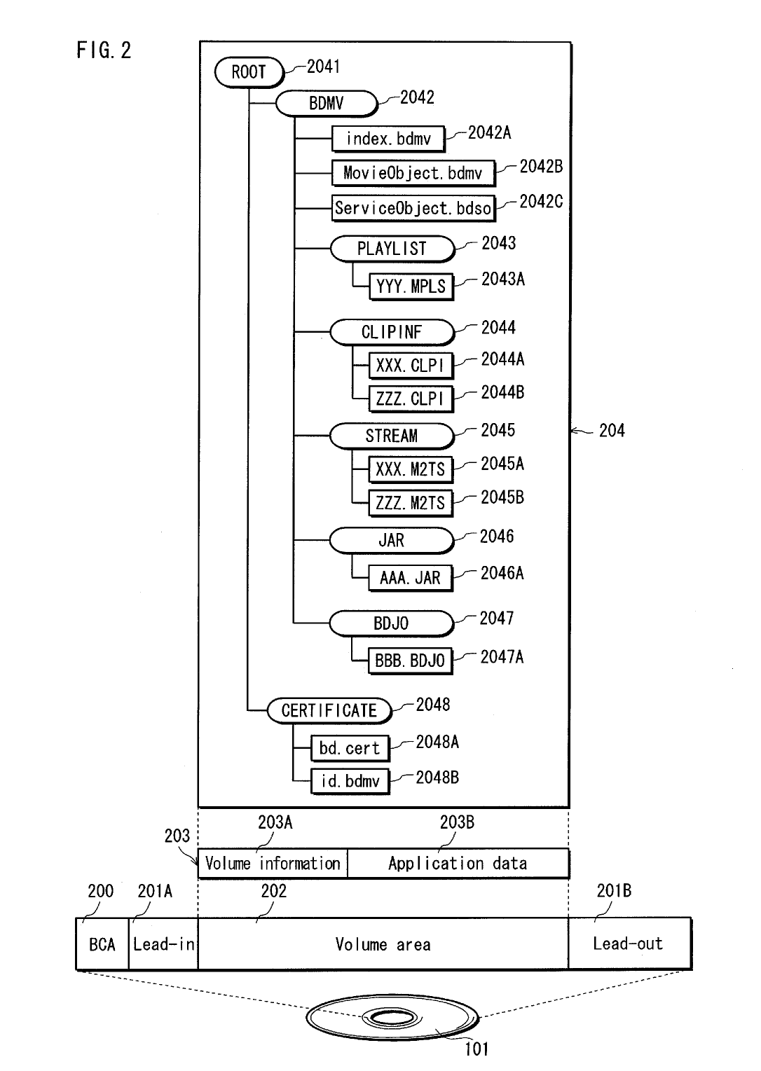

FIG. 2 is a schematic view showing the structure of data recorded on the BD-ROM disc 101. As shown in FIG. 2, the data recording area of the BD-ROM disc 101 includes a BCA (Burst Cutting Area) 200, a lead-in area 201A, a volume area 202 and a lead-out area 201B. These data recording areas are contiguously formed to spiral from the inner to outer circumference of the BD-ROM disc 101. In FIG. 2, however, the data recording areas are illustrated to extended in a lateral direction, with the inner circumference of the BD-ROM disc 101 located on the left side and the outer circumference on the right side. The BCA 200 is provided at the innermost part of the BD-ROM disc 101. The BCA 200 is accessible only by the BD-ROM drive 102A of the playback device 102 and any access from application programs is prohibited. The BCA 200 can thus be used for copyright protection, for example. The lead-in area 201A is provided immediately on the outside edge of the BCA 200. The lead-in area 201A includes information necessary for accessing the volume area 202, such as the size, the physical address, etc. of the data recorded in the volume area 202. The lead-out area 201B is provided on the outermost circumferential part of the BD-ROM disc 101 and indicates the end of the volume area 202. The volume area 202 is provided between the lead-in area 201A and the lead-out area 201B. In the volume area 202, application data such as video and audio data is recorded.

In the file system for the volume area 202, the volume area 202 is managed as one logical address space 203. In the logical address space 203, volume information 203A and the application data 203B are recorded in the stated order from the top. In the file system, pieces of data recorded in the volume area 202 are represented in directories or files. In the case of the BD-ROM disc 101, the pieces of data are represented in UDF (Universal Disc Format). The use of UDF enables typical personal computers (PCs) to access data on the BD-ROM disc 101 in files and directories, in the same manner to access a file system such as FAT or NTFS.

FIG. 2 also shows the directory structure 204 of data recorded in the volume area 202. In the directory structure 204, a BDMV directory 2042 and a CERTIFICATE directory 2048 are located immediately below the root (ROOT) directory 2041. The BDMV directory 2042 stores data, such as video and audio contents (hereinafter, abbreviated as “AV contents”) or management information. The CERTIFICATE directory 2048 stores data related to authentication of data recorded on the BD-ROM disc 101.

The BDMV directory 2042 also stores an index file (index.bdmv) 2042A, a movie object file (MovieObject.bdmv) 2042B, and a service object file (ServiceObject.bdso) 2042C. Additionally, the BDMV directory 2042 includes a PLAYLIST directory 2043, a CLIPINF directory 2044, a STREAM directory 2045, a JAR directory 2046 and a BDJO directory 2047. The PLAYLIST directory 2043 stores a playlist file (YYY.MPLS) 2043A. The CLIPINF directory 2044 stores clip information files (XXX.CLPI and ZZZ.CLPI) 2044A and 2044B. The STREAM directory 2045 stores AV clip files (XXX.M2TS and ZZZ.M2TS) 2045A and 2045B. The JAR directory 2046 stores a JAR file (AAA.JAR) 2046A. The BDJO directory 2047 stores a BD-J object file (BBB.BDJO) 2047A.

The CERTIFICATE directory 2048 stores a merge certificate (bd.cert) 2048A and an ID file (id.bdmv) 2048B. The merge certificate 2048A includes a public key assigned to the provider, such as a movie company, of an AV content recorded on the BD-ROM disc 101. The file format of the merge certificate 2048A may be X.509. The ID file 2048B includes Org ID (Organization ID) and Disc ID. Org ID is a 32-bit identifier uniquely assigned to the provider of the BD-ROM disc 101. Org ID is a 128-bit identifier uniquely assigned to the provider of the BD-ROM disc 101.

The following now describes the data structure of files 2042A-2042C, 2043A, 2044A, 2044B, 2045A, 2045B, 2046A and 2047A stored in the BDMV directory 2042 and its sub-directories 2043-2047.

<Index File (Index.bdmv) 2042A>

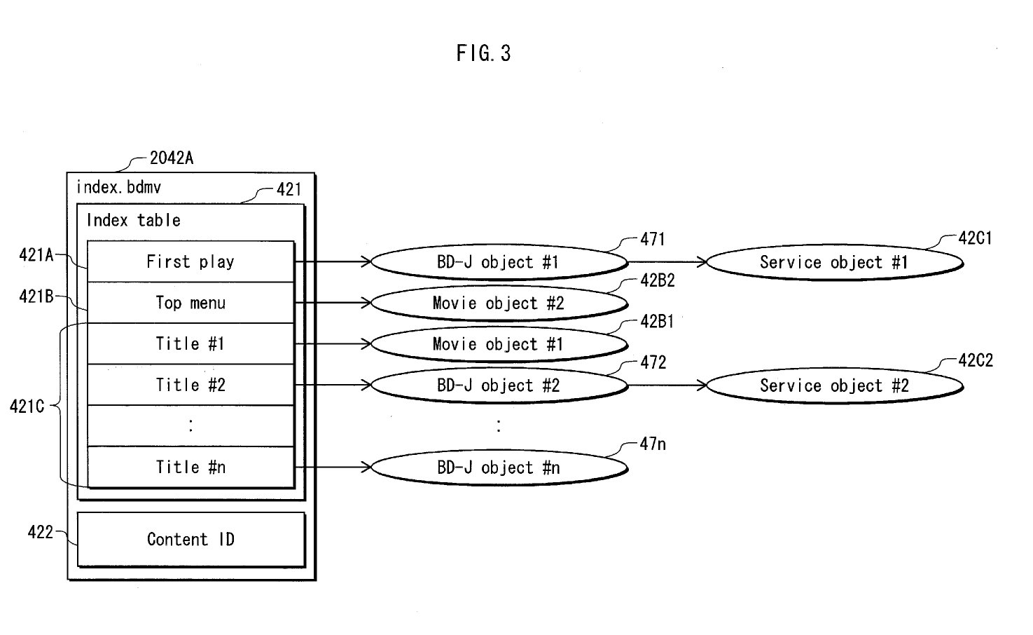

FIG. 3 is a schematic view showing the data structure of the index file 2042A. As shown in FIG. 3, the index file 2042A includes an index table 421 and a content ID 422.

The index table 421 includes such items as titles 421C, top menu 421B, and first play 421A. Each of the items 421A, 421B and 421C defines a “title” recorded on the BD-ROM disc 101. More specifically, each of the items 421A, 421B and 421C specifies the ID of a movie object 42B1 or 42B2 or the file name of a BD-J object file 2047A that includes BD-J objects 471, 472 or 47n. During playback of the BD-ROM disc 101, each time a title or menu is called by a user operation or an application program, the control unit of the playback device 102 references a corresponding item of the index table 421 and calls one of the objects 42B1, 42B2, 471, 472 and 47n specified by the item. Furthermore, the control unit executes a program according to the object called. In this manner, the playback device 102 implements various functions including playback of an AV content from the BD-ROM disc 101.

The first play 421A is set by the content provider, and the first item referenced by the control unit when the BD-ROM disc 101 is inserted into the playback device 102. Accordingly, the first play 421A specifies a movie object or BD-J object #1 471 corresponding to a program to be automatically executed upon the insertion of the BD-ROM disc 101. The top menu 421B is referenced by the control unit, for example, when a user operates the remote control 104 to enter the command “go back to menu” into the playback device 102. Accordingly, the top menu 421B specifies a movie object #2 42B2 or BD-J object to be called in response to the command. Each title 421C is referenced by the control unit, for example, when the user operates the remote control 104 to enter the title name of an AV content to be played back into the playback device 102. Accordingly, each title 421C specifies a movie object #1 42B1 or BD-J object 472 or 47n to be used to implement the function of playing back a specific AV content from the BD-ROM disc 101.

The movie objects 42B1 and 42B2 and the BD-J objects 471, 472 and 47n may be so described that the control unit of the playback device 102 calls a service object 42C1 or 42C2. The control unit then executes the service object 42C1 or 42C2, thus replacing an advertisement playitem embedded in an AV content to be played back according to the movie object 42B1 or 42B2 or BD-J object 471 or 472, with a new advertisement playitem included in an update kit.

The content ID 422 is recorded in an area in the index file 2042A; the area is freely usable by the provider of the AV content recorded on the BD-ROM disc 101, such as a movie company. The content ID 422 is an identifier for the AV content.

<Movie Object File (MovieObject.bdmv) 2042B>

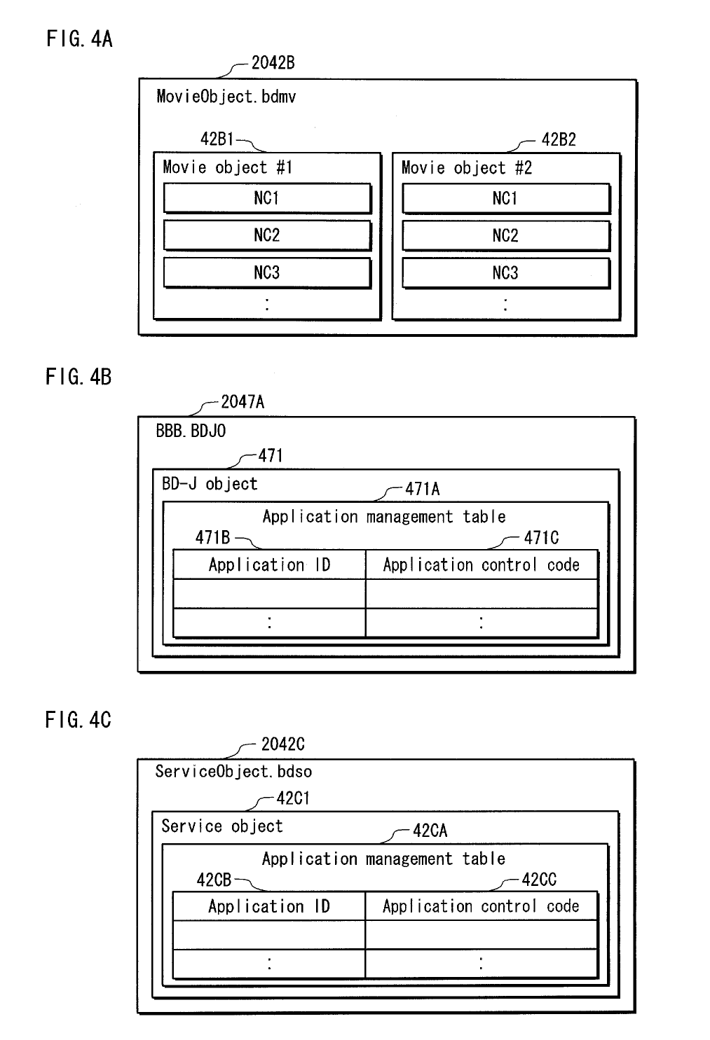

FIG. 4A is a schematic view showing the data structure of the movie object file 2042B. As shown in FIG. 4A, the movie object file 2042B generally includes a plurality of movie objects 42B1 and 42B2. Each of the movie objects 42B1 and 42B2 is identified by a unique movie object ID. Each of the movie objects 42B1 and 42B2 includes a sequence of navigation commands NC1, NC2 and NC3. Each of the navigation commands NC1, NC2 and NC3 is an instruction for causing the control unit of the playback device 102 to execute a playback process of a playlist or a transition process to another title by, for example, issuing a call to another movie object 42B1 or 42B2. Upon calling the movie object 42B1 or 42B2, the control unit sequentially executes the sequence of navigation commands NC1, NC2 and NC3 included in the movie object called. For example, if the navigation command NC1 at the top of the sequence is “PlayPL#N”, the control unit selects the playlist file 2043A which corresponds to “#N” from the PLAYLIST directory 2043 and plays back a playlist corresponding to the selected file. For example, when the next navigation command NC2 is “JumpObject#2”, the control unit selects the movie object #2 42B2 identified by the movie object ID matching “#2”, from the movie object file 2042B.

### <BD-J Object File (BBB.BDJO) 2047A>

FIG. 4B is a schematic view showing the data structure of the BD-J object file 2047A. As shown in FIG. 4B, the BD-J object file 2047A includes a single BD-J object 471. The BD-J object 471 includes an application management table 471A. The application management table 471A includes data necessary to implement signaling by a BD-J application program on the platform of the playback device 102 during playback of the BD-ROM disc 101. Note that examples of BD-J application programs include: one for causing the playback device 102 to execute playlist playback according to the playlist file 2043A; one for causing the playback device to access e.g. the network 105; and one for causing the display 103 to display graphics independently of display of the playlist to present multi-functional GUIs.

As shown in FIG. 4B, the application management table 471A includes application IDs 471B and application control codes 471C. An application ID 471B is the identifier of a BD-J application program to be executed. An application control code 471C indicates the control conditions for activating the BD-J application program specified by the application ID 471B. For example, the application control code 471C defines the initial state of the BD-J application program to be executed first when the BD-J object 471 is called by the control unit in response to selection of a title. The application control code 471C also defines whether the BD-J application program to be executed is to be automatically started (AUTOSTART) or not (PRESENT) upon being loaded to a virtual machine implemented in the playback device 102.

<Service Object File (ServiceObject.bdso) 2042C>

FIG. 4C is a schematic view showing the data structure of the service object file 2042C. As shown in FIG. 4C, the service object file 2042C includes a single service object 42C1. The service object 42C1 has a common format with the BD-J object 471 shown in FIG. 4B and includes an application management table 42CA. The application management table 42CA includes an application ID 42CB and application control code 42CC, which are similar to the application ID 471B and the application control codes 471C shown in FIG. 4B. BD-J application programs specified in the application management table 42CA particularly include those for causing the virtual machine to execute the following processes: (1) detecting an advertisement playitem from a playlist recorded on the BD-ROM disc 101; (2) downloading an update kit for the BD-ROM disc 101 from the server device 106 located on the network 105 or from an external storage device such as the memory card 107; and (3) replacing the detected advertisement playitem with a new advertisement playitem included in the update kit.

### <AV Clip File (XXX.M2TS and ZZZ.M2TS) 2045A and 2045B>

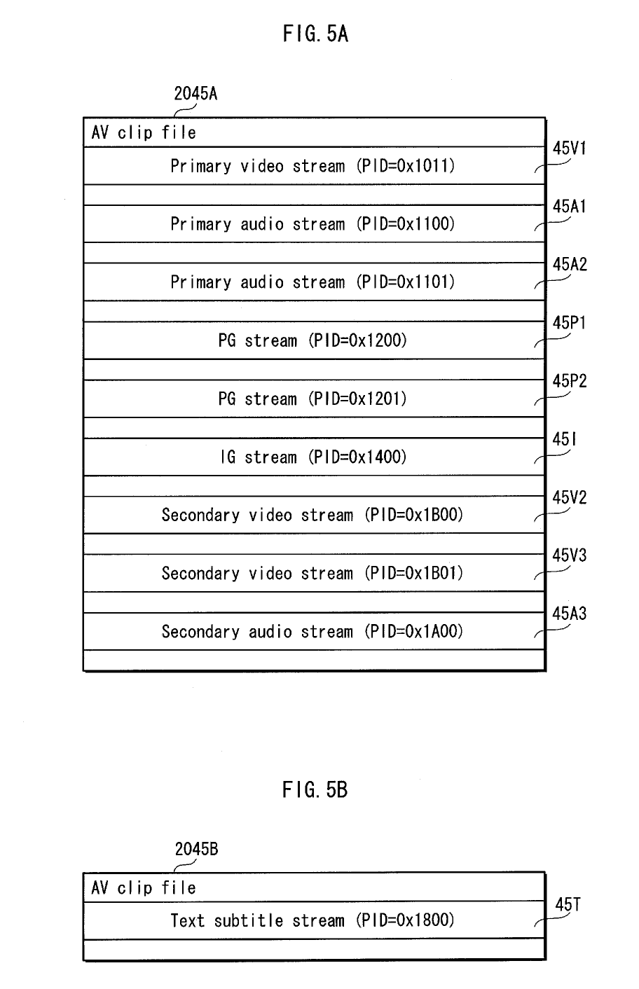

Each of the AV clip files 2045A and 2045B is also referred to as a clip AV stream and is obtained by multiplexing a plurality of elementary streams. FIG. 5A is a schematic view showing the plurality of elementary streams constituting one of the AV clip files, namely the AV clip file 2045A, in the order of playback time. FIG. 5B is a schematic view showing the text subtitle stream constituting the other one of the AV clip files, namely AV clip file 2045B, in the order of playback time. In the example shown in FIG. 5, the AV clip files 2045A and 2045B are of a movie content. The AV clip file 2045A shown in FIG. 5A includes a primary video stream 45V1, secondary video streams 45V2 and 45V3, primary audio streams 45A1 and 45A2, a secondary audio stream 45A3, presentation graphics (PG) streams 45P1 and 45P2, and an interactive graphics (IG) stream 451. The primary video stream 45V1 represents the primary video of a movie. The secondary video streams 45V2 and 45V3 each represent a secondary video to be displayed in picture-in-picture playback with the primary video. The primary audio streams 45A1 and 45A2 each represent the primary audio of the movie. The secondary audio stream 45A3 represents sub-audio to be mixed with the primary audio. The PG streams 45P1 and 45P2 and the IG stream 451 represent graphics to be displayed with the video of the movie. The PG streams 45P1 and 45P2 typically represent subtitles of the movie in mutually different languages (Japanese and English, for example) with graphics images. The IG stream 451 represents a graphical element or a set of graphical elements for GUI to be presented on interactive screen such as an operation screen of the playback device 102. That is, such graphical element(s) is to be presented on the screen of the display 103. As shown in FIG. 5A, the plurality of elementary streams 45V1, 45V2, 45V3, 45A1, 45A2, 45P1, 45P2 and 451 included in the AV clip file 2045A may be played back in parallel. The AV clip file 2045B shown in FIG. 5B includes a text subtitle stream 45T. The text subtitle stream 45T represents subtitles of the movie in a predetermined language with text character sequences. As shown in FIG. 5B, the text subtitle stream 45T is included singly in the AV clip file 2045B.

The AV clip files 2045A and 2045B each adopt the MPEG-2 transport stream (TS) format for multiplexing a plurality of elementary streams. That is, in each of the AV clip files 2045A and 2045B, the streams 45V1-45V3, 45A1, 45A2, 45P1, 45P2, 45I, 45A3 and 45T are each divided into a plurality of TS packets. Each TS packet is assigned with a packet ID (PID) which differs for each elementary stream, so that the elementary stream to which each TS packet belongs is identified with the PID of the TS packet. In the example shown in FIG. 5, the primary video stream 45V1 is assigned with PID holding the value “0x1011”, the primary audio stream 45A1 is assigned with PID holding a value ranging from “0x1100” to “0x111F”, the PG streams 45P1 and 45P2 are each assigned with PID holding a value ranging from “0x1200” to “0x121F”, the IG stream 451 is assigned with PID holding a value ranging from “0x1400” to “0x141F”, the secondary video streams 45V2 and 45V3 are assigned with PID holding a value ranging from “0x1B00” to “0x1B1F”, the secondary audio stream 45A3 is assigned with PID holding a value ranging from “0x1A00” to “0x1A1F”, and the text subtitle stream 45T is assigned with PID holding the value “0x1800”.

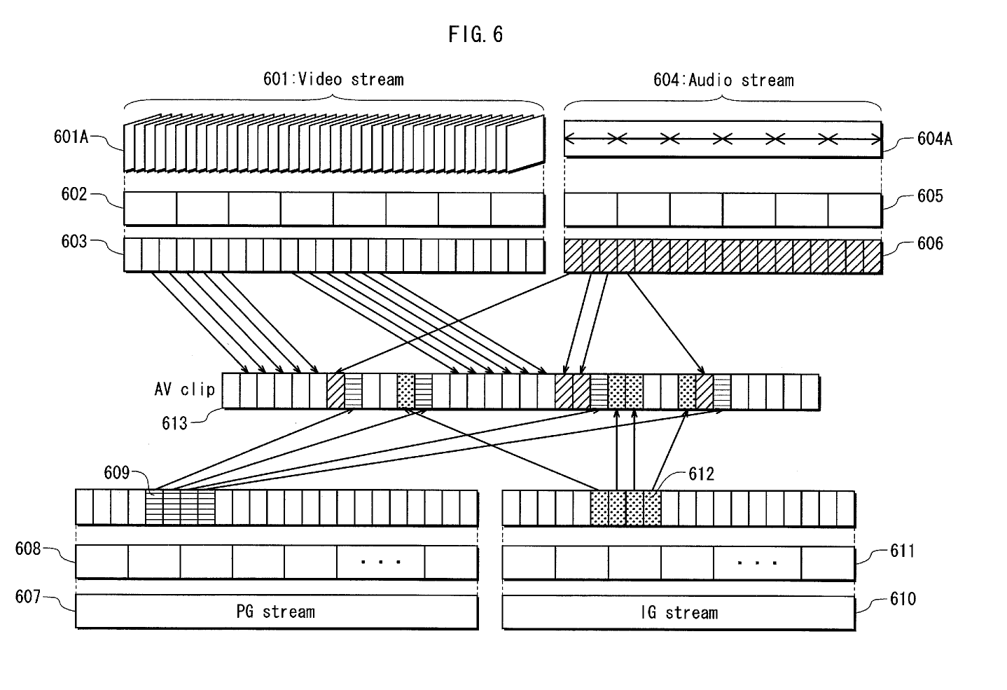

FIG. 6 is a schematic view showing the arrangement of TS packets of the respective elementary streams included in the AV clip file 613. A video stream 601 is composed of a plurality of video frames 601A. An audio stream 604 is composed of a plurality of audio frames 604A. The respective streams 601 and 604 are first converted into PES (Packetized Elementary Stream) packet sequences 602 and 605, and then into TS packet sequences 603 and 606. Similarly, the PG stream 607 and the IG stream 610 are first converted into PES packet sequences 608 and 611, and then into TS packet sequences 609 and 612. Furthermore, a header (TP_Extra_Header) is appended to each individual TS packet. Each TS packet attached with the header is called a source packet. By multiplexing the thus obtained source packets into a single stream in an sequential order, the AV clip file 613 is constituted.

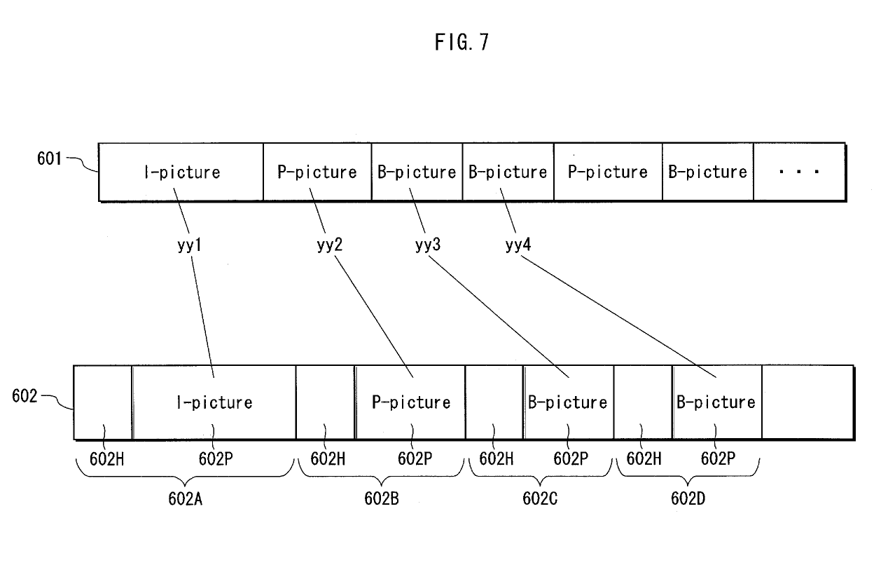

FIG. 7 is a schematic view showing the arrangement of video frames in the PES packet sequence 602 converted from the video stream 601. As shown in FIG. 7, each PES packet 602A, 602B, 602C, 602D . . . includes a PES header 602H and a PES payload 602P. First, the video stream 601 is compressed into I-picture yy1, P-picture yy2, B-pictures yy3, yy4 . . . , sequentially from the top video frame. The coding format of pictures that may be employed is any of MPEG-2, MPEG-4 AVC, and VC-1. Next, I-picture yy1, P-picture yy2, B-pictures yy3, yy4 . . . are each stored into the PES payload 602P of a different one of the PES packets 602A, 602B, 602C, 602D . . . . On the other hand, the PES header 602H of each PES packet stores the presentation time (PTS: Presentation Time-Stamp) and the decoding time (DTS: Decoding Time-Stamp) of the picture stored in the PES payload 602H of that PES packet. Note that PTS indicates a time at which one frame data decoded from one elementary stream by a decoder of the playback device 102 is to be output from the decoder. On the other hand, DTS indicates a time at which the decoder is to start decoding of one elementary stream.

Similarly, in each PES packet converted from an audio stream, the PES payload stores a piece of LPCM (Linear Pulse Code Modulation) audio data compressed in a predetermine coding format and the PES header stores PTS of the piece of audio data. The coding format of audio streams that may be employed is any of AC-3, Dolby Digital Plus (where “Dolby Digital” is a registered trademark), DTS (Digital Theater System which is a registered trademark), and DTS-HD LBR. In each PES packet converted from the PG stream or IG stream, the PES payload stores a piece of graphics data compressed in a predetermined coding format and the PES header stores PTS and DTS of the piece of graphics data. In each PES packet converted from a text subtitle stream, a text character sequence is stored in the PES payload.

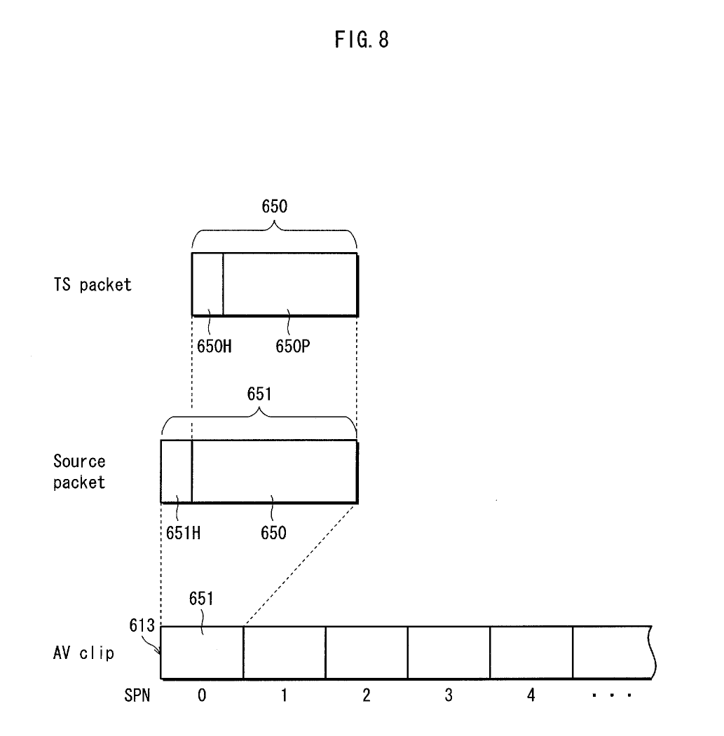

FIG. 8 is a schematic view showing the format of a TS packet 650 and the format of a source packet 651. As shown in FIG. 8, the TS packet 650 is a fixed length packet (188 bytes) and includes a TS header 650H and a TS payload 650P. The TS header 650H is 4-byte long and includes a PID. The TS payload 650P is 184-byte long. When the sequence of PES packets is converted into the sequence of TS packets, the individual PES packets are divided and stored into the TS payloads 650P of the TS packets 650. The source packet 651 is composed of a TS packet 650 attached with a four-byte header (TP_Extra_Header) 651H and thus is 192-byte long. The header 651H includes ATS (Arrival_Time_Stamp). ATS indicates a time at which the decoder of the playback device 102 is to output the first part of the TS packet 650 extracted from the source packet 651 to the PID filter. As shown in FIG. 8, the source packets 651 included in the AV clip file 613 are sequentially arranged. The source packets 651 are sequentially numbered from the top. The sequential numbers are called source packet numbers (SPNs).

The types of TS packets contained in an AV clip file include TS packets 603, 606, 609 and 612 obtained from the respective elementary streams 601, 604, 607 and 610 shown in FIG. 6, i.e., from the video, audio, subtitle streams and also include TS packets obtained from PAT (Program Association Table), PMT (Program Map Table) and PCR (Program Clock Reference). PAT includes information indicating the PID of PMT contained in the same AV clip file. The PID of the PAT is 0. The PMT includes a descriptor of the PID and attribute of each elementary stream contained in the same AV clip file and also includes a descriptor for the entirety of the AV clip file. The descriptor includes copy control information indicating whether copying of the AV clip file is permitted/prohibited. The PCR includes information used to set STC (System Time Clock) to a predetermined value. The STC is a clock used by the decoder as a reference for PTS and DTS.

### <Clip Information File (XXX.CLPI and ZZZ.CLPI) 2044A and 2044B>

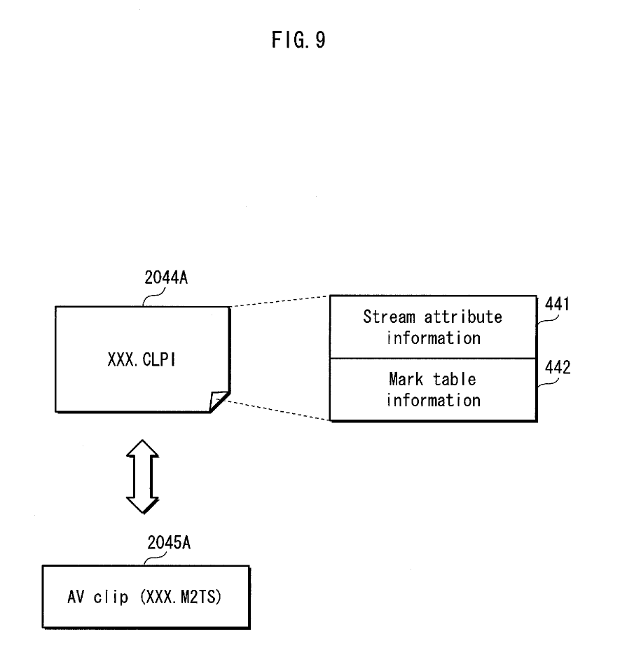

FIG. 9 is a schematic view showing the data structure of the clip information file 2044A. The clip information files 2044A and 2044B shown in FIG. 2 are in one-to-one correspondence with the AV clip files 2045A and 2045B stored in the STREAM directory 2045. The clip information files 2044A and 2044B each defines the correspondence between PTSs and SPNs, which are the addresses in a corresponding one of the AV clip files 2045A and 2045B. The clip information files 2044A and 2044B each further defines the attribute of each elementary stream multiplexed in a corresponding one of the AV clip files 2045A and 2045B. The following describes an example directed to the clip information file 2044A that corresponds to the AV clip file 2045A containing the primary video stream. Note that the same description similarly applies to the clip information file 2044B. As shown in FIG. 9, the clip information file 2044A includes stream attribute information 441 and mark table information 442.

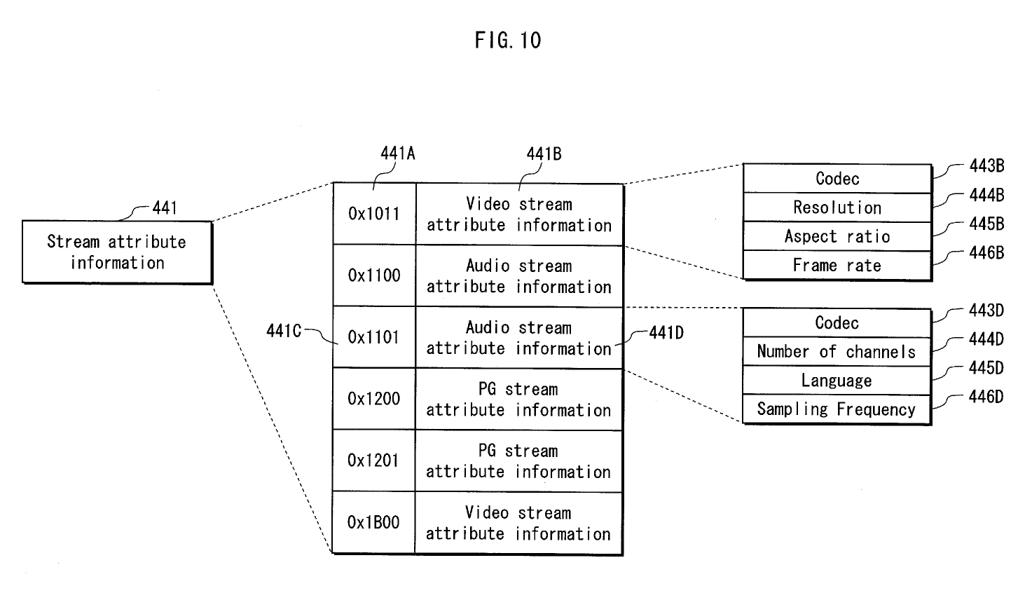

FIG. 10 is a schematic view showing the data structure of the stream attribute information 441. As shown in FIG. 10, the stream attribute information 441 includes pieces of attribute information regarding the respective elementary streams 45V1, 45V2, 45V3, 45A1, 45A2, 45A3, 45P1, 45P2, and 45I included in the AV clip file 2045A shown in FIG. 5A, in association with the PIDs of the respective elementary streams. For example, the PID 441A of the primary video stream 45V1 holds the value “0x1011” and is associated with the attribute information 441B. Similarly, the PID 441C of the primary audio stream holds the value “0x1101” and is associated with the attribute information 441D. Details of the attribute information differ among the video stream, audio stream, PG stream and IG stream. The video stream attribute information 441B includes the identification information 443B identifying the codec used to compress the video stream, the resolution 444B and aspect ratio 445B of pictures constituting the video stream, and the frame rate 446B of the video stream. The audio stream attribute information 441D includes the identification information 443D identifying the codec used to compress the audio stream, the number of channels 444D included in the audio stream, the language 445D of the audio stream, and the sampling frequency 446D of the audio stream. The respective pieces of attribute information are used to initialize the decoder of the playback device 102.

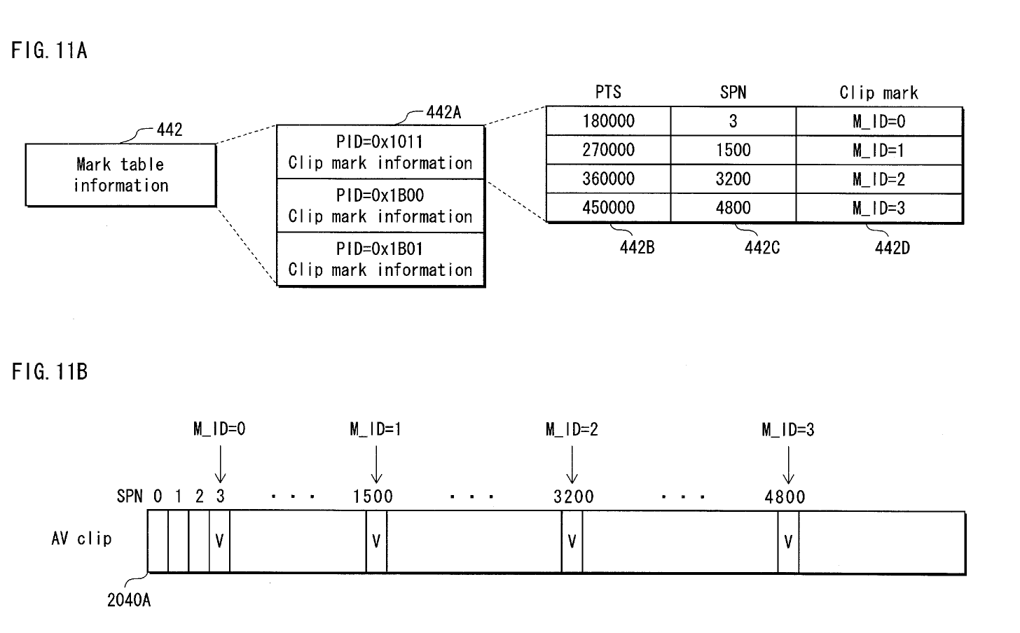

FIG. 11A is a schematic view showing the data structure of the mark table information 442. The mark table information 442 defines the correspondence between SPNs and PTSs separately for the respective elementary streams multiplexed in one AV clip file. For example, as shown in FIG. 11A, the mark table information 442 includes pieces of clip mark information 442A one for each video stream multiplexed in the AV clip file. The clip mark information 442A shows, for each I-picture included in the video stream, a pair composed of a PTS 442B of the I-picture and a SPN 442C of a portion of the AV clip file containing the I-picture, and the PTS-SPN pair is associate with a clip mark ID (M_ID) 442D. For example, consider the clip mark information 442A that is associated with the PID “0x1011” 441A of the primary video stream 45V1. In the clip mark information 442A, the PTS values “180000”, 270000”, 360000”, 450000” . . . of the respective I-pictures are paired with the SPNs “3”, “1500”, 3200”, 4800” . . . of the first one of source packets containing the respective I-pictures, and the PTS-SPN pairs are sequentially associated with the M_IDs=0, 1, 2, 3 . . . in the order of the corresponding I-pictures in the AV clip file 2045A.

FIG. 11B is a schematic view showing the source packets having the SPNs associated with the M_IDs by the clip mark information 442A, out of the source packets included in the AV clip file 2045A. By referencing to the clip mark information 442A, the playback device 102 specifies a specific one of source packets included in the AV clip file 2045A, the specific source packet corresponding to a frame of the primary video stream 45V1 having an arbitrary PTS. For example, at the time of trickplay playback, such as fast forward or reverse, the playback device 102 references the clip mark information 442A to specify a source packet having a specific SPN associated with an M_ID to start the trickplay playback. In this manner, it is ensured that playback starts selectively from an I-picture, so that the playback device 102 effectively executes trickplay playback.

Regarding the elementary streams other than the video stream, the mark table information 442 similarly includes pieces of clip mark information each associates an M_ID with a pair of PTS and SPN of a specific portion of data. Therefore, by referencing to the pieces of clip mark information, the playback device 102 specifies a source packet in the AV clip file corresponding an arbitrary PTS in each elementary stream.

### <Playlist File (YYY.MPLS) 2043A>

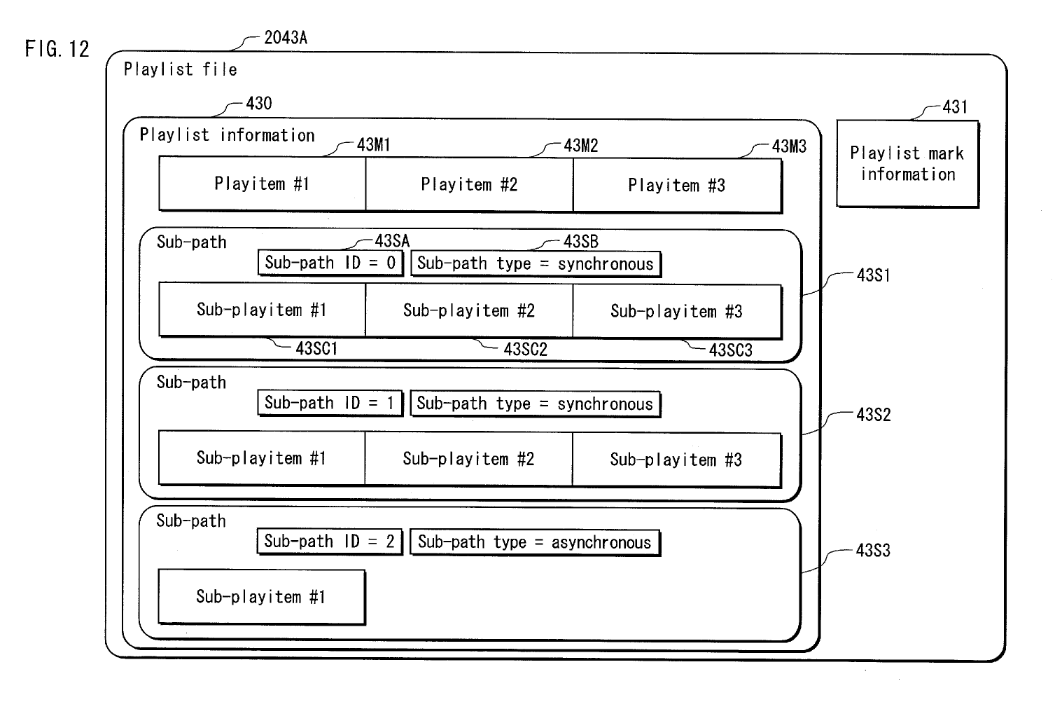

FIG. 12 is a schematic view showing the data structure of the playlist file 2043A. As shown in FIG. 12, the playlist file 2043A includes playlist information 430 and playlist mark information 431.

The playlist information 430 defines playback paths of the AV clip file 2045A and 2045B, by specifying portions of the AV clip files 2045A and 2045B to be played back, with the playback times at which the portions are to be played back. Specifically, the playlist information 430 includes one or more pieces playitem information 43M1, 43M2 and 43M3. Each piece of playitem information 43M1, 43M2 and 43M3 defines portions of the AV clip file 2045A containing the primary video stream that are to be continuously played back, with the playback sections, i.e., pairs each composed of the playback start time and playback end time of each section. The pieces of playitem information 43M1, 43M2 and 43M3 are serially numbered. The serial numbers thus indicate the order of the portions of the AV clip file 2045A defined by the respective pieces of playitem information 43M1, 43M2 and 43M3. The serial numbers are also used as indentifies, i.e., as the playitem IDs, of the respective pieces of playitem information 43M1, 43M2 and 43M.

Note that the playlist information 430 may further include one or more sub-paths 4351, 4352 and 43S3, as shown in FIG. 12. The sub-paths 43S1, 43S2 and 4353 each defines another playback path of the AV clip file 2045A or a playback path of another AV clip file 2045B, for synchronous playback with portions of the AV clip file 2045A defined by a corresponding one of the pieces of playitem information 43M1, 43M2 and 43M3. Note that the playback path of the AV clip file 2045A defined by the pieces of playitem information 43M1, 43M2 and 43M3 is referred to as a main path in contrast to the sub-paths 43S1, 43S2 and 43S3. In particular, the AV clip file 2045B storing the text subtitle stream is referenced in a sub-path rather than in the main path. The sub-paths 43S1, 43S2 and 43S3 each include a sub-path ID 43SA, a sub-path type 43SB, and one or more pieces of sub-playitem information 43SC1, 43SC2 and 43SC3. The sub-path ID 43SA is an identifier of a corresponding sub-path. The sub-path type 43SB indicates the type of the sub-path 43S1. The types of sub-path include a synchronous type and a asynchronous type. A sub-path of a synchronous type is required to be synchronously played back with the main path, whereas an asynchronous type sub-path is not. The pieces of sub-playitem information 43SC1, 43SC2 and 43SC3 each define portions of the AV clip file to be continuously played back, by defining the playback sections, i.e., pairs of a playback start time and a playback end time of each portion. The number of pieces of sub-playitem information generally differs for each sub-path. The pieces of sub-playitem information 43SC1, 43SC2 and 43SC3 of the respective sub-paths 43S1, 43S2 and 43S3 are serially numbered. The serial numbers thus indicate the order of the portions of the AV clip file defined by the respective pieces of sub-playitem information 43SC1, 43SC2 and 43SC3.

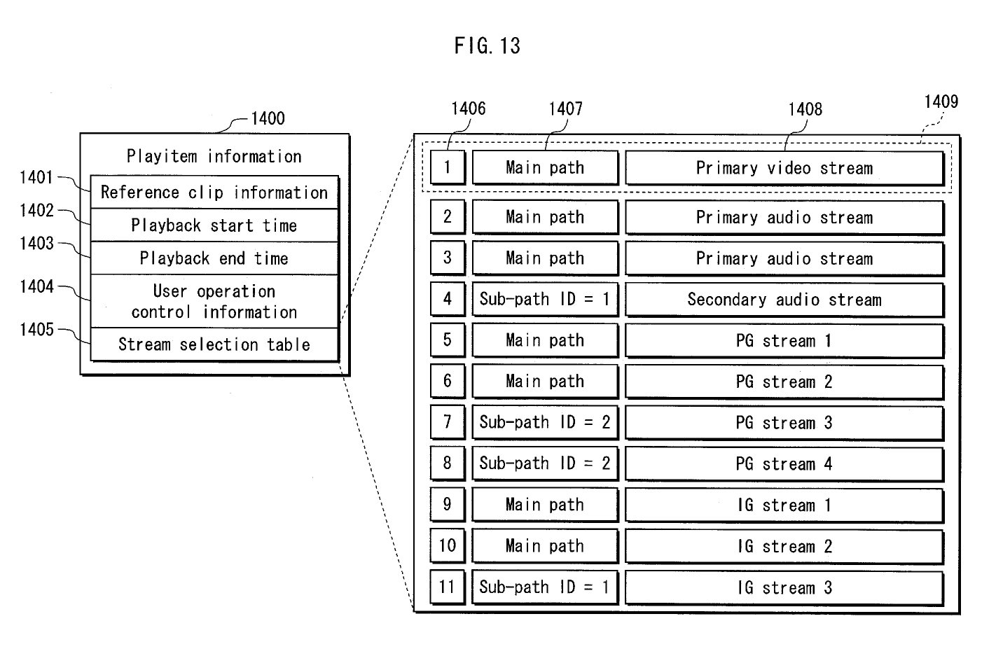

FIG. 13A is a schematic view showing the data structure of the playitem information 1400. As shown in FIG. 13, the playitem information 1400 includes reference clip information 1401, a playback start time 1402, a playback end time 1403, a user operation control information 1404, and a stream selection table 1405. The reference clip information 1401 is for identifying clip information files 2044A and 2044B that are necessary for referencing the AV stream file 2045A and 2045B. The playback start time 1402 and playback end time 1403 indicate PTSs corresponding to the start and end of the portions of the AV clip files 2045A and 2045B to be played back. The stream selection table 1405 is a list of elementary streams selectable, by the decoder of the playback device 102, from among the AV clip files 2045A and 2045B during the time between the playback start time 1402 and the playback end time 1403.

As shown in FIG. 13, the stream selection table 1405 includes a plurality of stream entries 1409. Each stream entry 1409 includes a stream selection number 1406, stream path information 1407 and stream identification information 1408. The stream selection number 1406 is a serial number assigned to each stream entry 1409 included in the stream selection table 1405. The stream path information 1407 is used for specifying an AV clip file to be played back. For example, when the stream path information 1407 indicates the “main path”, the AV clip file to be played back is the AV clip file 2045A associated with the clip information file 2044A specified by the reference clip information 1401. On the other hand, when the stream path information 1407 indicates the “sub-path ID=1”, the AV clip file to be played back is the AV clip file indicated by one of the pieces of sub-playitem information included in the sub-path 43S2 identified by the sub-path ID=1. Note that the piece of sub-playitem information indicates a playback section positioned between the playback start time 1402 and the playback end time 1403. The stream identification information 1408 indicates the PID of one of the elementary streams multiplexed in the AV clip file specified by the stream path information 1407. The elementary stream identified by the PID is selectable, by the playback device 102, from the AV clip file to be played back during the time between the playback start time 1402 and the playback end time 1403.

Similarly to the playitem information 1400 shown in FIG. 13, the pieces of sub-playitem information 43SC1, 43SC2 and 43SC3 shown in FIG. 12 each include reference clip information, a playback start time and a playback end time. In the sub-paths 43S1 and 43S2 each having a “synchronous” sub-path type 43SB, the sub-playitem information further includes one playitem ID. In addition, such a piece of sub-playitem information defines the playback start time and playback end time that falls within the playback section specified by a piece of playitem information having the playitem ID included in the playitem information.

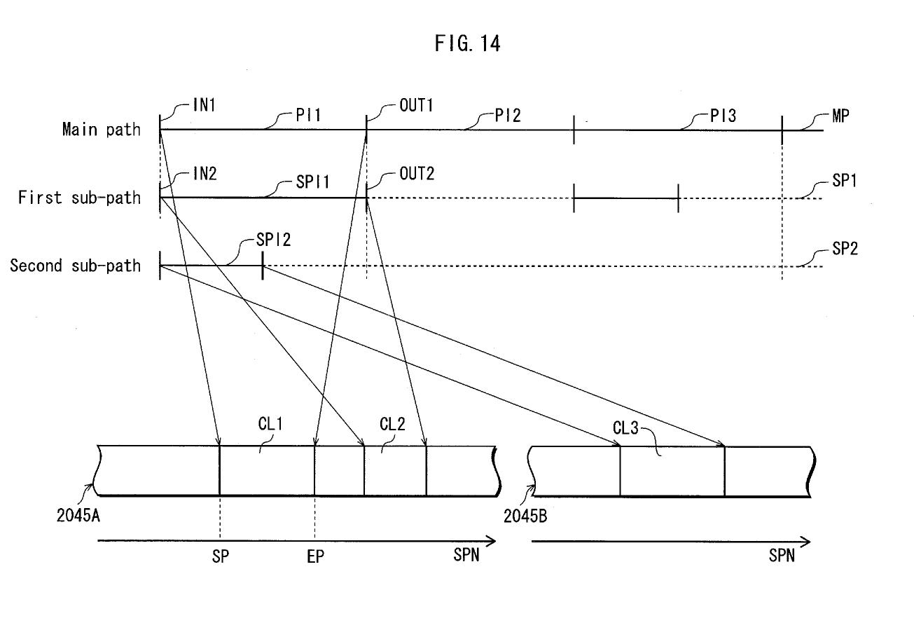

FIG. 14 is a schematic view showing portions CL1, CL2 and CL3 of the AV clip files 2045A and 2045B that are to be played back according to the main path and two sub-paths defined by the playlist information 430 shown in FIG. 12. Three time axes MP, SP1 and SP2 shown in FIG. 14 represent the playback time of the streams to be played back according to the main path, the first sub-path and the second sub-path, respectively. Here, assume that the sub-path IDs of the first and second sub-paths are “0” and “1”, respectively.

In the playback process according to the main path MP, the playback device 102 references playitem information #1 43M1, playitem information #2 43M2 and playitem information #3 43M3 in the order of their playitem IDs, among pieces of information included in the playlist information 430. For example, when the playitem information #1 43M1 is referenced, the mark table information 442 of the clip information file 2044A (see FIG. 11A) indicated by the reference clip information 1401 (see FIG. 13) is searched for a piece of clip mark information 442A containing a PTS corresponding to the playback start time IN1. Next, the SPNSP of the AV clip file 2045A included in that piece of clip mark information is determined to be the start address. In a similar manner, the SPNEP corresponding to the playback end time OUT1 is determined to be the end address. Next, with the use of the stream attribute information 441 (see FIG. 11A) of the clip information file 2044A, elementary streams that can be played back by both the playback device 102 and the display 103 are detected from the elementary streams registered in the stream selection table 1405 (see FIG. 13) included in the playitem information #1 43M1. Among the thus detected elementary streams, the one having the smallest stream selection number 1406 is selected. Finally, the PID described in the stream identification information 1408 of the thus selected elementary stream is set in the decoder. As a result, the decoder is set to process source packets having that PID, among the source packets of the portion CL1 that starts at the start address SP and ends at the end address EP of the AV clip file 2045A. In this manner, the playback section PI1, which starts at the playback start time IN1 and ends at the playback end time OUT1, of the main path MP is played back.

Suppose that one of the stream entries registered in the stream selection table included in the playitem information #1 43M1 has the stream path information indicating the “sub-path ID=0” and the stream identification information indicating the PID of the PG stream. In this case, the sub-playitem information #1 43SC1 is referenced among the pieces of sub-playitem information included in the first sub-path 4351. Here, the sub-playitem information #1 43SC1 indicates the playback start time IN2 and the playback end time OUT2 both of which are within the playback section PI1 indicated by the playitem information #1. Next, in a similar manner to specify the portion CL1 of the AV clip file 2045A for the playback section PI1 indicated by the playitem information #1 43M1, a portion CL2 of the AV clip file 2045A to be played back for the playback section SPI1 indicated by the sub-playitem information #1 43SC1 is specified. As a result, in the playback section SPI1 of the first sub-path, the PG stream is played back from the portion CL2 of the AV clip file 2045A, synchronously with the playback section PH of the main path. Similarly, suppose that another one of the stream entries registered in the stream selection table included in the playitem information #1 43M1 has the stream path information indicating the “sub-path ID=1” and the stream identification information indicating the text subtitle stream. In this case, a portion CL3 of the AV clip file 2045B to be played back is specified by one of the pieces of sub-playitem information included in the second sub-path 43S2. As a result, in the playback section SPI2 of the second sub-path, the portion CL3 of the text subtitle stream is played back, synchronously with the playback section PI1 of the main path.

As described above, the playlist information, clip information file, and AV clip file are used in combination to play back a series of AV contents. A “playlist” means the combination of such files. A “playitem” means a portion of a playlist that is combined with a single piece of playitem information.

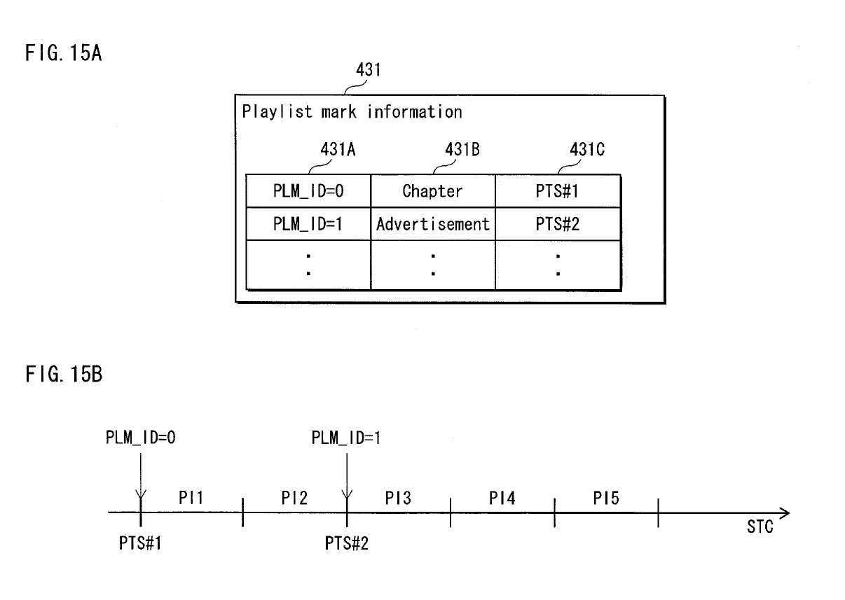

FIG. 15A is a schematic view showing the data structure of the playlist mark information 431. The playlist mark information 431 is a table showing a correspondence between the types and playback start times of specific playitems included in a playlist. As shown in FIG. 15A, the playlist mark information 431 associates one playlist mark ID (PLM_ID) 431A with one pair of a mark type 431B and a PTS 431C. The mark type 431B indicates the type of a playitem to be specified with the PLM_ID 431A. Types of playitem include a chapter of movie content and an advertisement. The PTS 431C indicates the playback start time of the playitem to be specified by the PLM_ID 431A. The combination of the PLM_ID 431A, mark type 431B and PTS 431C is referred to as “playlist mark”.

FIG. 15B is a schematic view showing playitems included in a playlist and specified by the playlist mark. Note that the playback time of the playlist is expressed by the STC. In FIG. 15B, playitems included in the playlist are sequentially played back for playback sections PI1, PI2, PI3, PI4 and PI5 represented by the STC. By referencing the playlist mark information 431, the playback device 102 can detect the playback section of a playitem specified by each playlist mark from the playback sections PI1, PI2, P13, P14 and PI5 of the playitems. In the example shown in FIG. 15A, the playlist mark PLM_ID=0 indicates that the playback start time of the first playitem in a chapter is PTS#1. Accordingly, a random access to the chapter starts playback from the playitem corresponding to the playback section PH having the playback start time PTS#1, as shown in FIG. 15B. As further shown in FIG. 15A, the playlist mark PLM_ID=1 indicates that the playback start time of an advertisement playitem is PTS#2. Thus, the playback section PI3 having the playback start time=PTS#2 as shown in FIG. 15B, is found to be the playback section of the advertisement playitem indicated by the playlist mark PLM_ID=1.

### <JAR File (AAA.JAR) 2046A>

The JAR file 2046A stores a BD-J application program that is to be executed in accordance with the BD-J object 471 or 472 shown in FIG. 4B or with the service object 42C1 or 42C2 shown in FIG. 4C. The BD-J application program is a bytecode program and specifically is a Java (registered trademark) application program. More specifically, “Java” mentioned in this specification is a registered trademark of Sun Microsystems. A BD-J application program includes HAVi framework conforming to GEM (Globally Executable Multimedia home platform) 1.0.2. The Java platform of the playback device 102 may include a standard Java library for presenting screen display with the use of raster data such as JFIF (JPEG) and PNG. In this case, the BD-J application program can cause the playback device 102 to realize the GUI framework with the use of the remote control navigation mechanism according to GEM 1.0.2. That is, the BD-J application program causes the playback device 102 to composite a screen display, such as buttons, text or bulletin board system (BBS) based on the HAVi framework, with video images, to realize GUI that uses the display 103 and the remote control 104.

### <Hardware Structure of Playback Device 102>

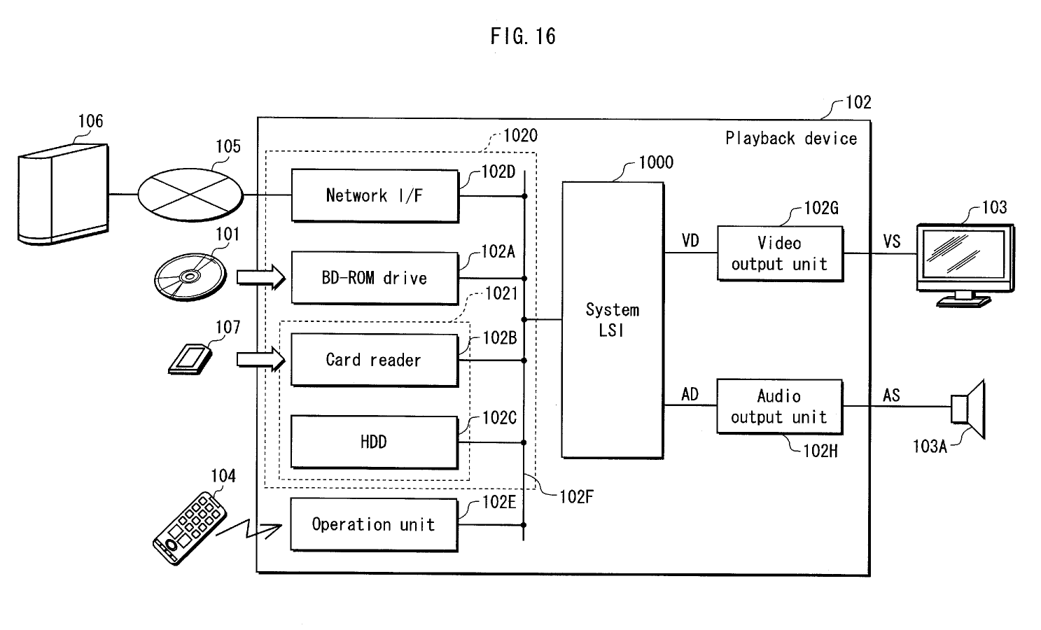

FIG. 16 is a block diagram showing the hardware structure of the playback device 102. As shown in FIG. 16, the playback device 102 includes a BD-ROM drive 102A, a local storage 1021, a network interface 102D, an operation unit 102E, a bus 102F, a system LSI 1000, a video output unit 102G and an audio output unit 102H. The BD-ROM drive 102A, the local storage 1021, the network interface 102D and the operation unit 102E are each capable of communicating with the system LSI 1000 via the 102F. Especially, the BD-ROM drive 102A, the local storage 1021 and the network interface 102D each function as means 1020 for supplying an AV content to the system LSI 1000 (hereinafter the means 1020 is referred to as supplying unit).

The network interface 102D connects the external network 105 and the bus 102F to enable communications therebetween. Via the network interface 102D, the system LSI 1000 can communicate with the server device 106 located on the network 105.

The operation unit 102E receives and interprets a command transmitted from the remote control 104 by radio, such as infrared communications, and passes the result of interpretation to the system LSI 1000. Additionally, the operation unit 102E detects a push of a button disposed on the front panel of the playback device 102 and notifies the detected result to the system LSI 1000.

The BD-ROM drive 102A directs laser light to the BD-ROM disc 101 inserted therein, to read data recoded on the BD-ROM disc 101 based on changes in the reflected light. Specifically, the BD-ROM drive 102A reads, based on a logical address specified by the system LSI 1000, application data 203B from the volume area 202 of the BD-ROM disc 101 shown in FIG. 2 and transfers the read data to the system LSI 1000. Note that data read from the BD-ROM disc 101 includes the AV clip file 2045A as well as the index file 2042A, the movie object file 2042B, the service object file 2042C, the playlist file 2043A, the BD-J object file 2047A and the JAR file 2046A.

The local storage 1021 is a mass storage device that is readable and writable and implemented by using HDD and a memory card such an SD card. In FIG. 16, the local storage 1021 includes the card reader 102B and an HDD 102C. The card reader 102B reads and writes data to and from the memory card 107 inserted therein. The HDD 102C is disposed within the playback device 102. In addition, although not shown in FIG. 16, an external HDD may be connected to the bus 102F via a predetermined interface to be used as the local storage 1021.

According to the commands give from the system LSI 1000, the local storage 1021 downloads an update kit for the BD-ROM disc 101, from the server device 106 located on the network 105 via the network interface 102D and stores the update kit into the HDD 102C or memory card 107. Alternatively, the memory card 107 storing an update kit may be inserted into the card reader 102B.

The system LSI 1000 executes built-in firmware or an application program read from the BD-ROM disc 101 and controls the other components 102A-102F of the playback device 102 according to the firmware or application program executed. In particular, the system LSI 1000 creates a virtual package from the files on the BD-ROM disc 101 and the update kit included in the local storage 1021 and plays back a series of AV contents according to a playlist, although some of the AV contents are included in the BD-ROM disc 101 and some in the update kit. Note that a virtual package refers to a virtual BD-ROM disc that the system LSI 1000 creates in the internal memory and is a file system that allows an application program to access files on the BD-ROM disc 101 and files in the update kit in a manner that all the files are on the same BD-ROM. Thus, an application program can access files recorded on the BD-ROM disc 101 and differential data included in the local storage 1021 with paths on the virtual package instead of actual paths. Note that details of the system LSI 1000 including the function of creating a virtual package will be described later.

The video output unit 102G converts the video data VD reproduced by the system LSI 1000 into a video signal VS in a format suitable for the display 103 and outputs the resulting signal to the display 103. Note that the video output unit 102G may be integrated within the system LSI 1000.

The audio output unit 102H converts the audio data AD reproduced by the system LSI 1000 into an audio signal AS in a format suitable for the external speaker 103A and outputs the resulting signal to the speaker 103A. Note that the audio output unit 102H may be integrated within the system LSI 1000. The speaker 103A is built into the display 103. Alternatively, the speaker 103A may be externally connected to the display 103.

### <Data Structure of Update Kit>

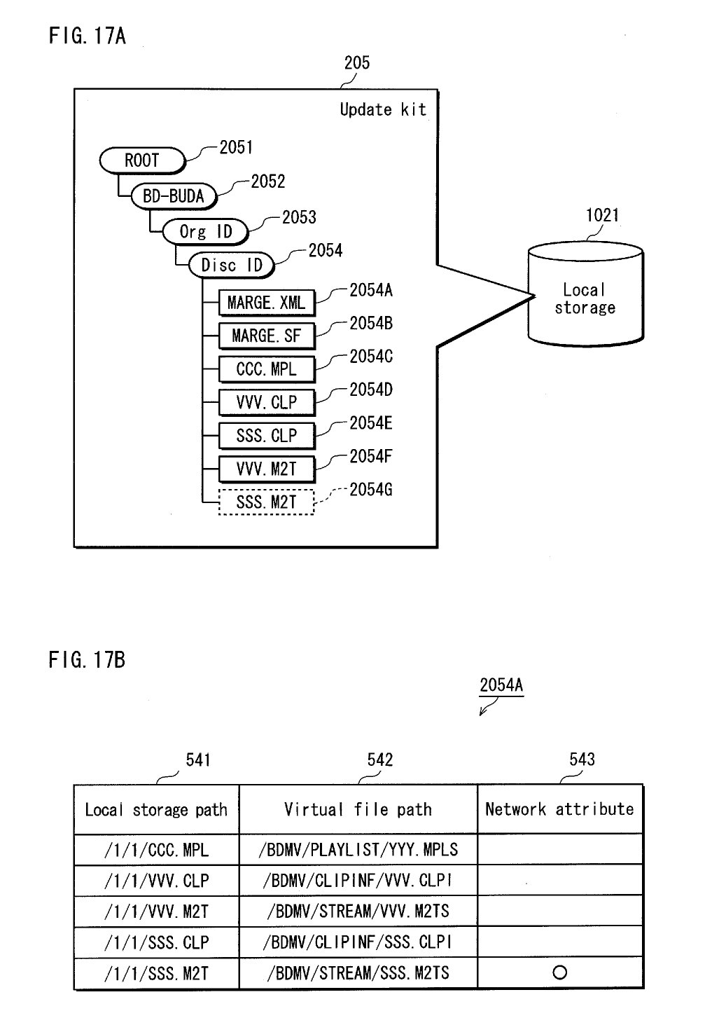

FIG. 17A is a schematic view showing the directory structure of an update kit 205 stored in the local storage 1021. The update kit 205 includes differential data and a merge management information file. The differential data is files to constitute a virtual package together with files recorded on the BD-ROM disc 101 shown in FIG. 2 or to replace some of the files in the virtual package. Specifically, the differential data includes a new advertisement playitem to replace an advertisement playitem recorded on the BD-ROM disc 101. The merge management information file includes data necessary to convert a path of the differential data on the local storage 1021 to a path on the virtual package.

As shown in FIG. 17A, the directory structure of the update kit 205 is such that an additional content storage directory (BD_BUDA) 2052 is located immediately below the root directory (ROOT) 2051 of the local storage 1021, and an Org ID directory 2053 is located below the BD_BUDA 2052. The directory name of the Org ID directory 2053 is an 8-digit hexadecimal number representing an Org ID assigned to the provider of an AV content to be updated. Immediately below the Org ID directory 2053, an Disc ID directory 2054 is located. The directory name of the Disc ID directory 2054 is a 32-digit hexadecimal number representing a Disc ID of the BD-ROM disc on which the AV content to be updated is recorded. The Disc ID directory 2054 contains a merge management information file (MERGE.XML) 2054A, a signature information file (MERGE.SF) 2054B, additional content files (CCC.MPL, VVV.CLP, SSS.CLP, VVV.M2T and SSS.M2T) 2054C-2054G.

FIG. 17B is a schematic view showing the data structure of the merge management information file (MERGE.XML) 2054A. As shown in FIG. 17B, the merge management information file 2054A includes local storage paths 541, virtual file paths 542 and network attributes 543. The local storage paths 541 indicate the locations and names of individual files in the local storage 1021 that are to be incorporated into a virtual package in place of some files recorded on the BD-ROM disc 101. The virtual file paths 542 indicate access paths on the virtual package to the individual files specified by the local storage paths 541. The network attributes 543 indicate AV clip files (SSS.M2T) that are included in the files specified by the local storage paths 541 and downloadable from the server device 106 on the network 105. The AV clip files (SSS.M2T) are not required to be stored on the local storage 1021 at the time of creating a virtual package, and allowed to be downloaded from the server device 106 on the network 105 to the local storage 1021 or the system LSI 1000 at or before the time when actually processed by the system LSI 1000.

The signature information file (MERGE.SF) 2054B includes an electronic signature of the provider of the AV content to be updated. An electronic signature is a hash value that is generated from information to be protected against tampering and then encrypted with a predetermined secrete key. The electronic signature included in the signature information file 2054B is a hash value that is generated from the merge management information file 2054A and then encrypted with a predetermined secrete key. The secrete key is paired with a public key included in the merge certificate 2048A shown in FIG. 2. That is, the electronic signature can be decrypted with the public key.

The additional content files 2054C-2054G are files to be added to or substituted for files representing original playlists stored on the BD-ROM disc 101. In FIG. 17A, the additional content files include an additional playlist file (CCC.MPL) 2054C, additional clip information files (VVV.CLP and SSS.CLP) 2054D and 2054E, and additional AV clip files (VVV.M2T and SSS.M2T) 2054F and 2054G.

Like the playlist file 2043A shown in FIG. 12, the additional playlist file 2054C includes playlist information and playlist mark information. The playlist information defines playback paths of the additional AV clip files 2054F and 2054G in addition to or in place of the playback path of the AV clip file 2045A recorded on the BD-ROM disc 101. The playlist information particularly includes playitem information of a new advertisement for replacing an advertisement recorded on the BD-ROM disc 101. The playlist mark information indicates the playback start times described in specific playitem information included in the playlist information, in particular, playitem information about chapters and advertisements.

The additional clip information files (VVV.CLP and SSS.CLP) 2054D and 2054E are in one-to-one correspondence with the additional AV clip files (VVV.M2T and SSS.M2T) 2054F and 2054G. One of the additional clip information files (VVV.CLP) 2054D is management information relating to the additional AV clip file (VVV.M2T) 2054F and downloaded together with the additional AV clip file (VVV.M2T) 2054F. The other of the additional clip information files (SSS.CLP) 2054E is management information relating to the AV clip file (SSS.M2T) 2054G having the network attribute and thus downloaded prior to the additional AV clip file (SSS.M2T) 2054G. The additional AV clip file (SSS.M2T) 2054G is downloaded from the network 105 on the server device 106 into the local storage 1021 or the system LSI 1000 at or before the time when actually processed by the system LSI 1000. The elementary streams representing video images, sounds or subtitles of the new advertisement may be stored in any of the additional AV clip files (VVV.M2T and SSS.M2T) 2054F and 2054G. Furthermore, the additional content files may include a plurality of pairs of a clip information file and an AV clip file for new advertisements; one of the pairs is used for playback of the main path and another of the pairs is for playback of a sub-path.

The playitem information of a new advertisement is different from the playitem information of the advertisement originally recorded on the BD-ROM disc 101 in the following respects. First, in the playitem information 1400 shown in FIG. 13, the file name described in the reference clip information 1401 is changed to the file name of one of the additional clip information files 2054D and 2054E. When there are more than one clip information file for new advertisements, the reference clip information 1401 indicates the file name of a clip information file belonging to the main path. Next, the stream selection table 1405 is rewritten to indicate the elementary streams included one of the additional AV clip files 2054F and 2054G. The stream selection table 1405 may additionally include the stream path information 1407 indicating a sub-path ID. In that case, the additional playlist file 2054C includes a sub-path with the sub-path ID and also includes sub-playitem information for the new advertisement.

### <Functional Units of System LSI 1000>

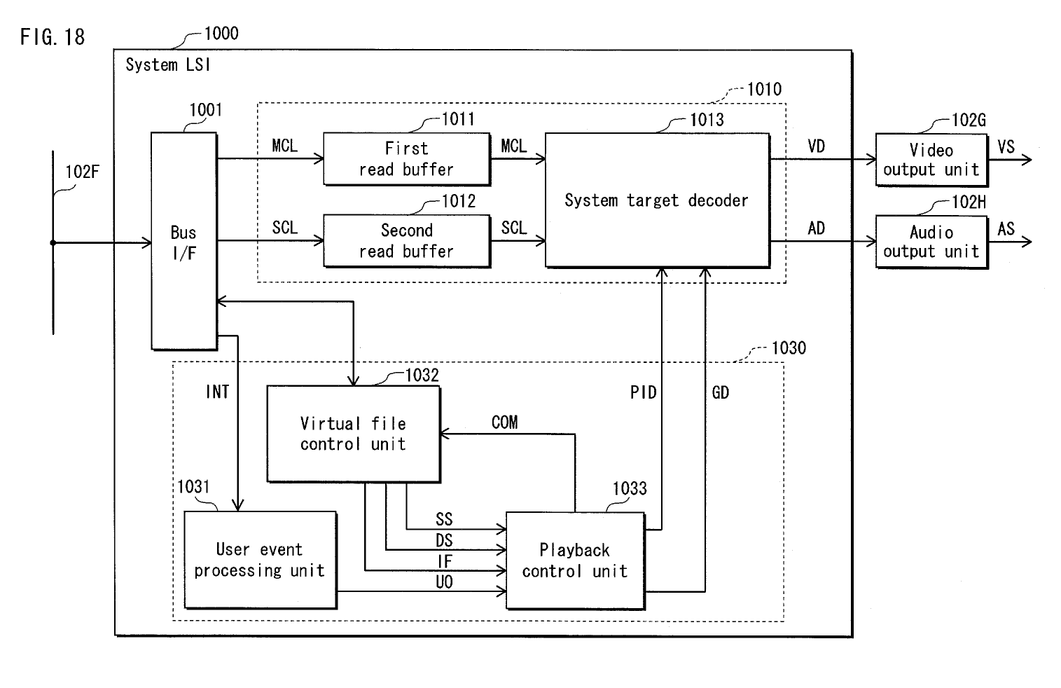

FIG. 18 is a functional block diagram of the system LSI 1000. As shown in FIG. 18, the system LSI 1000 includes a bus interface 1001, a playback unit 1010 and a control unit 1030. The playback unit 1010 includes a first read buffer 1011, a second read buffer 1012 and a system target decoder 1013. The control unit 1030 includes a user event processing unit 1031, a virtual file control unit 1032 and a playback control unit 1033. The control unit 1030 implements the functional units 1031, 1032 and 1033 mentioned above, by executing the built-in program of the system LSI 1000, i.e., firmware of the system LSI 1000. The bus interface 1001, the playback unit 1010 and the control unit 1030 are all implemented on a single chip. Alternatively, the playback unit 1010 and the control unit 1030 may be implemented on separate chips.

The bus interface 1001 connects the respective functional units 1010 and 1030 of the system LSI 1000 to the supplying unit 1020 and the operation unit 102E shown in FIG. 2, via the bus 102F in a mariner to enable communications therebetween. Specifically, by following the instructions given from the virtual file control unit 1032, the bus interface 1001 reads an AV clip file from the BD-ROM disc 101 via the bus 102F and the BD-ROM drive 102A or from the local storage 1021 via the bus 102F. Furthermore, the bus interface 1001 may download an AV clip file from the server device 106 on the network 105 via the bus 102F and the network interface 102D. Furthermore, the bus interface 1001 may send each AV clip file to one of the read buffers 1011 and 1012 specified by the virtual file control unit 1032. Note that the bus interface 1001 is capable of sending different AV clip files in parallel to the read buffers 1011 and 1012 according to instructions given by the virtual file control unit 1032.

The first read buffer 1011 and the second read buffer 1012 are internal buffer memory of the system LSI 1000. The read buffers 1011 and 1012 are used to temporally hold the AV clip files MCL and SCL read by the bus interface 1001. Here, the bus interface 1001 selects the destination of output according to the instructions given from the virtual file control unit 1032, so that the AV clip file MCL of the main path is held in the first read buffer 1011 and the AV clip file SCL of a sub-path is held in the second read buffer 1012.

The system target decoder 1013 reads the AV clip files MCL and SCL in parallel from the respective read buffer 1011 and 1012 in the units of source packets. The system target decoder 1013 separates the read source packets into elementary streams each having a PID specified by the playback control unit 1033. Furthermore, the system target decoder 1013 decodes the elementary streams separately for their types i.e., for PIDs to reproduce the video data VD and audio data AD from the decoded data. The system target decoder 1013 also receives graphics data GD for GUI, such as a menu screen, from the playback control unit 1033 and decodes the received graphics data to composite with the video data VD. The structure of the system target decoder 1013 will be described later in more detail.

The user event processing unit 1031 receives a notification INT from the operation unit 102E and decodes the notification INT into a command to interpret the user operation indicated by the command. Furthermore, the user event processing unit 1031 sends to the playback control unit 1033 a request UO for the process corresponding to the user operation. In an example in which the notification INT received from the operation unit 102E indicates insertion of the BD-ROM disc 101 to the BD-ROM drive 102A, the user event processing unit 1031 requests the playback control unit 1033 to read an index file from the BD-ROM disc 101. In another example in which the notification INT received from the operation unit 102E indicates a push of a fast-forwarding/rewinding button on the remote control 104, the user event processing unit 1031 requests the playback control unit 1033 to execute the process of fast-forwarding/rewinding of the playlist currently being played back.

The virtual file control unit 1032 controls file access to the BD-ROM disc 101. In particular, in the case where the update kit 205 is stored on the local storage 1021, the virtual file control unit 1032 creates a virtual package in the internal memory, with the use of the differential data and the merge management information on the local storage 1021 shown in FIG. 17A, in addition to the files on the BD-ROM disc 101 shown in FIG. 2. For example, upon receipt of a notification from the user event processing unit 1031 indicating that the BD-ROM disc 101 is inserted into the BD-ROM drive 102A, the playback control unit 1033 issues a command COM to instruct the virtual file control unit 1032 to create a virtual package. According to the instruction COM, the virtual file control unit 1032 creates the virtual package. The process of creating the virtual package 206 by the virtual file control unit 1032 will be described later in detail.

After creating the virtual package, the virtual file control unit 1032 reads an index file IF from the virtual package and passes the read index file IF to the playback control unit 1033. Then, the virtual file control unit 1032 controls access to the files of the virtual package according to the instruction COM received from the playback control unit 1033 and the request UO received from the user event processing unit 1031. For example, the virtual file control unit 1032 reads, from the virtual package, scenario information to be played back, which means the pieces of current scenario information DS and SS, and passes the read information to the playback control unit 1033. Regarding scenario information, there is dynamic scenario information DS and static scenario information SS. The dynamic scenario information DS includes a movie object file, a BD-J object file, a service object file and a JAR file. The static scenario information SS includes a playlist file and a clip information file referenced by the playlist file. Furthermore, the virtual file control unit 1032 controls the bus interface 1001, so that the AV clip file MCL to be played back in the main path is transferred from the virtual package to the first read buffer 1011 and that the AV clip file SCL to be played back in a sub-path is transferred from the virtual package to the second read buffer 1012.

The playback control unit 1033 executes the firmware of the system LSI 1000 to provide a run-time environment for an application program and reads and executes an application program from the dynamic scenario information DS in that environment. As a result, the playback control unit 1033 controls the respective components of the playback device 102 according to the application program. The structure of the playback control unit 1033 will be described later in detail.

Specifically, the playback control unit 1033 functions in the following manner. First, the playback control unit 1033 selects a title from the index table contained in the index file, according to a request UO received from the user event processing unit 1031 and then issues a command COM to the virtual file control unit 1032 so as to request for files related to the selected title. The files to be requested include a movie object or BD-J object specified by the title and a service object or BD-J application program to be called according to the specified object. The virtual file control unit 1032 reads the files from the virtual package and passes the files to the playback control unit 1033 as the current dynamic scenario information DS. Next, the playback control unit 1033 issues to the virtual file control unit 1032 a command COM according to the dynamic scenario information DS so as to specify one playlist for playback. At this point, the virtual file control unit 1032 reads, from the virtual package, playlist information relating to the specified playlist and the clip information file referenced by the playlist information and passes the read information and file to the playback control unit 1033 as the current static scenario information SS. Furthermore, the playback control unit 1033 issues to the virtual file control unit 1032 a command COM according to the static scenario information SS so as to specify one playitem for playback. At this point, the virtual file control unit 1032 causes the bus interface 1001 to read portions of the AV clip file included in the specified playitem and to send portions MCL to be played back in the main path to the first read buffer 1011 and portions SCL to be played back in the sub-path to the second read buffer 1012.

### <Process of Creating Virtual Package 206 by Virtual File Control Unit 1032>

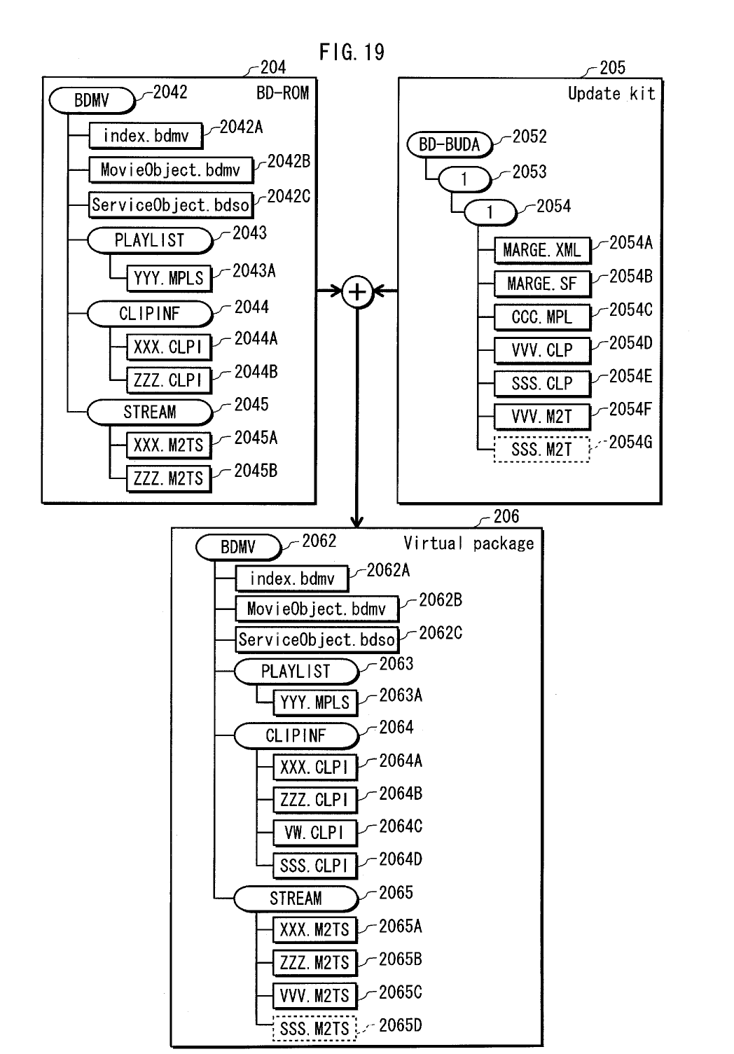

FIG. 19 is a schematic view of the process of creating a virtual package 206 by the virtual file control unit 1032. The files contained in the BDMV directory 2042 on the BD-ROM disc 101 are directly treated as files contained in the BDMV directory 2062 on the virtual package 206. The virtual file control unit 1032 first reads the ID file 2048B from the CERTIFICATE directory 2048 located on the BD-ROM disc 101 shown in FIG. 2, and then acquires the Org ID “1” and the Disc ID “1” of the BD-ROM disc 101 from the file. Next, the virtual file control unit 1032 searches the update kit 205 stored in the local storage 1021 for the Org ID directory 2053 with the directory name representing the Org ID “1,” and then searches the Org ID directory 2053 for the Disc ID directory 2054 with the directory name representing the Disc ID “1”. Furthermore, the virtual file control unit 1032 reads the merge management information file (MERGE.XML) 2054A and the signature information file (MERGE.SF) 2054B from the Disc ID directory 2054, decrypts the signature information file 2054B with the public key contained in the merge certificate 2048A on the BD-ROM disc 101 shown in FIG. 2, and then checks the decrypted file against the merge management information file 2054A. In this manner, the merge management information file 2054A is authenticated. After the authentication is successful, the virtual file control unit 1032 associates paths in the local storage 1021 to the additional content files (CCC.MPL, VVV.CLP, SSS.CLP and VVV.M2T) 2054C-2054F with paths on the virtual package 206, according to the correspondence between the paths described in the merge management information file 2054A shown in FIG. 17B.

In FIG. 17B, the local storage path of the additional playlist file 2054C is described as “/1/1/CCC.MPL,” and the virtual file path thereof is described as “/BDMV/PLAYLIST/YYY.MPLS”. Accordingly, an access to the playlist file (YYY.MPLS) 2063A in the PLAYLIST directory 2063 on the virtual package 206 actually leads an access to the additional playlist file (CCC.MPL) 2054C rather than the playlist file (YYY.MPLS) 2043A on the BD-ROM disc 101. Further in FIG. 17B, the local storage paths of the other additional content files 2054D-2054G are described as “/1/1/VVV.CLP”, “/1/1/VVV.M2T”, “/1/1/SSS.CLP” and “/1/1/SSS.M2T,” and their virtual file paths are described as “/BDMV/CLIPINF/VVV.CLPI”, “/BDMV/STREAM/VVV.M2TS”, “BDMV/CLIPINF/SSS.CLPI”, and “BDMV/STREAM/SSS.M2TS”. Accordingly, an access to one of the clip information files (VVV.CLPI and SSS.CLPI) 2064C and 2064D in the CLIPINF directory 2064 on the virtual package 206 actually leads an access to one of the additional clip information files (VVV.CLP and SSS.CLP) 2054D and 2054E. Similarly, an access to the AV clip file (VVV.M2TS) 2064C in the STREAM directory 2065 actually leads an access to the additional AV clip file (VVV.M2T) 2054F. On the other hand, the merge management information file 2054A shows that one of the additional AV clip files (SSS.M2T) is provided with the network attribute. Accordingly, the file (SSS.M2T) 2054G shown in FIG. 19 is not required to be included in the update kit 205 at the time of creating the virtual package 206. After the virtual package 206 is created, the additional AV clip file (SSS.M2T) 2054G may be downloaded from the server device 106 on the network 105 to the local storage 1021 or the system LSI 1000 at or before the time when the AV clip file (SSS.M2TS) 2065D in the STREAM directory 2065 is accessed.

### <Structure of Playback Control Unit 1033>

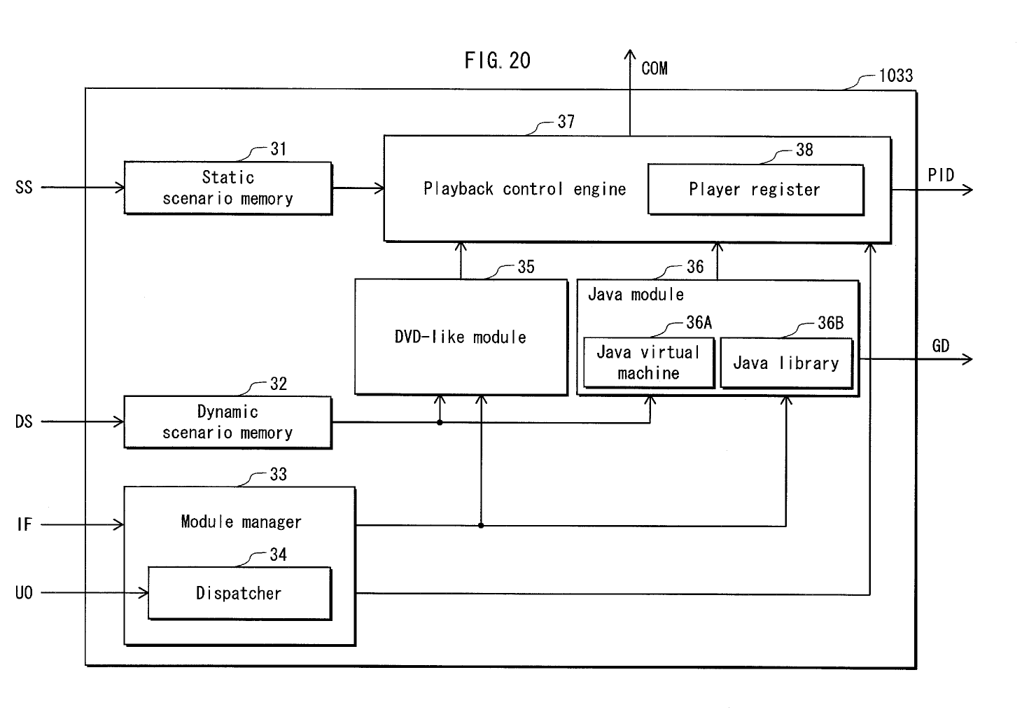

FIG. 20 is a functional block diagram of the playback control unit 1033. As shown in FIG. 20, the playback control unit 1033 includes a static scenario memory 31, a dynamic scenario memory 32, a module manager 33, a DVD-like module 35, a Java module 36 and a playback control engine 37.

The static scenario memory 31 and the dynamic scenario memory 32 are each internal memory of the playback control unit 1033. The static scenario memory 31 receives to store current static scenario information SS (i.e., the playlist file and clip information file of the current playback target) from the virtual file control unit 1032. The static scenario information SS is referenced by the playback control engine 38. The dynamic scenario memory 32 receives to store the current dynamic scenario information DS (i.e., the movie object file, BD-J object file, service object file or JAR file relating to the program being the current execution target) from the virtual file control unit 1032. These files are processed by the DVD-like module 35 or Java module 36.

The module manager 33 receives to hold the index file IF from the virtual file control unit 1032. Furthermore, the module manager 33 manages the operation mode of the playback device 102 based on the index file IF. More specifically, the module manager 33 assigns execution of the dynamic scenario information DS held in the dynamic scenario memory 32 to either of the DVD-like module 35 and the Java module 36 each time one item, which is a title, is selected from the index table stored in the index file IF. In the case where the dynamic scenario information DS is a movie object file, the module manager 33 assigns the dynamic scenario information DS to the DVD-like module 35. The operation mode at this point is called a movie mode. On the other hand, in the case where the dynamic scenario information DS is a BD-J object or service object, the module manager 33 assigns the dynamic scenario information DS to the Java module 36. The operation mode at this point is called a Java mode. Furthermore, in the case where a request UO for operation mode switching is received from the user event processing unit 1031 or the operation mode switching is requested by the module 35 or 36, the module manager 33 switches between the modules 35 and 36 to which the dynamic scenario information DS is assigned.

The module manager 33 includes a dispatcher 34. The dispatcher 34 receives request UOs from the user event processing unit 1031 and selects a request UO conforming to the current operation mode and passes the selected request UO to one of the modules 35 and 36 to which the dynamic scenario information DS is assigned. For example, when the request UO indicates fast-forward playback or rewind playback, the dispatcher 34 passes the request UO to the DVD-like module 35 in the movie mode and to the Java module 36 in the Java mode. Furthermore, when a request UO requesting to read an index file from the BD-ROM disc 101 is received from the user event processing unit 1031 upon loading of the BD-ROM disc 101 into the BD-ROM drive 102A, the dispatcher 34 issues a command COM to instruct the virtual file control unit 1032 to read the index file IF via the playback control engine 37.

The DVD-like module 35 is a virtual DVD player and operates to read, in the movie mode, a movie object from the dynamic scenario information DS held in the dynamic scenario memory 32 and sequentially executes navigation commands described in the movie object. In this manner, the DVD-like module 35 instructs the playback control engine 37 to play back the playlist specified by the movie object.

The Java module 36 is a Java platform and compliant with J2ME (Java2Micro_Edition), PBP (Personal Basis Profile) 1.0 and GEM 1.0.2. The Java module 36 includes a Java virtual machine 36A and a Java library 36B. The Java virtual machine 36A operates in the Java mode to read the BD-J object or service object from the dynamic scenario information DS held in the dynamic scenario memory 32. Furthermore, the Java virtual machine 36A converts the Java object into native doe of the control unit 1030 and passes the native code to the playback control engine 37. In this manner, the Java virtual machine 36A instructs the playback control engine 37 to play back a playlist specified by the BD-J object or service object. Furthermore, the Java virtual machine 36 operates to download an update kit to the local storage 1021 from the server device 106 located on the network 105 or from an external storage device such as the memory card 107. The Java library 36B includes a standard Java library for displaying screen images using raster data, such as JFIF (JPEG), PNG and other formats. On the other hand, a Java application program specified by a BD-J object or service object includes the HAVi framework compliant with GEM 1.0.2, Consequently, the Java module 36 is enabled to implement the GUI framework with the use of the remote control navigation mechanism compliant with GEM 1.0.2, by executing such a Java application program. Specifically, the Java module 36 generates graphics data GD to be used in the GUI and passes the graphics data GD to the system target decoder 1010. Note that the graphics data GD is generated as raster data in the format such as JPEG and PNG.

The playback control engine 37 issues a command COM to the virtual file control unit 1032 according to instructions given from the respective modules 35 and 36, thereby to instruct an AV playback process or a playlist playback process. Furthermore, the playback control engine 37 includes a player register 38 and provides to the modules 35 and 36 the functionality of setting/monitoring the operation state of the playback device 102 using the player register 38.

AV playback is an essential process of a playback device and follows the playback processes of DVD and CD players. More specifically, the AV playback processes include playback start (Play), playback stop (Stop), pause during playback (Pause On), release pause to restart playback (Pause Off), release the still function (Still Off), fast forward at a specified speed (Forward Play (speed)) and rewind at a specified speed (Backward Play (speed)), audio switching (Audio Change), subtitle switching (Subtitle Change) and angle switching (Angle Change). When a request UO received from the dispatcher 34 instructs an AV playback process, each of the modules 35 and 36 requests the playback control engine 37 to execute the playback process. In response to the request, the playback control engine 37 issues a command COM indicating the process to the virtual file control unit 1032.

To execute the process of playing back a playlist, the playback control engine 37 follows the instructions given from the respective modules 35 and 36 to instruct the virtual file control unit 1032 to create a virtual package, transfer the current scenario information DS and SS to the respective scenario memories 31 and 32, and execute playback of the playlist specified by the current static scenario information SS.

When either of the respective modules 35 and 36 calls a service object according to the current dynamic scenario information DS, the Java module 36 issues instructions to the playback control engine 37 according to the service object. According to the instructions, the playback control engine 37 instructs the virtual file control unit 1032 to execute the following processes: (1) the process of detecting playitem information about an advertisement from the current static scenario information SS; and (2) the process of creating a virtual package from the update kit and replacing the current playlist with a playlist contained in the virtual package.

The player register 38 includes 32 system parameter registers (SPRs) and 32 general purpose registers (GPRs). The value held in each SPR is used as a variable SPRM by the modules 35 and 36. Similarly, the value stored in each GPR is used as a variable GPRM by the modules 35 and 36. In particular, the SPRs hold the parameters representing the current settings, available settings, and initial settings of the playback device 102. The parameters representing the current settings include the stream selection numbers of the audio, PG and text subtitle streams to be decoded and also include the identifies of the playlist and playitem to be played back. The parameters representing available settings include the numbers associated with selectable languages of the audio/subtitles and the numbers associated with the selectable coding methods of audio data. By referencing to the player register 38 according to the instructions given by the modules 35 and 36, the playback control engine 37 detects elementary streams that can be played back by both the playback device 102 and the display 103, from among the elementary streams registered in the stream selection table of each piece of playitem information. Furthermore, the playback control engine 37 selects an elementary stream having the smallest stream selection number from the selected elementary streams and sets the stream selection number in a corresponding one of the SPRs. In addition, the playback control engine 37 sets the PID described in the stream identification information of the selected elementary stream to the system target decoder 1013 as the PID indicating the elementary stream to be decoded. The SPRs and GPRs are managed by the playback control engine 37 independently of the modules 35 and 36. Accordingly, the modules 35 and 36 are enabled to promptly find out the operation state of the playback device 102 from SPRM and GPRM even immediately after an operation mode switching.

### <Structure of System Target Decoder 1013>

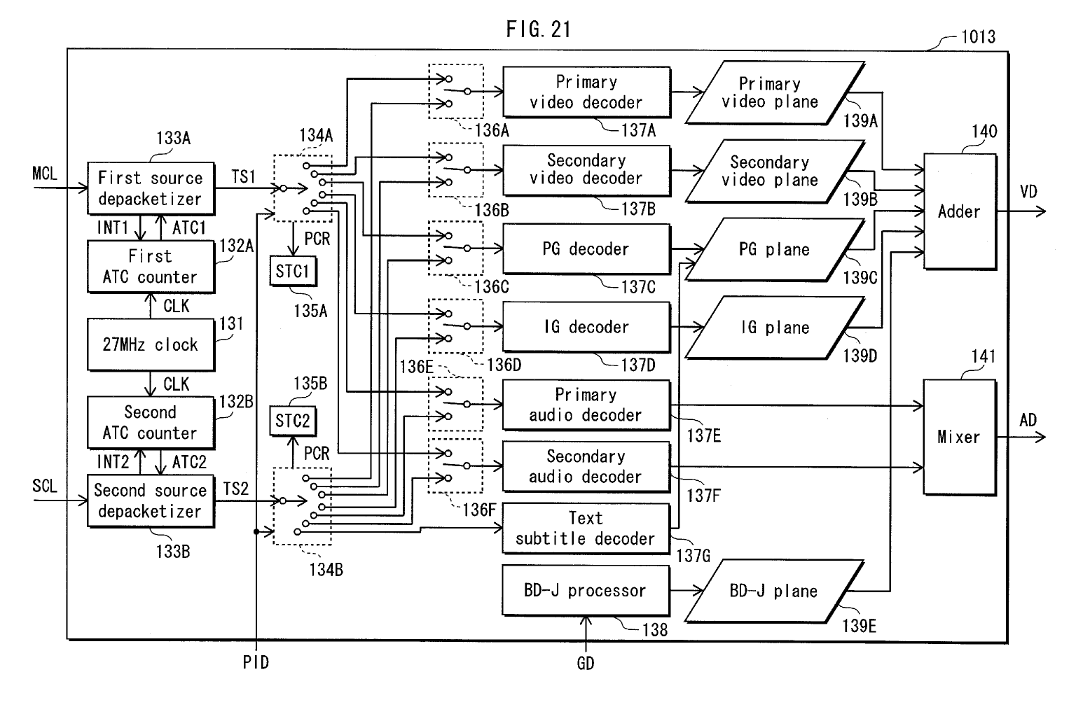

FIG. 21 is a block diagram of the system target decoder 1013. As shown in FIG. 21, the system target decoder 1013 includes a 27 MHz clock 131, a pair of ATC counters 132A and 132B, a pair of source depacketizers 133A and 133B, a pair of PID filters 134A and 134B, six switches 136A-136F, a primary video decoder 137A, a secondary video decoder 137B, a PG decoder 137C, an IG decoder 137D, a primary audio decoder 137E, a secondary audio decoder 137F, a text subtitle decoder 137G, a BD-J processor 138, a primary video plane 139A, a secondary video plane 139B, a PG plane 139C, an IG plane 139D, a BD-J plane 139E, an adder 140 and a mixer 141.

The 27 MHz clock 131 generates a clock signal CLK at a fixed frequency of 27 MHz. The ATC counters 132A and 132B each count the pulses of the clock signal CLK. The first ATC counter 132A initializes the count ATC1 in response to an initialization signal INT1 received from the first source depacketizer 133A. Similarly, the second ATC counter 132B initializes the count ATC2 in response to an initialization signal INT2 received from the second source depacketizer 133B.

The first source depacketizer 133A reads the AV clip file MCL in units of source packets from the first read buffer 1011 and extracts the TS packet TS1 from each source packet to send the TS packets TS1 to the first PID filter 134A. At this time, the first source depacketizer 133A adjusts the time for transferring the first TS packet TS1 in accordance with the ATS described in the header 651H of the source packet (see FIG. 8). More specifically, the first source depacketizer 133A compares the count ATC1 of the first ATC counter 132A with the ATS of each source packet and transfers, at the time when the ATS of a source packet matches the count ATC1, the TS packet TS1 contained in that source packet. Similarly, the second source depacketizer 133B reads the AV clip file SCL from the second read buffer 1012 in units of source packets and extracts a TS packet TS2 from each source packet. Furthermore, at the time when the ATS of a source packet matches the count ATC2 of the second ATC counter 132B, the second source depacketizer 133B transfers the first TS packet TS2 contained in that source packet to the second PID filter 134B.

The first PID filter 134A receives the TS packets TS1 from the first source depacketizer 133A and reads the PID from the TS header 650H (see FIG. 8) of each TS packet TS1. Furthermore, the first PID filter 134A checks the read PID against the PID of the elementary stream set by the playback control engine 37 as the decoding target. If the two PIDs match, the first PID filter 134A transfers the TS packets TS1 to an appropriate one of the six decoders 137A-137F according to the PID. For example, when the PID of an TS packet TS1 is “0x1011”, that TS packet TS1 is transferred to the primary video decoder 137A. Similarly, when the PID of a TS packet TS1 falls within a range of “0x1B00” to “0x1B1F”, that TS packet TS1 is transferred to the secondary video decoder 137B. When the ND of a TS packet TS1 falls within a range of “0x1100” to “0x111F”, that TS packet TS1 is transferred to the primary audio decoder 137E. When the PID of a TS packet TS1 falls within a range of “0x1A00” to “0x1A1F”, that TS packet TS1 is transferred to the secondary audio decoder 137F. When the PID of a TS packet TS1 falls within a range of “0x1200” to “0x121F”, that TS packet TS1 is transferred to the PG decoder 137C. When the PID of a TS packet TS1 falls within a range of “0x1400” to “0x141F”, that TS packet TS1 is transferred to the IG decoder 137D. Similarly to the first PID filter 134A, the second PID filter 134B receives TS packets TS2 from the second source depacketizer 133B and transfers each TS packet TS2 having the same PID as the PID of the elementary stream set by the playback control engine 37 as the decoding target. More specifically, the second PID filter 134B transfers each TS packet TS2 to a corresponding one of the seven decoders 137A-137G according to the PID of the TS packet TS2. Note that the text subtitle stream is stored only in the AV clip file SCL of a sub-path, the TS packets of the text subtitle stream are transferred from the second PID filter 134B to the text subtitle decoder 137G.

Furthermore, the first PID filter 134A detects the PCR from the TS packets TS1 received from the first source depacketizer 133A using the PID of each TS packet TS1. At this point, the first PID filter 134A sets the first STC (STC1) 135A to the predetermined value. Similarly, the second PID filter 134A detects the PCR from the TS packets TS2 received from the second source depacketizer 133B and sets the second STC (STC2) 135B to the predetermined value. Note that the values to which the STC 135A and STC 135B are set are instructed to the PID filters 134A and 134B from the playback control unit 1033 in advance. With the use of STC 1135A and STC 2135B, each of the decoders 137A-137G adjusts the timing for processing the TS packets TS1 and TS2 received from the respective PID filters 134A and 134B to synchronize with PTS and DTS indicated by data contained in the TS packets TS1 and TS2.

As described above, the first source depacketizer 133A and the first PID filter 134A process the AV clip file MCL of the main path transferred from the first read buffer 1011. In parallel with processing of the AV clip file MCL, the second source depacketizer 133B and the second PID filter 134B process the AV clip file SCL, which is of a sub-path, transferred from the second read buffer 1012. Each of the switches 136A-136F operate to alternately pass the TS packets TS1 and TS2 transferred from the PID filters 134A and 134B to the respective one of the six decodes 137A-137F, except for the text subtitle decoder 137G. The system target decoder 1013 adjusts the timing for switching by the respective switches 136A-136F, with the use of STC 1135A and STC 2135B. As a result, in the case where the AV clip file SCL of a synchronous type sub-path, the system target decoder 1013 controls the decoders 137A-137G to process the AV clip files MCL and SCL synchronously. On the other hand, in the case where the AV clip file SCL is of an asynchronous type sub-path, the system target decoder 1013 controls the decoders 137A-137G to process the AV clip files MCL and SCL asynchronously. Note that the sub-path type of the AV clip file SCL is instructed from the virtual file control unit 1032 to the system target decoder 1013 in advance.

The primary video decoder 137A receives the TS packets TS1 and TS2 of the primary video stream from the PID filters 134A and 134B and holds the received TS packets in the internal buffer. In parallel with storing the received TS packets, the primary video decoder 137A reads TS packets from the internal buffer, removes the TS header and PES header 602H (see FIG. 7) from each read TS packet to leave the PES payload 602P, and extracts coded pictures (I-picture yy1, B-pictures yy3 and yy4, and P-picture yy2) from the PES payload 602P. Furthermore, the primary video decoder 137A decodes each coded picture with the timing indicated by the DTS described in the PES header 602H, and writes the decoded and thus uncompressed picture to the primary video plane 139A with the timing indicated by the PTS described in the PES header 602H. Note that the primary video decoder 137A checks the attribute of the primary video stream targeted for the decoding, to interpret the coding format in advance and switches the decoding process according to the coding format.

The secondary video decoder 137B includes a similar mechanism to the primary video decoder 137A. With the use of the mechanism, the secondary video decoder 137B receives TS packets TS1 and TS2 of the secondary video stream from the PID filters 134A and 134B and extract coded pictures from the TS packets. Furthermore, the secondary video decoder 137B decodes each coded picture at the timing indicated by DTS described in a corresponding TS packet and writes the decoded and thus uncompressed picture to the secondary video plane 139B at the timing indicated by PTS described in the TS packet.

The PG decoder 137C receives TS packets TS1 and TS2 of the PG stream from the PID filters 134A and 134B and extracts pieces of coded graphics data from the TS packets. Furthermore, the PG decoder 137C decodes coded graphics data at the timing indicated by DTS described in a corresponding TS packet and writes the decoded and thus uncompressed graphics data to the PG plane 139C at the timing indicated by PTS described in the TS packet.

The IG decoder 137D receives TS packets TS1 and TS2 of the IG stream from the ND filters 134A and 134B and extracts pieces of coded graphics data from the TS packets. Furthermore, the IG decoder 137D decodes each piece of coded graphics data at the timing indicated by DTS described in a corresponding TS packet and writes the decoded and thus uncompressed graphics data to the IG plane 139D at the timing indicated by PTS described in the TS packet.

The primary audio decoder 137E receives the TS packets TS1 and TS2 of the primary audio stream from the PID filters 134A and 134B and holds the received TS packets in the internal buffer. In parallel with storing the received TS packets, the primary audio decoder 137E reads TS packets from the internal buffer, removes the TS header and PES header from each read TS packet to leave the PES payload, and extracts coded LPCM audio data from the PES payload. Furthermore, the primary audio decoder 137E decodes the coded audio data and outputs the coded and thus uncompressed audio data to the mixer 141 at the timing indicated by PTS described in a corresponding TS packet. Note that the primary audio decoder 137E checks the attribute of the primary audio stream targeted for the decoding, to interpret the coding format in advance and switches the decoding process depending according to the coding format.

The secondary audio decoder 137F includes a similar mechanism to the primary audio decoder 137E. With the use of the mechanism, the secondary audio decoder 137F receives TS packets TS1 and TS2 of the secondary audio stream from the PID filters 134A and 134B, decodes the coded LPCM audio data contained in each TS packet into uncompressed audio data, and outputs the decoded and thus uncompressed audio data to the mixer 141 at the timing indicated by PTS described in a corresponding TS packet.

The text subtitle decoder 137G receives TS packets TS2 of the text subtitle stream from the second PID filter 134B, extracts the coded text character sequence from the received TS packets, and decode the extracted text character sequence. Furthermore, the text subtitle decoder 137G generates raster data of fonts representing the decoded text character sequence, with the use of built-in font data, and writes the raster data into the PG plane 139C at the timing indicated by the PTS described in a corresponding TS packet.

The BD-J processor 138 receives the graphics data GD from the Java module 36 of the playback control unit 1033 and decodes the received graphics data GD. Furthermore, the BD-J processor 138 writes decoded uncompressed graphics data into the BD-J plane 139E at the timing indicated by the PTS that is specified by the Java module 36 according to the BD-J application program.

The primary video plane 139A is an area reserved in the internal memory of the system target decoder 1013 and has a size equal to one video plane. In the primary video plane 139A, one video plane representing a primary video of a movie is formed from uncompressed picture data written by the primary video decoder 137A.

The secondary video plane 139B is an area reserved in the internal memory of the system target decoder 1013 and has a size equal to one video plane. In the secondary video plane 139B, one video plane representing a secondary video to be presented with the main video is formed from uncompressed picture data written by the secondary video decoder 137B.

The PG plane 139C is an area reserved in the internal memory of the system target decoder 1013 and has a size equal to one video plane. In the PG plane 139C, one video plane representing graphics to be presented with the main video is formed from uncompressed graphics data written by the PG decoder 137C. In the PG plane 139C, in addition, one video plane representing subtitles to be presented with the primary video is formed from raster data written by the text subtitle decoder 137G.

The IG plane 139D is an area reserved in the internal memory of the system target decoder 1013 and has a size equal to one video plane. In the IG plane 139D, one video plane representing graphics to be presented with the main video is formed from uncompressed graphics data written by the IG decoder 137D.

The BD-J plane 139E is an area reserved in the internal memory of the system target decoder 1013 and has a size equal to one video plane. In the BD-J plane 139E, one video plane representing graphics to be presented with the main video is formed from uncompressed graphics data written by the BD-J processor 138.

The adder 140 overlays the video planes formed on the respective planes 139A-139E into one video plane to output as the video data VD.

The mixer 141 mixes uncompressed audio data output from the primary audio decoder 137E and uncompressed audio data output from the secondary audio decoder 137F into one piece of audio data AD. The audio data AD represents audio produced by superimposing the pieces of audio data from both the decoders 137E and 137F.

### <Playlist Playback Process by Playback Device 102>

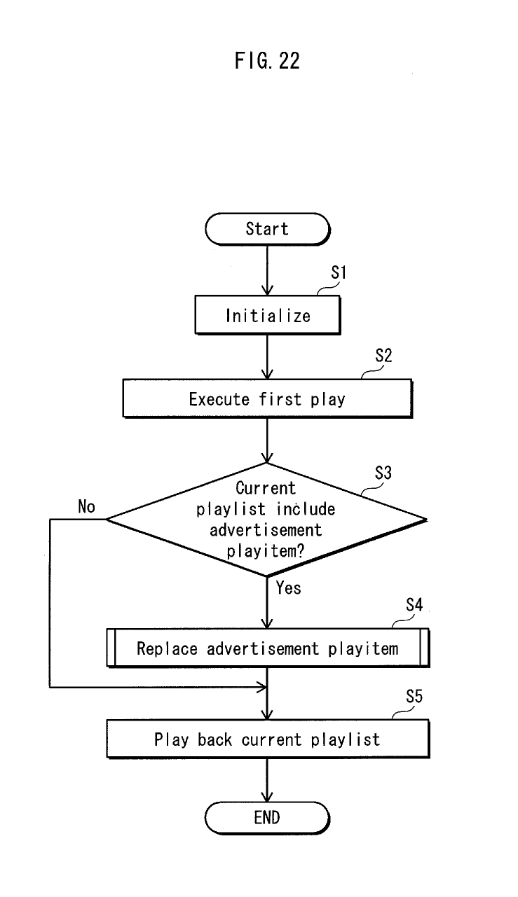

FIG. 22 is a flowchart of the process of playing back a playlist by the playback device 102. The following describes the process of playing back a playlist, in the order of the steps shown in FIG. 22.

Step S1: When the playback device 102 is switched on, the system LSI 1000 starts initialization of the functional units 1001, 1010 and 1030 (see FIG. 18). In particular, the playback control unit 1033 prepares run-time environments for application programs.

Step S2: The operation unit 102E detects insertion of the BD-ROM disc 101 into the BD-ROM drive 102A, and then sends a notification INT indicating the insertion to the user event processing unit 1031 (see FIGS. 16 and 18). In response to the notification INT, the user event processing unit 1031 sends a request UO to the playback control unit 1033 to instruct reading of an index file from the BD-ROM disc 101. In the playback control unit 1033, the module manager 33 responds to the request UO with issuing a command COM to the virtual file control unit 1032 via the playback control engine 37 (see FIG. 20), thereby causing the virtual file control unit 1032 to read the index file IF from the BD-ROM disc 101. Furthermore, the module manager 33 references the first play 421A of the index table 421 contained in the index file IF (see FIG. 3), and then provides the Java module 36 with the name of a BD-J object file specified in the first play. The Java module 36 issues a command COM to request the BD-J object file with the file name from the virtual file control unit 1032. In response to the command COM, the virtual file control unit 1032 passes the BD-J object file, as current dynamic scenario information DS, from the BD-ROM disc 101 to the playback control unit 1033. Thus, the Java module 36 reads the BD-J object specified in the first play from the dynamic scenario information DS, and then executes BD-J application programs according to the BD-J object.

Furthermore, the Java module 36 issues a command COM to the virtual file control unit 1032 so as to request the current playlist file and service object file according to the BD-J object specified in the first play. In response to the command COM, the virtual file control unit 1032 reads the playlist file and service object file from the BD-ROM disc 101, and then passes the playlist file to the playback control unit 1033 as current static scenario information SS and adds the service object file to the current dynamic scenario information DS. The Java module 36 reads a service object from the dynamic scenario information DS, and then executes BD-J application programs according to the service object. As a result, the process of replacing an advertisement playitem included in a current playlist is performed in the order of Steps S3 and S4 described below.

Step S3: The Java module 36 causes the playback control engine 37 to read the playlist mark information 431 (See FIG. 15A) from the current static scenario information SS and to detect a playlist mark of the mark type “advertisement”. If such a playlist mark is detected, the Java module 36 judges that the current playlist includes an advertisement playitem, and thus moves the process to Step S4. If such a playlist mark is not detected, the Java module 36 judges that the current playlist does not include any advertisement playitem, and thus moves the process to Step S5.

Step S4: The Java module 36 replaces the current playlist with a new playlist. The new playlist is different from the current playlist in that a new advertisement playitem is substituted for the original advertisement playitem. Details of Step S4 will be described later.

Step S5: The Java module 36 returns to the process according to the BD-J object specified in the first play, from the process according to the service object. Then, the Java module 36 instructs the playback control engine 37 to play back the current playlist. In response to the instruction, the playback control engine 37 reads playlist information from the current static scenario information SS, and according to the playlist information, causes the virtual file control unit 1032 to transfer AV clip files to be played back from the BD-ROM disc 101, the local storage 1021 or the server device 106 to the playback unit 1010. The playback unit 1010 decodes the AV clip files into elementary streams to reproduce video data VD and audio data AD. Furthermore, the video output unit 102G converts the video data VD into a video signal VS and then provides the video signal VS to the display 103, whereas the audio output unit 102H converts the audio data AD into an audio signal AS and provides the audio signal AS to the speaker 103A. In this manner, the current playlist is played back.

### <Process in Step S4 of Replacing Advertisement Playitem>

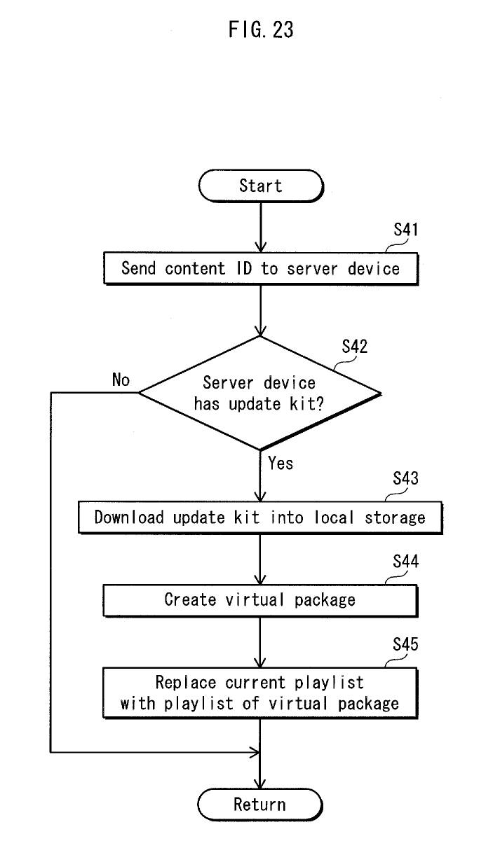

FIG. 23 is a flowchart of the process of replacing an advertisement playitem; the process is performed in Step S4.

Step S41: The Java module 36 first reads the content ID 422 from the index file IN (see FIG. 3) held in the module manager 33. Next, the Java module 36 sends the content ID to the server device 106 located on the network 105 via the network interface 102D (see FIG. 16).

Step S42: The server device 106 manages update kits for various AV contents in association with the content IDs of the AV contents. An update kit includes one or more new advertisement playitems to be substituted for one or more original advertisement playitems. Specifically, the update kit includes a new playlist file, a new clip information file, a new AV clip file and a merge management information file. The new playlist file differs from the original playlist file recorded on the BD-ROM in that playitem information for new advertisements is substituted for the original playitem information. The new clip information file is management information relating to the new AV clip file, and the new AV clip file includes contents of the new advertisements. The merge management information file specifies the paths of the original playlist files as virtual file paths associated with local storage paths of the new playlist files.

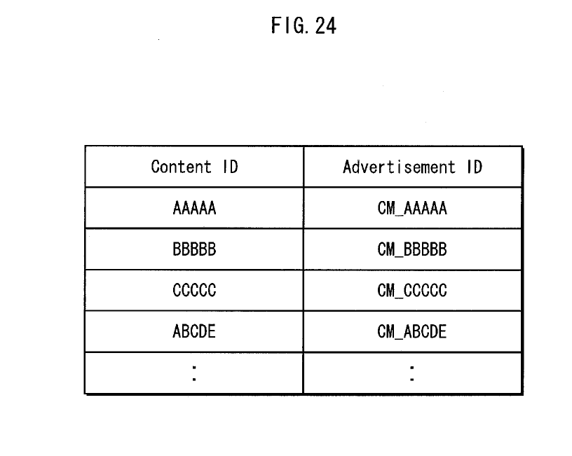

FIG. 24 is a table that shows the correspondence between content IDs and advertisement IDs and is stored in the server device 106. The advertisement IDs shown in FIG. 24 are allocated individually to the update kits. When receiving a content ID from the Java module 36, the server device 106 searches the table shown in FIG. 24 for an advertisement ID associated with the content ID. For example, if the content ID is “AAAAA”, the advertisement ID “CM_AAAAA” associated with “AAAAA” is retrieved. In that case, the server device 106 returns the advertisement ID to the Java module 36 as a response to the content ID. On the other hand, if any advertisement ID associated with the content ID cannot be retrieved from the table shown in FIG. 24, the server device 106 notifies the Java module 36 of the result by a response to the content ID.

After transmitting the content ID, the Java module 36 waits for a response from the server device 106. When receiving the response, the Java module 36 determines from the response whether the server device 106 has an update kit for the BD-ROM disc 101. If the response indicates the advertisement ID, the Java module 36 determines that the server device 106 has an update kit for the BD-ROM disc 101, and thus moves the process to Step S43. On the other hand, if the response indicates that any advertisement ID associated with the content ID is not retrieved, the Java module 36 determines that the server device 106 does not have an update kit for the BD-ROM disc 101, and thus terminates the process of replacing an advertisement playitem.

Step S43: The Java module 36 transmits the advertisement ID received from the server device 106 to the server device 106. When receiving the advertisement ID, the server device 106 provides the playback device 102 with the update kit 205 (see FIG. 17A) to which the advertisement ID is allocated. The Java module 36 causes the network interface 102D (see FIG. 18) to receive and store the update kit 205 into the local storage 1021. In this manner, the update kit 205 containing a new advertisement playitem is downloaded from the server device 106 to the local storage 1021.

Step S44: When the download of the update kit is completed, the Java module 36 provides the virtual file control unit 1032 with a command COM to create a virtual package. In response to the command COM, the virtual file control unit 1032 first acquires the Org ID and Disc ID from the BD-ROM disc 101, and then detects the Org ID directory 2053 and the Disc ID directory 2054 with the directory names representing the IDs from the local storage 1021 (see FIG. 17A). Furthermore, the virtual file control unit 1032 reads the merge management information file 2054A and the signature information file 2054B from the Disc ID directory 2054, and then authenticates the merge management information file 2054A by using the file 2054B together with the merge certificate 2048A stored on the BD-ROM disc 101. After the authentication is successful, the virtual file control unit 1032 incorporates the additional content files 2054C-2054G contained in the Disc ID directory 2054 into the virtual package 206 (see FIG. 19) according to the merge management information file 2054A. In this manner, the virtual package 206 is created.

Step S45: The Java module 36 again issues a command COM to request a current playlist file from the virtual file control unit 1032. In response to the command COM, the virtual file control unit 1032 reads and passes the playlist file from the virtual package to the playback control unit 1033 as the current static scenario information SS. Then, the process of replacing an advertisement playitem is completed.

When the virtual package 206 is created in Step S4, a playlist is played back from the virtual package 206 during the playlist playback of Step S5. In that case, an access to the playlist file 2063A contained in the virtual package 206 leads an access to the additional playlist file 2054C, instead of an access to the playlist file 2043A recorded on the BD-ROM disc 101. That is, the playlist file 2043A recorded on the BD-ROM disc 101 is replaced with the additional playlist file 2054C. In contrast to the playlist file 2043A on the BD-ROM disc 101, the additional playlist file 2054C includes playitem information about a new advertisement instead of the playitem information about the original advertisement. Consequently, during the playback section specified by the playitem information, the additional AV clip files 2054F and 2054G are played back, instead of the AV clip files 2045A and 2045B recorded on the BD-ROM disc 101.

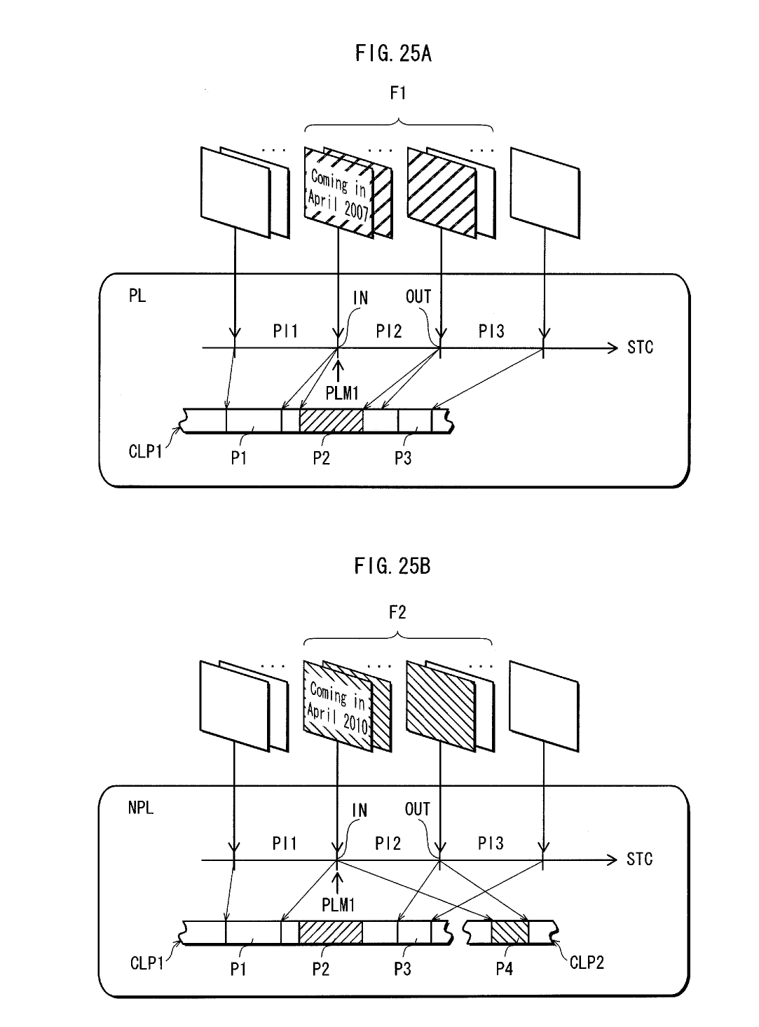

FIG. 25A is a schematic view showing a playlist PL that is played back in Step S5 when Step S4 is skipped. In the example shown in FIG. 25A, the clip information file on the BD-ROM disc 101 is referenced according to the playlist file on the BD-ROM disc 101, so that the portions P1, P2 and P3 of the AV clip file CLP1 on the BD-ROM disc 101 are sequentially targeted for playback during the respective playback sections PI1, P12 and PI3 of the playlist PL. Furthermore, the playlist file includes the playlist mark PLM1 set for the playback start time IN of the playback section P12 of a playitem. The playlist mark PLM1 is of the mark type “advertisement”, and accordingly indicates that a group of frames F1 representing an advertisement is to be played back from the portion P2 of the AV clip file CLP1 during the playback section PI2.

FIG. 25B is a schematic view of a playlist NPL that is played back in Step S5 when the virtual package 206 is created in Step S4. The playlist file included in the virtual package 206 is not the playlist file 2043A recorded on the BD-ROM disc 101 but the additional playlist file 2054C. On the other hand, the playlist mark PLM1 of the mark type “advertisement” is set for the playback start time of the playback section PI2 in the playlist NPL. Accordingly, the playitem information indicating the playback section PI2 references the additional clip information files 2054D and 2054E, instead of the clip information files 2044A and 2044B recorded on the BD-ROM disc 101. As a result, the example shown in FIG. 25B differs from one shown in FIG. 25A in that a group of frames F2 representing a new advertisement is played back from the portion P4 of the additional AV clip file CLP2 during the playback section PI2, instead of the portion P2 of the AV clip file CLP1 recorded on the BD-ROM disc 101. In this manner, a file on the BD-ROM disc 101 is replaced with an additional content file so that the advertisement playitem is replaced with a new advertisement playitem.

As set forth above, the playback device 102 according to Embodiment 1 of the present invention can play back a desired new advertisement playitem during the playback section of an advertisement playitem embedded in the playlist recorded on the BD-ROM disc 101. By adopting an advertisement more relevant to the playlist as the new advertisement, the playback device can reduce the possibility that an advertisement of low interest to viewers is played back when the playlist is played back. As a result, the playback device can further reduce the risk that insertion of an advertisement disturbs the entertaining effect of the playlist. Furthermore, the playback device can also improve the advertising effect of the advertisement.

### Embodiment 2

An optical disc playback device according to Embodiment 2 of the present invention differs from the playback device according to Embodiment 1 with respect to the features of service objects and Step S4 shown in FIG. 22, i.e., the process of replacing an advertisement playitem. The differences are, in particular, as follows: (1) for the process, only a clip information file and AV clip file of a new advertisement is used rather than the entirety of an update kit for the BD-ROM disc, and (2) the playback device rewrites the playitem information of an advertisement on the static scenario memory. The other features of the playback device according to Embodiment 2 are similar to those according to Embodiment 1, such as the data structure of the BD-ROM disc to be played back, the hardware structure of the playback device, the functional units in the system LSI, and the structures of the playback control unit and the system target decoder. Accordingly, the features of Embodiment 2 different from those of Embodiment 1 will be described below. Details of the features similar to those of Embodiment 1 can be found in the descriptions about Embodiment 1.

### <Features of Service Object>

A service object file according to Embodiment 2 of the present invention includes an application management table (see FIG. 4C) specifying, in particular, a BD-J application program that causes the Java virtual machine 36A to execute the following processes: (1) A process of detecting a playitem representing an advertisement from a playlist recorded on the BD-ROM disc 101; (2) a process of reading a clip information file and AV clip file of a new advertisement from the server device 106 on the network 105 or an external storage device, such as the memory card 107; (3) a process of rewriting the playitem information of the detected playitem representing the advertisement so that the clip information file and AV clip file of the new advertisement are referenced.

In the playback control unit 1033 according to Embodiment 2 of the present invention (see FIGS. 18 and 20), the DVD-like module 35 or Java module 36 calls a service object according to current dynamic scenario information DS, and in that case, the Java module 36 issues instructions to the playback control engine 37 according to the service object. In response to the instructions, the playback control engine 37 instructs the virtual file control unit 1032 to perform the following processes: (1) a process of detecting playitem information about an advertisement from current static scenario information SS; and (2) a process of rewriting the detected playitem information about the advertisement so that a clip information file and AV clip file of a new advertisement are referenced. Furthermore, the Java module 36 downloads the clip information file and AV clip file of the new advertisement from the external storage device to the local storage 1021, according to the service object.

### <Process of Replacing Advertisement Playitem>

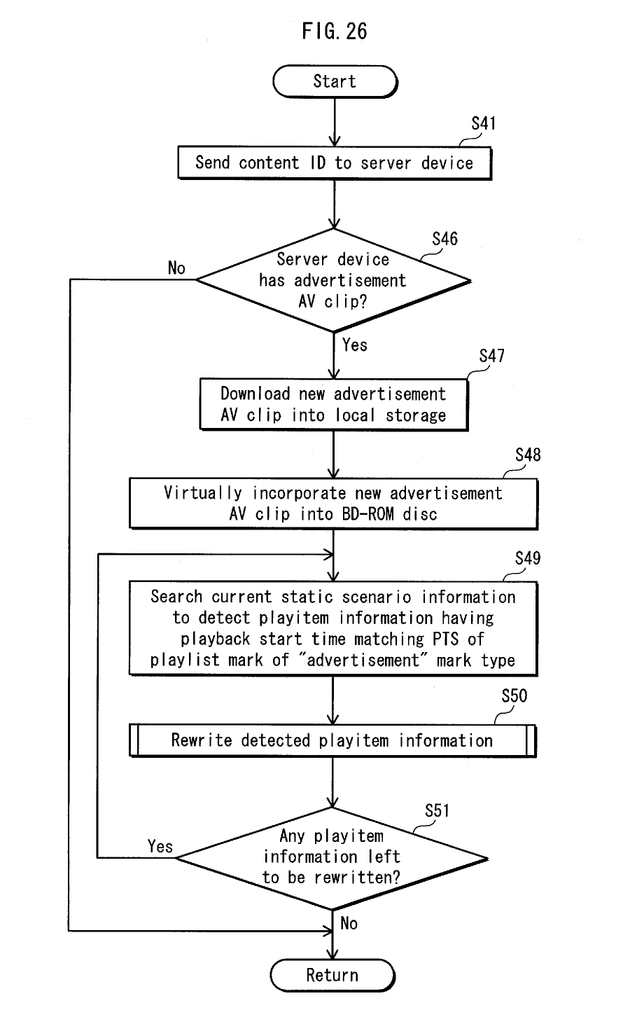

FIG. 26 is a flowchart of the process of replacing an advertisement playitem, according to Embodiment 2 of the present invention.

Step S41: Similarly to Step S41 according to Embodiment 1 of the present invention, the Java module 36 first reads the content ID 422 (see FIG. 3) from the index file IN held in the module manager 33. Next, the Java module 36 sends the content ID to the server device 106 on the network 105 via the network interface 102D (see FIG. 16).

Step S46: The server device 106 manages pairs of a clip information file and an AV clip file that represent new advertisements (hereinafter, abbreviated as new advertisement AV clips) for various AV contents; the new advertisement AV clips are each associated with the content ID of one of the AV contents. That is, Embodiment 2 of the present invention differs from Embodiment 1 in that the advertisement IDs shown in FIG. 24 are individually associated with the advertisement AV clips.

Note that each AV clip is attached with information to be used for rewriting the stream selection table included in playitem information (see FIG. 13). The AV clip file may have a network attribute. In that case, information indicating the presence of the network attribute is attached to the AV clip. Furthermore, one AV clip may include two or more pairs of a clip information file and an AV clip file. One of the pairs is used to play back the main path and another thereof is used to play back a sub-path. Such an AV clip is attached with information indicating the allocation of the individual pairs to the main path and sub-path, information to be used to add a sub-path to playlist information, or information to be used to add or overwrite sub-playitem information to a sub-path existing in playlist information.

When receiving a content ID from the Java module 36, the server device 106 retrieves an advertisement ID associated with the content ID from the table shown in FIG. 24, and then sends the advertisement ID to the Java module 36 as a response to the content ID. On the other hand, if any advertisement ID associated with the content ID is not retrieved from the table shown in FIG. 24, the server device 106 notifies the Java module 36 of the result as a response to the content ID.

After transmitting the content ID, the Java module 36 waits for a response from the server device 106. When receiving the response, the Java module 36 determines from the response whether the server device 106 has a new advertisement AV clip. If the response indicates the advertisement ID, the Java module 36 determines that the server device 106 has a new advertisement AV clip, and thus moves the process to Step S47. On the other hand, if the response indicates that any advertisement ID associated with the content ID cannot be retrieved, the Java module 36 determines that the server device 106 does not have any new advertisement AV clip, and thus terminates the process of replacing an advertisement playitem.

Step S47: The Java module 36 transmits the advertisement ID received from the server device 106 to the server device 106. When receiving the advertisement ID, the server device 106 transmits the new advertisement AV clip associated with the advertisement ID to the playback device 102. The Java module 36 instructs the network interface 102D (see FIG. 18) to receive and store the new advertisement AV clip into the local storage 1021. In this manner, the new advertisement AV clip is downloaded from the server device 106 to the local storage 1021. Note that when the AV clip file of the new advertisement has a network attribute, portions of the new advertisement AV clip except for the AV clip file are downloaded in Step S47. The AV clip file is downloaded at or before the time when actually played back.

Step S48: The Java module 36 causes the virtual file control unit 1032 to incorporate the new advertisement AV clip into the BD-ROM disc 101 in a virtual manner. In other words, the Java module 36 causes the virtual file control unit 1032 to convert the path of the AV clip on the local storage 1021 to a path on the BD-ROM disc 101. As a result, the Java module 36 can access the new advertisement AV clip as if it were files on the BD-ROM disc 101. If the virtual package has already been created, the Java module 36 causes the virtual file control unit 1032 to incorporate the new advertisement AV clip into the existing virtual package. As a result, the Java module 36 can access the new advertisement AV clip through a path on the virtual package.

After completion of downloading the new advertisement AV clip, or in parallel with the downloading thereof, the Java module 36 repeats the loop consisting of Steps S49-S51 described below. Through the repetition, all pieces of playitem information of advertisements included in the current static scenario information SS are overwritten on the static scenario memory 21 (see FIG. 20).

Step S49: The Java module 36 causes the playback control engine 37 to detect playitem information indicating the playback start time matching the PTS of the detected playlist mark (see FIG. 15A) from the current static scenario information SS. Since the mark type of the detected playlist mark indicates “advertisement”, the detected playitem information is playitem information about an advertisement.

Step S50: The Java module 36 rewrites the playitem information detected in Step S49. Details of the rewriting process will be described later.

Step S51: The Java module 36 causes the playback control engine 37 to further detect a playlist mark of the mark type indicating “advertisement” from playlist mark information 431 (see FIG. 15A) read from the current static scenario information SS in Step S3. If such a playlist mark is detected, the Java module 36 determines that there still remains playitem information to be rewritten, and then returns the process to Step S49. On the other hand, if such a playlist mark is not detected, the Java module 36 determines that there is no more playitem information to be rewritten, and then terminates the process of replacing an advertisement playitem.

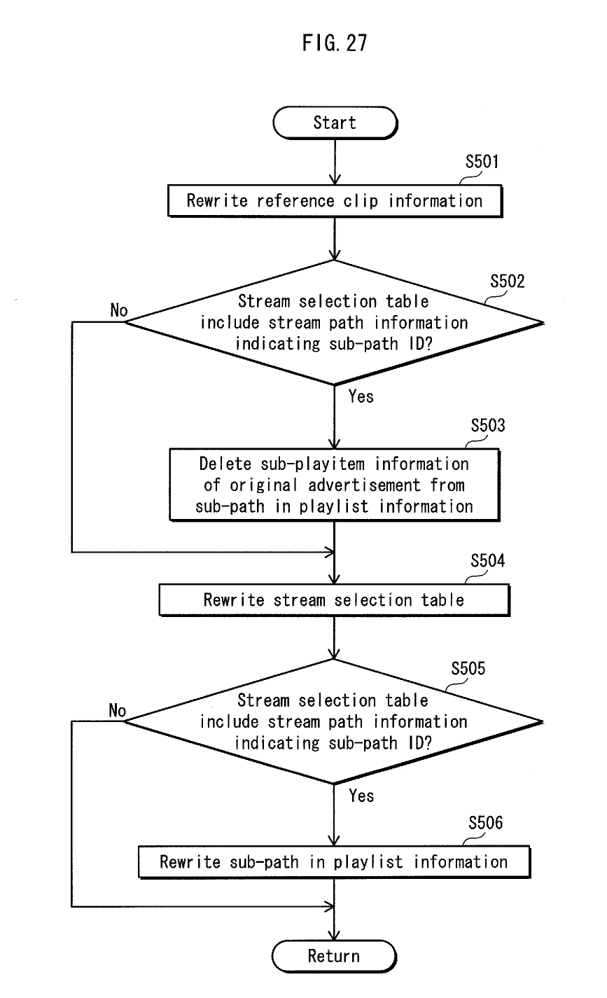

FIG. 27 is a flowchart of the process of rewriting playitem information; the process is performed in Step S50. The Java module 36 rewrites playitem information 1400 (see FIG. 13) detected in Step S49, i.e., playitem information about an original advertisement, in the following steps.

Step S501: The Java module 36 rewrites the playitem information 1400 about the original advertisement so that the file name described in the reference clip information 1401 is changed to the file name of a clip information file of a new advertisement. If two or more clip information files represent the new advertisement, the Java module 36 selects the name of a file belonging to the main path.

Step S502: The Java module 36 checks whether stream path information 1407 indicating a sub-path ID is found in the stream selection table 1405 included in the playitem information 1400 about the original advertisement. If such stream path information 1407 is found, the Java module 36 retrieves all the sub-path IDs indicated by the stream path information 1407, and then moves the process to Step S503. If such stream path information 1407 is not found, the Java module 36 moves the process to Step S504.

Step S503: The Java module 36 causes the playback control engine 37 to detect sub-paths from the current static scenario information SS; the sub-paths have the sub-path IDs retrieved in Step S502. Furthermore, the Java module 36 deletes from the sub-paths all sub-playitem information including the playitem ID of the playitem information 1400 about the original advertisement.

Step S504: The Java module 36 uses information attached to the new advertisement AV clip to overwrite the stream selection table 1405 included in the playitem information 1400 about the original advertisement with the stream selection table included in the playitem information about the new advertisement.

Step S505: The Java module 36 checks whether stream path information 1407 indicating a sub-path ID is found in the stream selection table 1405 included in the playitem information 1400 about the new advertisement. If such stream path information 1407 is found, the Java module 36 retrieves all sub-path IDs indicated in the stream path information 1407, and then moves the process to Step S506. If such stream path information 1407 is not found, the Java module 36 terminates the process of rewriting playitem information.

Step S506: The Java module 36 causes the playback control engine 37 to detect sub-paths from the current static scenario information SS; the sub-paths have the sub-path IDs retrieved in Step S502. If any sub-path having one of the sub-path IDs is not found, the Java module 36 uses information attached to the new advertisement AV clip to add a new sub-path to the playlist information included in the current static scenario information SS. If a sub-path is detected, the Java module 36 uses the information attached to the new advertisement AV clip to add sub-playitem information about the new advertisement to the sub-path. When the above-described process is completed for all the sub-path IDs retrieved in Step S502, the Java module 36 terminates the process of rewriting playitem information.

Through Steps S41-S51 described above, on the static scenario memory 21, the playitem information about the original advertisement included in the current playlist information is overwritten with the playitem information about the new advertisement. Accordingly, AV clip files representing the new advertisement are played back from the local storage 1021 during the playback sections indicated by the playitem information, instead of AV clip files recorded on the BD-ROM disc 101. Similarly to Embodiment 1, this results that the group of frames F2 representing the new advertisement is played back during the playback section P12 of the playlist NPL shown in FIG. 25B, instead of the group of frames F1 representing the original advertisement played back during the playback section PI2 of the playitem PL shown in FIG. 25A. In this manner, the playitem representing the original advertisement is replaced with the playitem representing the new advertisement.

Steps S41-S51 may be modified to collectively replace two or more advertisement playitems included in a current playlist with one playitem representing a new advertisement.

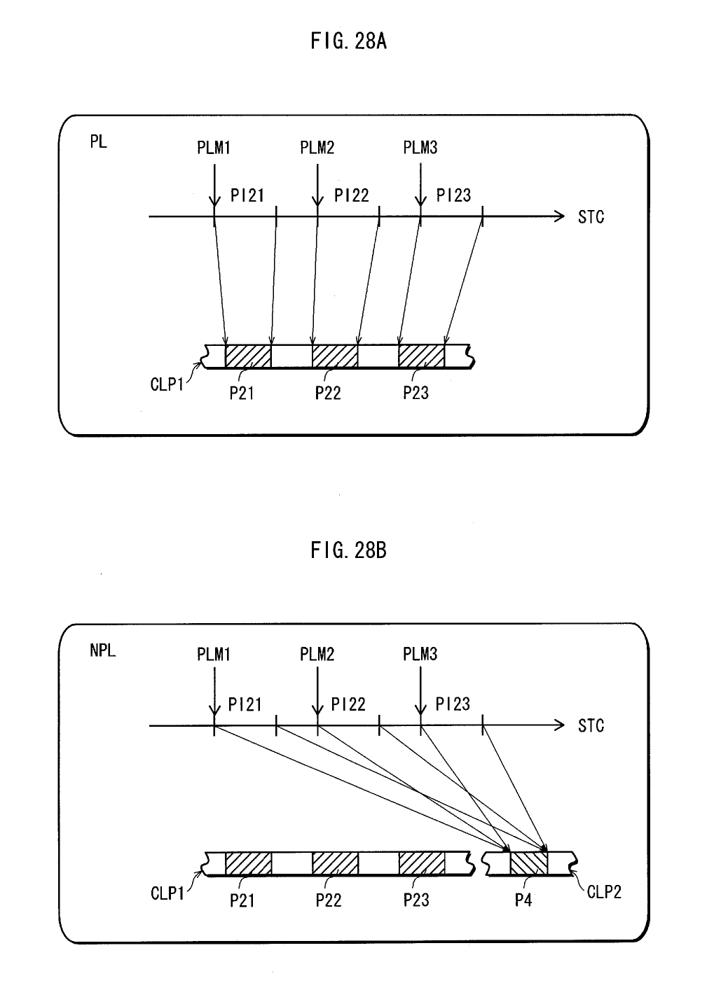

FIG. 28A is a schematic view showing a playlist PL that is played back in Step S5 if Step S4 is skipped. In the example shown in FIG. 28A, portions P21, P22 and P23 of an AV clip file CLP1 recorded on the BD-ROM disc 101 are sequentially targeted for playback during playback sections PI21, PI22 and PI23 of the playlist PL. Furthermore, the playlist file includes playlist marks PLM1, PLM2 and PLM3 set for the playback start times of the playback sections PI21, PI22 and PI23, respectively. Each of the playlist marks PLM1, PLM2 and PLM3 has the mark type “advertisement”.

FIG. 28B is a schematic view of a playlist NPL played back in Step S5 if playitem information is rewritten in Step S4. On the static scenario memory 21, the pieces of playitem information specified by the respective playlist marks PLM1, PLM2 and PLM3 included in current playlist information NPL are replaced with the same piece of playitem information about a new advertisement. Accordingly, the pieces of the playitem information reference, not the clip information files recorded on the BD-ROM disc 101, but the same clip information files stored on the local storage 1021. As a result, the example shown in FIG. 28B differs from the example shown in FIG. 28A in that the same portion P4 of the AV clip file CLP2 stored on the local storage 1021 is played back during all the playback sections PI21, PI22 and PI23 indicated by the respective pieces of the playitem information, instead of the portions P21, P22 and P23 of the AV clip file CLP1 stored on the BD-ROM disc 101. In this manner, two or more advertisement playitems are collectively replaced with the same new advertisement playitem.

As set forth above, the playback device according to Embodiment 2 of the present invention can play back a desired new advertisement playitem during the playback section of an advertisement playitem embedded in the playlist recorded on the BD-ROM disc 101, similarly to that according to Embodiment 1. Accordingly, the playback device according to Embodiment 2, similarly to one according to Embodiment 1, can reduce the possibility that an advertisement of low interest to viewers is played back when a playlist is played back. As a result, the playback device of Embodiment 2 can further reduce the risk that insertion of an advertisement disturbs the entertaining effect of the playlist. Furthermore, the playback device of Embodiment 2 can also improve the advertising effect of the advertisement. In addition, Embodiment 2 can reduce the amount of data to be downloaded from an external storage device such as the server device 106 in order to replace an advertisement playitem, as compared with Embodiment 1. Consequently, the playback device of Embodiment 2 can reduce the burdens on the server device 106, the network 105, and the like.

### Embodiment 3

An optical disc playback device according to Embodiment 3 of the present invention differs from the playback device according to Embodiment 2 with respect to the features of service objects, the process of playing back a playlist, and the process of replacing an advertisement playitem. In particular, the differences are as follows: (1) during the process of playing back a playlist, the history of changes in playback states is recorded each time the states are changed, and (2) the process of replacing an advertisement playitem includes a step of selecting a content representing a new advertisement depending on the history of the playback states having been recorded. The other features of the playback device according to Embodiment 3 are similar to those according to Embodiment 2, such as the data structure of the BD-ROM disc to be played back, the hardware structure of the playback device, the functional units of the system LSI, and the structures of the playback control unit and the system target decoder. Accordingly, the features of Embodiment 3 different from those of Embodiment 2 will be described below. Details of the features similar to those of Embodiment 2 can be found in the description about Embodiment 1 or 2.

### <Features of Service Object>

A service object file according to Embodiment 3 of the present invention includes an application management table (see FIG. 4C) specifying, besides the BD-J application programs described in Embodiment 2, BD-J application programs that cause the Java virtual machine 36A to execute the following processes: (1) a process of monitoring audio/subtitle settings during playback of a playlist, and recording details of a change in the settings into the history of playback states (hereinafter, referred to as “playback history”) each time the change is detected; (2) a process of presuming a user profile based on the playback history to determine user preferences each time the playback of a playlist is completed; and (3) a process of using the user preferences to select a pair of a clip information file and an AV clip file of a new advertisement to be downloaded.

In the playback control unit 1033 according to Embodiment 3 of the present invention (see FIGS. 18 and 20), the DVD-like module 35 or the Java module 36 a calls a service object according to the current dynamic scenario information DS, and in that case, the Java module 36 performs the following processes according to the service object, in addition to the processes described in Embodiment 2: (1) a process of monitoring the player register 38 during the playback of a playlist and recording details of a change in the values of the SPRs representing audio/subtitle settings each time the playback control engine 37 changes the values; (2) a process of presuming the user profile based on the playback history to determine user preferences each time the playback of a playlist is completed; and (3) a process of using the user preferences to select and request a new advertisement AV clip to be downloaded from the server device 106 at the start of playing back the next playlist.

### <Process of Playlist Playback>

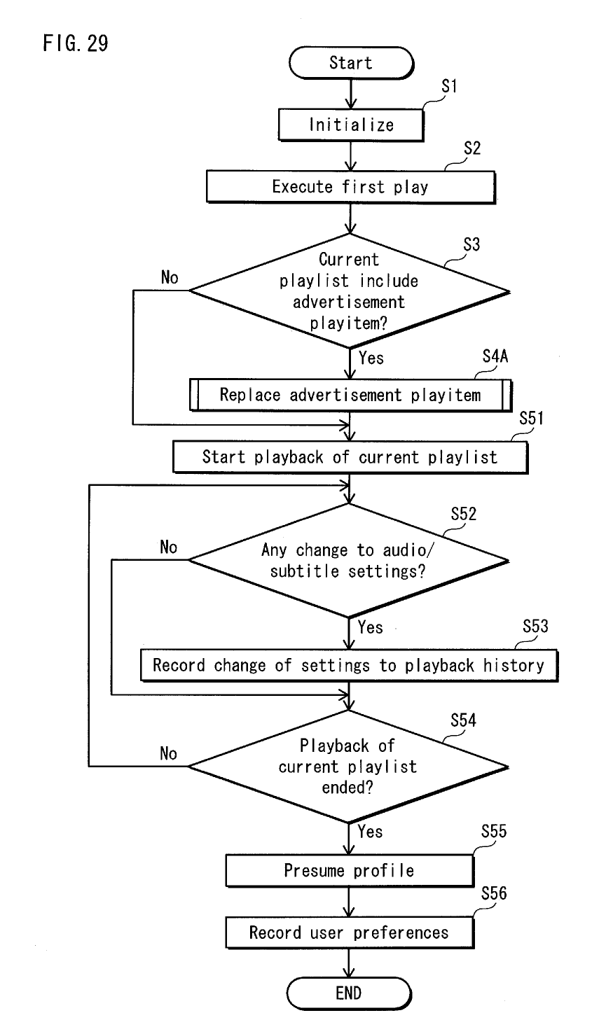

FIG. 29 is a flowchart of the process of playing back a playlist by the playback device 102 according to Embodiment 3. The following describes the process of playing back a playlist in the order of the steps shown in FIG. 29. In FIG. 29, steps similar to those shown in FIG. 22 are marked with the same reference signs and details of such steps can be found in the description of Embodiment 1.

Step S1: When the playback device 102 is switched on, the system LSI 1000 starts initialization of the functional units 1001, 1010 and 1030 (see FIG. 18). In particular, the playback control unit 1033 prepares run-time environments for application programs.

Step S2: When receiving a notification indicating that the BD-ROM disc 101 is inserted into the BD-ROM drive 102A, the playback control unit 1033 responds to the notification with causing the virtual file control unit 1032 to read the index file IF from the BD-ROM disc 101. Furthermore, the playback control unit 1033 causes the virtual file control unit 1032 to read a BD-J object file from the BD-ROM disc 101; the BD-J object file is specified in the first play of the index table contained in the index file IF. In the playback control unit 1033 then, the Java module 36 executes BD-J application programs according to the BD-J object for the first play described in the BD-J object file.

Furthermore, the Java module 36 causes the virtual file control unit 1032 to read a current playlist file and service object file from the BD-ROM disc 101, according to the BD-J object for the first play. Then, the Java module 36 executes BD-J application programs according to the service object.

Step S3: The Java module 36 causes the playback control engine 37 to detect a playlist mark of the mark type “advertisement” from current static scenario information SS. If such a playlist mark is detected, the Java module 36 determines that the current playlist includes an advertisement playitem, and then moves the process to Step S4A. If such a playlist mark is not detected, the Java module 36 determines that the current playlist does not include any advertisement playitem, and then moves the process to Step S51.

Step S4A: The Java module 36 replaces the current playlist with a new playlist. The new playlist differs from the current playlist in that a new advertisement playitem is substituted for the original advertisement playitem. Furthermore, the new advertisement playitem varies with the user preferences. Details of Step S4A will be described later.

Step S51: The Java module 36 causes the playback control engine 37 to start playback of the current playlist. The playback control engine 37 plays back the current playlist in a manner similar to that in Step S5 according to Embodiment 1.

Step S52: During the playback of the current playlist, the Java module 36 monitors the player register 38. If detecting a change in the values of the SPRs relating to the audio/subtitle settings in the player register 38, the Java module 36 moves the process to Step S53. If any change is not detected, the Java module 36 moves the process to Step S54.

Note that the audio/subtitle settings are changed in the following procedure. When the operation unit 102E accepts an operation by a user to change the audio or subtitle settings during playback of the current playlist, the operation unit 102E sends a notification INT indicating the user operation to the user event processing unit 1031 (see FIGS. 16 and 18). The changes in the audio and subtitle settings include, for example, a change in language from Japanese to English, and a change in method of coding audio data from AC-3 to Dolby (registered trademark) Lossless. In response to the notification INT, the user event processing unit 1031 issues a request UO to the playback control unit 1033 to instruct the unit to change the audio or subtitle settings. In the playback control unit 1033, the module manager 33 passes the request UO to the Java module 36, and in response to the request UO, the Java module 36 instructs the playback control engine 37 to change the audio or subtitle settings (see FIG. 20). In response to the instruction, the playback control engine 37 refers to the values of the relevant SPRs in the player register 38. Furthermore, the playback control engine 37 uses the values of the SPRs to select audio, PG, or text subtitle streams (hereinafter, collectively referred to as “audio or other streams”) from among elementary streams that are registered in the stream selection table of the current playitem information and allowed to be played back by both the playback device 102 and the display device 103. Next, the playback control engine 37 updates the stream selection numbers of audio or other streams to be decoded, which are indicated by the SPRs, with the stream selection numbers of the selected elementary streams. Additionally, the playback control engine 37 sets the PID filter in the system target decoder 1013 to select the PIDs described in the stream identification information about the selected elementary streams as the PIDs of the audio or other streams to be decoded. As a result, audio or other streams to be decoded by the system target decoder 1013 are changed.

Step S53: The Java module 36 reads details of the change in the audio/subtitle settings from the values of the SPRs updated by the playback control engine 37, and then records the details of the change into the playback history.

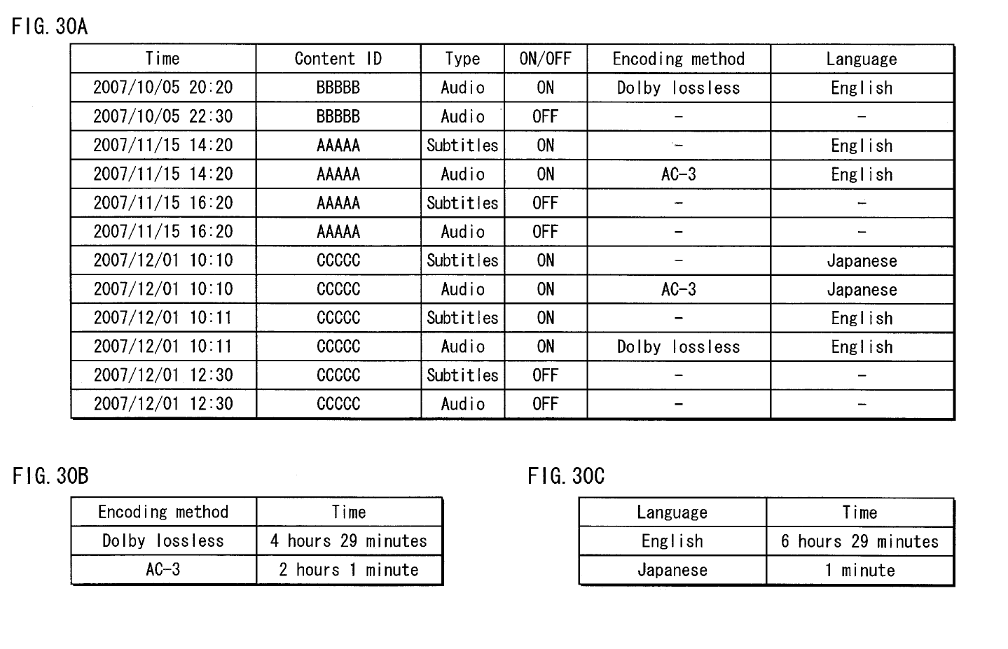

FIG. 30A is a table showing the contents of the playback history. As shown in FIG. 30A, the playback history has a record of each change in the audio/subtitle settings; the record indicates, as well as the time of the setting change, the content ID of a current playlist, the distinction of the setting type between audio and subtitles, the distinction between “ON” and “OFF” that respectively represent the start and end of playback with the changed settings, the coding method of audio data in the changed settings, and the language used in the changed audio/subtitle settings. For example, the playback history shown in FIG. 30A indicates that, from 20:20 to 22:30 on Oct. 5, 2007, a playlist with the content ID “BBBBB” was played back with the selection of the Dolby lossless method as the method of encoding audio data, and English as the language of voices/subtitles.

Step S54: The Java module 36 checks whether playback of the current playlist has ended or not. If the playback has ended, the Java module 36 moves the process to Step S55. If the playback has not yet ended, the Java module 36 returns the process to Step S52.

Step, S55: The Java module 36 presumes a user profile based on the playback history to determine user preferences. More specifically, the Java module 36 first calculates the total usage times of individual types of elements constituting the audio/subtitle settings recorded in the playback history. Next, the Java module 36 determines a combination of the elements of the types having the longest total usage times, as user preferences.

FIG. 30B is a table showing a total usage time of each method of encoding audio data calculated from the playback history shown in FIG. 30A. As shown in FIG. 30B, the “Dolby lossless” method is found to have the longest usage time among the methods of encoding audio data recorded in the playback history shown in FIG. 30A. On the other hand, FIG. 30C is a table showing a total usage time of each language of voices/subtitles calculated from the same playback history. As shown in FIG. 30C, “English” is found to have the longest usage time among the languages of voices/subtitles recorded in the playback history shown in FIG. 30A. From the calculation results shown in FIGS. 30B and 30C, the Java module 36 determines the combination of the “Dolby lossless method” and “English” as user preferences.

Step S56: The Java module 36 records user preferences into the local storage 1021; the user preferences have been determined as a result of presuming a user profile. In the example shown in FIGS. 30A-C, the combination of the “Dolby lossless method” and “English” is recorded as user preferences.

Note that each record in the playback history may be deleted therefrom after a period of a predetermined time length, e.g., three months, has elapsed since the record was entered. In addition, the records in the playback history that are used to calculate total usage times for presuming a user profile may be limited to those that were entered within a predetermined time period, for example, from three months ago to this point. These conditions may be defined by service objects.

### <Process of Replacing Advertisement Playitem in Step S4>

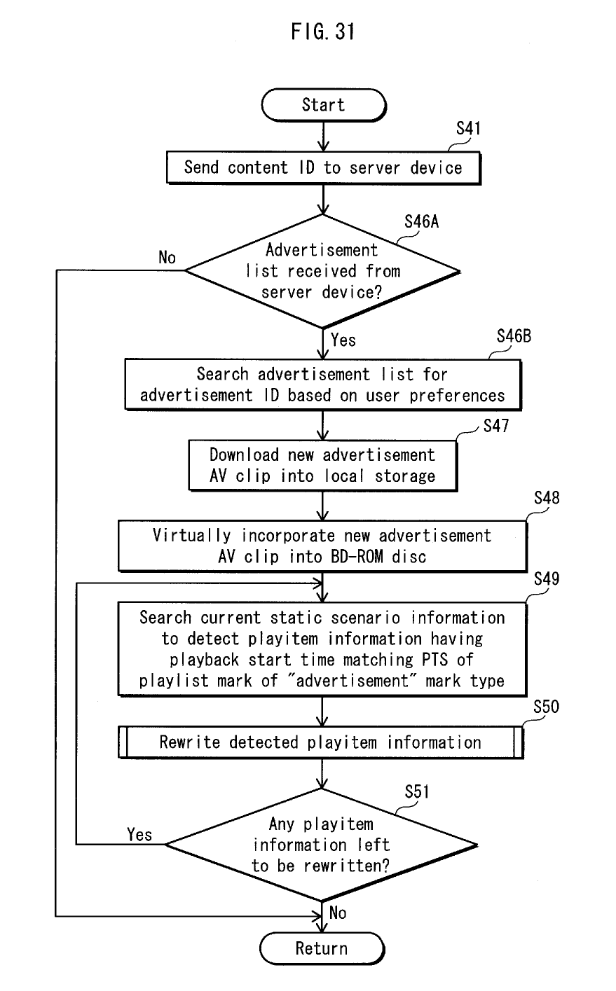

FIG. 31 is a flowchart of the process of replacing an advertisement playitem, according to Embodiment 3 of the present invention.

Step S41: Similarly to Step S41 according to Embodiment 1 of the present invention, the Java module 36 first reads the content ID 422 (see FIG. 3) from the index file IN held in the module manager 33. Next, the Java module 36 sends the content ID to the server device 106 located on the network 105, via the network interface 102D (see FIG. 16).

Step S46A: The server device 106 stores two or more AV clips each representing a new advertisement per variety of AV content. That is, two or more pairs of a clip information file and an AV clip file are stored per AV content. Each AV clip is individually assigned with an advertisement ID. Similarly to Embodiment 2, each AV clip is attached with information used for rewriting the stream selection table included in the playitem information or with information indicating that the corresponding AV clip file has a network attribute. Furthermore, in the case where one AV clip includes a plurality of pairs of a clip information file and an AV clip file, the AV clip is attached with information indicating the allocation of the receptive pairs to the main path and a sub-path.

A plurality of AV clips of a variety of types belonging to one AV content are classified for different user preferences. The server device 106 manages, in an advertisement list, the correspondence between the advertisement IDs of AV clips and sets of user preferences. In general, a different advertisement list is provided for a different AV content. The server device 106 manages the advertisement lists each in association with the content ID of a corresponding AV content.

Upon receipt of a content ID from the Java module 36, the server device 106 retrieves the advertisement list associated with the received content ID and sends the advertisement list to the Java module 36 as a response to the content ID. On the other hand, if the advertisement list associated with the received content ID is not found, the server device 106 returns information indicative of the situation to the Java module 36 in response to the content ID.

After transmitting a content ID, the Java module 36 waits for a response from the server device 106. Upon receipt of the response, the Java module 36 judges whether the contents of the response is the new advertisement list. If the contents of the response is an advertisement list, the Java module 36 moves onto Step S46B. On the other hand, if the contents of the response is not an advertisement list, the Java module 36 ends the process of replacing playitem representing an advertisement.

Step S46B: The Java module 36 reads the user preferences from the local storage 1021. Furthermore, the Java module 36 searches the advertisement list received from the server device 106 for the advertisement ID associated with the read user preferences.

Steps S47-S51 are exactly the same as the corresponding steps of Embodiment 2.

Step S47: The Java module 36 transmits the advertisement ID found in Step S46B to the server device 106. Upon receipt of the advertisement ID, the server device 106 transmits the AV clip of a new advertisement associated with the received advertisement ID to the playback device 102. The Java module 36 causes the network interface 102D to receive the AV clip of the new advertisement and store the received AV clip into the local storage 1021.

Step S48: The Java module 36 causes the virtual file control unit 1032 to virtually incorporate the AV clip of the new advertisement into the BD-ROM disc 101. At this point, if the virtual package has been created already, the Java module 36 causes the virtual file control unit 1032 to incorporate the AV clip of the new advertisement into the existing virtual package.

Step S49: The Java module 36 detects playitem information indicating the playback start time matching the PTS of the detected playlist mark from the current static scenario information SS. That is, the playitem information representing an advertisement is detected in this step.

Step S50: The Java module 36 rewrites the playitem information detected in Step S49.

Step S51: The Java module 36 causes the playback control engine 37 to further detect another playlist mark having mark type indicating “advertisement” from the playlist mark information read from the current static scenario information SS in Step S3. If such a playlist mark is detected, the Java module 36 goes back to Step S49. If such a playlist mark is not detected, the Java module 36 ends the process of replacing an advertisement playitem.

Through Steps S41-S51 described above, the current playlist information is rewritten on the static scenario memory 21, so that the playitem information representing an original advertisement is replaced by playitem information representing a new advertisement. Consequently, in the playback section indicated by the playitem information, an AV clip file representing a new advertisement is played back from the local storage 1021, rather than the AV clip file recorded on the BD-ROM disc 101. As a result, similarly to Embodiment 1, instead of the group of frames F1 representing the original advertisement to be played back in the playback section PI2 for the playitem PL shown in FIG. 25A, the group of frames F2 representing a new advertisement is played back in the same playback section P12 for the playlist NPL shown in FIG. 25B. In the manner described above, the playitem representing the original advertisement is replaced by a playitem representing a new advertisement.

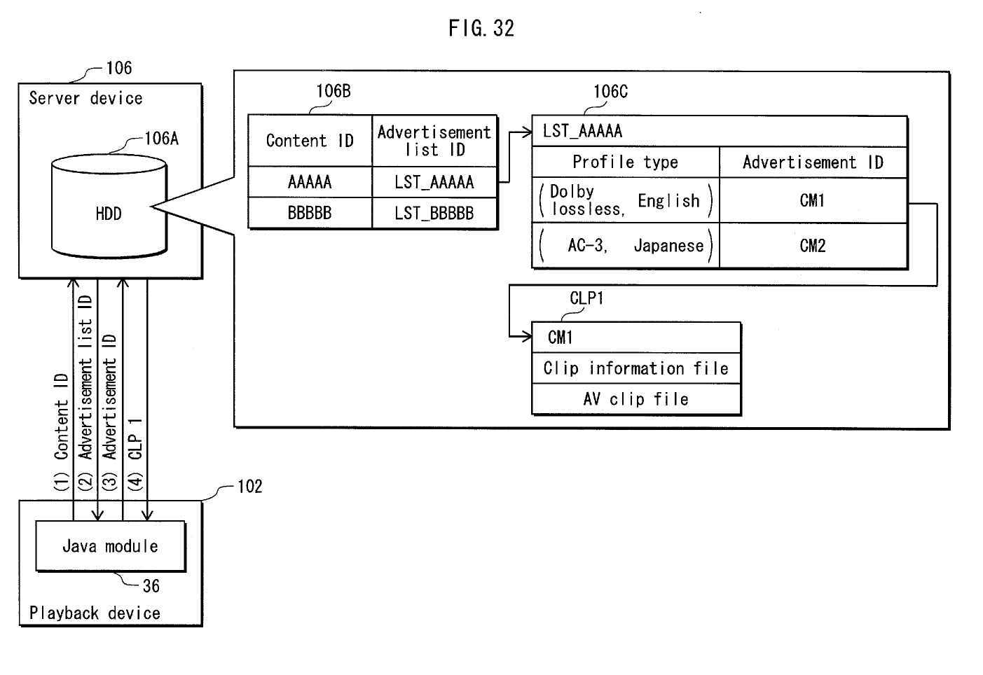

FIG. 32 is a schematic view showing the data exchange between the server device 106 and the playback device 102 performed through Steps S41-S47. Through Steps S41-S47, data is exchanged between the server device 106 and the playback device 102 in the order of (1)-(4) shown in FIG. 32.

As shown in FIG. 32, the server device 106 stores in advance a correspondence table 106B, advertisement lists 106C, and new advertisement AV clips CLP1 in a built-in HDD 106A. The correspondence table 106B shows the correspondence between content IDs and advertisement list IDs. Each advertisement list ID indicated in the correspondence table 106B is associated with one of the advertisement lists 106C. The advertisement list 106C associates one advertisement ID with each of the options of user preferences that can be determined by the playback device 102, i.e., each of the possible combinations of elements constituting audio/subtitle settings. Each advertisement ID is associated with an advertisement AV clip CLP1, i.e., a pair of a clip information file and an AV clip file.

(1) In Step S41, the Java module 36 of the playback device 102 transmits a content ID, for example, indicating “AAAAA,” to the server device 106.

(2) In Step S46A, the server device 106 receives the content ID “AAAAA,” and then retrieves the advertisement list ID “LST_AAAAA” associated with the content ID “AAAAA” from the correspondence table 106B. Furthermore, the server device 106 reads and sends the advertisement list 106C associated with the ID “LST_AAAAA” from the HDD 106A to the Java module 36 as a response to the content ID “AAAAA”. The Java module 36 then receives the advertisement list 106C from the server device 106.

(3) In Step S46B, the Java module 36 reads user preferences from the local storage 1021, and then retrieves the advertisement ID associated with the user preferences from the advertisement list 106C. For example, if the user preferences indicate the combination of the “Dolby lossless method” and “English” determined from the calculation results shown in FIGS. 30B and 30C, the Java module 36 retrieves the advertisement ID “CM1” associated with the combination from the advertisement list 106C.

(4) In Step S47, the Java module 36 transmits the advertisement ID “CM1” retrieved in Step S46B to the server device 106. The server device 106 receives the advertisement ID “CM1” and then transmits the new advertisement AV clip CLP1 associated with the advertisement ID “CM1”, from the HDD 106A to the playback device 102. The Java module 36 causes the network interface 102D to receive and store the new advertisement AV clip CLP1 into the local storage 1021.

For example, if the user preferences indicate the combination of the “Dolby lossless method” and “English”, the advertisement ID “CM1” associated with the combination is assigned to, for example, an English advertisement for a home theater system supporting the Dolby lossless method. Such an advertisement is expected to be of high interest to users viewing the AV content with the content ID “AAAAA” by using the playback device 102. This can further reduce the risk that insertion of the advertisement disturbs the entertaining effect of the AV content. Furthermore, the advertisement can achieve a further improved advertising effect.

Similarly to Embodiment 2, the playback device according to Embodiment 3 of the present invention is enabled, as set forth above, to play back a playitem representing a new advertisement in the playback section for a playitem representing an advertisement embedded in the playlist recorded on the BD-ROM disc 101. Furthermore, the playback device according to Embodiment 3 is enabled to presume the user preferences from the playback history and to select a playitem representing a new advertisement depending on the preferences. Consequently, the undesirable possibility can be further reduced as compared with Embodiment 2, that an advertisement of low interest to the viewer is presented at the time of playlist playback. As a result, the playback device of the present embodiment achieves to further reduce the risk that insertion of an advertisement leads to loss of entertainment of the playlist. Furthermore, the playback device of the present embodiment also achieves to improve the advertising effect.

### Embodiment 4

An authoring device according to Embodiment 4 of the present invention creates a disc image 204 (see FIG. 2) and an update kit 205 (see FIG. 17A) of the BD-ROM disc 101 of Embodiment 1. The authoring device is installed, for example, at a movie creation studio and used for editing playlists for a movie and the like from material data such as video, audio and subtitles to generate a disc image of a media package from the playlists. The disc image is a group of files 204 to be recorded in the volume area 202 of a media package as shown in FIG. 2.

### <Generating Disc Image 204 of BD-ROM Disc 101>

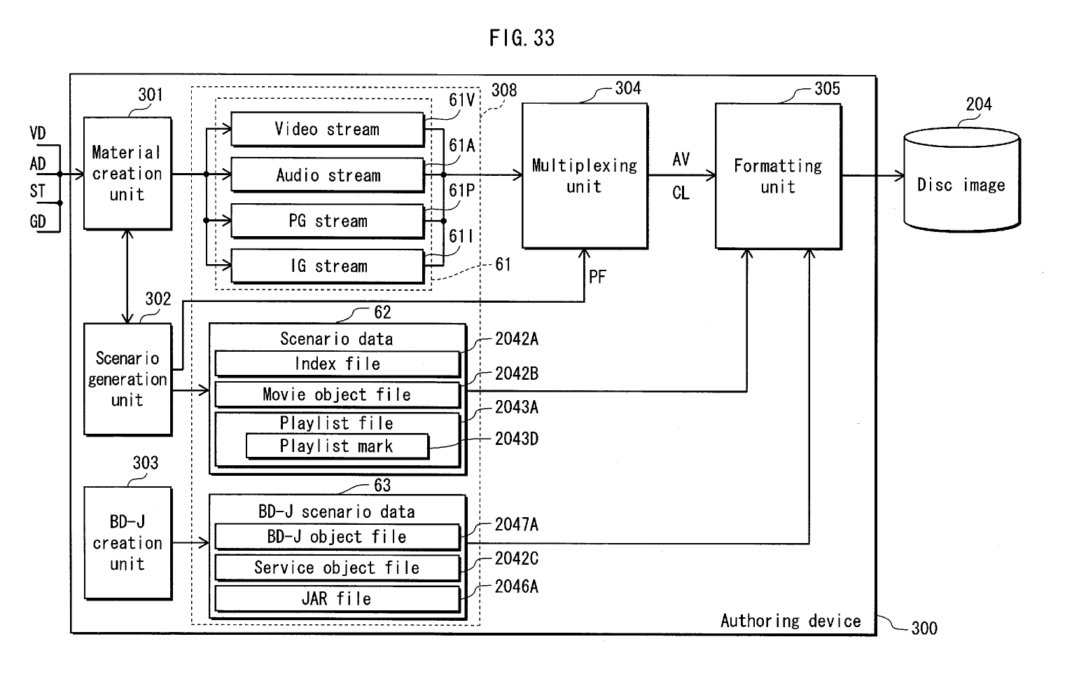

FIG. 33 is a functional block diagram of an authoring device 300 according to Embodiment 4 of the present invention. The functional units shown in FIG. 33 specifically relate to generation of the disc image 204 of the BD-ROM disc 101. As shown in FIG. 33, the authoring device includes a material creation unit 301, a scenario generation unit 302, a BD-J creation unit 303, a storage unit 308, a multiplexing unit 304 and a formatting unit 305. The functional units 301-305 and 308 are integrated into a single system LSI or a plurality of system LSIs.

The material creation unit 301 edits the elementary stream 61 from pieces of material data VD, AD, ST and GD, such as video, audio and subtitles, according to user operations. The elementary stream 61 represents video, audio, subtitles or interactive display of a sequence of playlists and includes at least one of a video stream 61V, an audio stream 61A, a PG stream 61P, and an IG stream 611. The elementary stream 61 may additionally include a text subtitle stream. Each elementary stream 61 is stored in the storage unit 308.

In particular, the material creation unit 301 generates the video stream 61V by compressing uncompressed image data VD in the bitmap format, with the coding method such as MPEG-4 AVC or MPEG-2. In the case the editing involves picture-in-picture, the video stream 61V includes both the primary and secondary video streams. On the other hand, the material creation unit 301 generates the audio stream 61A by compressing uncompressed audio data AD in the LPCM format, with the coding method such as AC-3. In the case where the editing involves mixing of two or more different types of audio data, the audio stream 61A includes both the primary and secondary audio streams. Furthermore, the material creation unit 301 generates a subtitle information file of the image data ST representing subtitles, according to user operations. The subtitle information file defines, for example, the position and timing for displaying the image data ST on a screen and the display effects, such as fade-in/out, to be added to the image data ST. The material creation unit 301 generates the PG stream 61P by combining the subtitle information file with the image data ST. The material creation unit 301 also generates a menu file for the image data GD such as bitmap data representing a GUI menu, according to user operations. The menu file defines, for example, a change to be caused responsive to a user operation to a button presented on a menu and the display effect to be added to the menu. The material creation unit 301 generates the IG stream 611 by companioning the menu file with the image data GD.

The scenario generation unit 302 generates scenario data 62 according to the editing information of the elementary stream 61 and also to user operations and stores the scenario data 62 to the storage unit 308. The scenario data 62 includes the index file 2042A, movie object file 2042B and playlist file 2043A shown in FIG. 2.

The editing information of each elementary stream 61 includes information about details of the editing by the material creation unit 301 and the attribute information of the elementary stream 61. For example, for the video stream 61V, the editing information includes the indication of a coding method and the correspondence relation between the primary and secondary video streams in picture-in-picture. For the audio stream 61A, the editing information includes the indication of a coding method and the correspondence relation between the primary and secondary audio streams. For the PG stream 61P, the editing information includes the subtitle information file. For the IG stream 611, the editing information includes the menu file. The editing information further includes the indication of times at which the respective portions of the elementary stream 61 are to be played in the playback time of the series of playlists. Each playback time is specified by a user operation.

At the time of generating the playlist file 2043A, the scenario generation unit 302 generates the stream selection table (see FIG. 13A) and the playlist mark 2043D (see FIG. 15A) of each piece of playitem information according to user operations. In particular, the playlist marks 2043D includes a playlist mark indicating the playback start time of an advertisement playitem.

The scenario generation unit 302 generates a parameter file PF and passes the parameter file PF to the multiplexing unit 304. The parameter file PF includes the identification information and attribute information of one or more of the elementary streams 61 to be multiplexed into the same AV clip file, out of the elementary streams 61 stored in the storage unit 308.

The BD-J creation unit 303 provides a programming environment for a BD-J application to the user. That is, the BD-J creation unit 303 receives requests relating to programming from the user via GUI and generates source codes of the BD-J application program. The BD-J creation unit 303 organizes the resulting source codes into the BD-J scenario data 63 and stores the BD-J scenario data 63 into the storage unit 308. The BD-J scenario data 63 includes the BD-J object file 2047A, service object file 2042C and JAR file 2046A shown in FIG. 2.

The multiplexing unit 304 reads the video stream 61V, audio stream 61A, PG stream 61P and IG stream 611 from the storage unit 308 based on the parameter file PF and multiplexes the read streams into an MPEG-2TS stream to generate the AV clip file AV. At the same time, the multiplexing unit 304 generates the clip information file CL for the AV clip file AV in the following steps. First, the multiplexing unit 304 generates the mark table information 442 (see FIGS. 9 and 11A). Specifically, the multiplexing unit 304 detects I-pictures or IDR-pictures from the video stream 61V, associates the PTS of each detected picture with the first SPN of the AV clip file AV in which the picture is stored, and associates each pair of PTS and SPN with one clip mark ID 442D to register as one clip mark information 442A. In the case where the AV clip file AV includes two video streams, namely the primary video stream and the secondary video stream, the multiplexing unit 304 simultaneously generates different pieces of mark table information for the respective video streams. Next, the multiplexing unit 304 generates the stream attribute information 441 (see FIGS. 9 and 10) indicating the attribute of each elementary stream multiplexed into the same AV clip file AV, based on the parameter file PF. The multiplexing unit 304 subsequently generates clip information file CL by combining the mark table information with the stream attribute information.

The formatting unit 305 reads the scenario data 62 and the BD-J scenario data 63 from the storage unit 308 and receives the pair of the AV clip file AV and the clip information file CL from the multiplexing unit 304. Furthermore, the formatting unit 305 converts the data into UDF files and organizes the resulting files into the directory structure 204 shown in FIG. 2. As a result, the disc image 204 for the BD-ROM disc 101 is generated. Thereafter, the disc image 204 is converted into data of a suitable format and recorded onto the a master of the BD-ROM disc 101. Furthermore, the master is pressed to produce the BD-ROM discs 101.

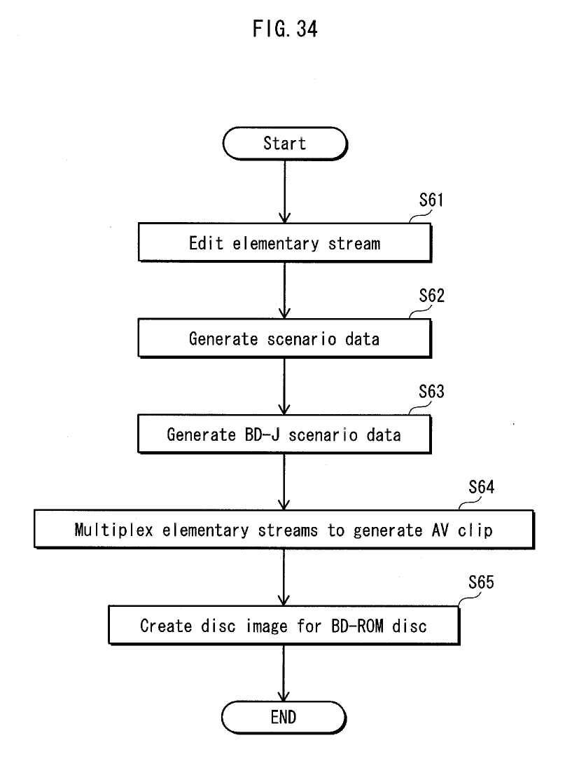

FIG. 34 is a flowchart of a method for generating the disc image 204.

Step S61: The material creation unit 301 edits one or more elementary streams 61 according to user operations.

Step S62: The scenario generation unit 302 generates the scenario data 62 according to the editing information of the elementary streams 61 and also to user operations. When generating the playlist file 2043A, the scenario generation unit 302 generates the stream selection table and playlist marks for each piece of playitem information according to user operations. In particular, the playlist marks includes a playlist mark indicating the playback start time of a playitem representing an advertisement. Furthermore, the scenario generation unit 302 passes the parameter file PF to the multiplexing unit 304.

Step S63: The BD-J creation unit 303 generates a BD-J application program according to user operations and then further generates BD-J scenario data 63.

Step S64: The multiplexing unit 304 reads the elementary streams 61 from the storage unit 308 based on the parameter file PF and multiplexes the read elementary streams 61 to generate an AV clip file AV. At the same time, the multiplexing unit 304 generates the clip information file CL for the AV clip file AV.

Step S65: The formatting unit 305 reads the scenario data 62 and the BD-J scenario data 63 from the storage unit 308 and receives the pair of the AV clip file AV and the clip information file CL from the multiplexing unit 304. Then the formatting unit 305 organizes the resulting data into the directory structure 204 shown in FIG. 2. As a result, the disc image 204 for the BD-ROM disc 101 is generated.

### <Generation of Update Kit 205>

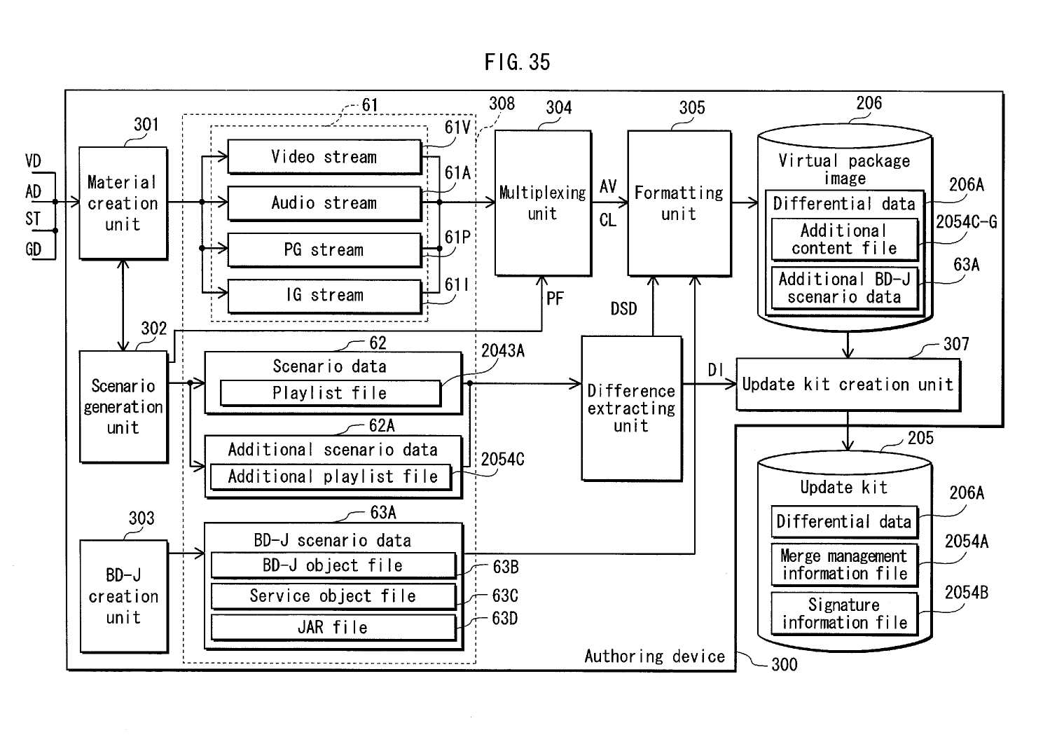

FIG. 35 is a functional block diagram of the authoring device 300 showing the functional units relating to the generation of the update kit 205. In addition to the functional units shown in FIG. 33, the functional units shown in FIG. 35 further include a difference extracting unit 306 and an update kit generation unit 307. The functional units 306 and 307 are integrated into the same system LSI with the other functional units or a separate system LSI from the other functional units.

The material creation unit 301 edits one or more additional elementary streams from the pieces of material data VD, AD, ST and GD, according to user operations. Each additional elementary stream represents the video, audio, subtitles or interactive display of a playitem to be added to the playlist recorded in the original disc image 204 or to replace a playitem embedded in playlist recorded in the original disc image 204. The additional elementary stream includes at least one of a video stream, audio stream, PG stream, and IG stream. The elementary stream 61 may additionally include a text subtitle stream. At least part of the additional elementary streams belongs to a playitem representing an advertisement to replace an advertisement embedded in the original disc 204. The additional elementary streams may further include a stream to be used for playback of a sub-path, in addition to a stream to be used for playback of the main path. The editing process of additional elementary streams are the same as the editing process of elementary streams 61 recorded in the original disc image 204. The additional elementary streams 61 are stored in the storage unit 308, together with the original elementary streams 61.

The scenario generation unit 302 generates additional scenario data 62A according to the editing information of the additional elementary streams and also to user operations, and stores the additional scenario data 62A to the storage unit 308. Similarly to the original scenario data 62, the additional scenario data 62A includes an index file, a movie object file and a playlist file. Note that the editing information of an additional elementary stream differs from the editing information of the elementary stream 61 in that the original advertisement is replaced by a new advertisement. Consequently, the additional scenario data 62A differs from the original scenario data 62 in the same respect.

In particular, the playlist file is equivalent to the additional playlist file 2054C shown in FIG. 17A. The additional playlist file 2054C differs from the original playlist file 2043A shown in FIG. 12 in that the playlist information is rewritten to replace the playitem information representing an original advertisement with playitem information representing a new advertisement. The playitem information representing a new advertisement differs from the playitem information representing the original advertisement with respect to the reference clip information and the stream selection table. More specifically, the stream selection table is overwritten with a stream selection table relating to the additional elementary stream. The stream selection table may additionally include the stream path information indicating a sub-path ID. In that case, the additional playlist file 2054C includes the sub-path identified by that sub-path ID and also includes sub-playitem information for the new advertisement. Furthermore, the additional playlist file 2054C includes a playlist mark indicating the playback start time of the playitem representing the new advertisement. The playback start time is set to be equal to the playback start time of the playitem representing the original advertisement.

The scenario generation unit 302 generates an additional parameter file MPF and passes the additional parameter file MPF to the multiplexing unit 304. The additional parameter file MPF includes the identification information and attribute information of each additional elementary stream to be multiplexed into the same AV clip file with the elementary streams 61 stored in the storage unit 308.

In accordance with user operations, the BD-J creation unit 303 generates source codes of a BD-J application program to be used after a virtual package is created. Furthermore, the BD-J creation unit 303 organizes the resulting source codes into the additional BD-J scenario data 63A and stores the additional BD-J scenario data 63A into the storage unit 308. The additional BD-J scenario data 63A includes a BD-J object file 63B, a service object file 63C and a JAR file 63D.

The multiplexing unit 304 reads the additional elementary streams from the storage unit 308 based on the additional parameter file MPF and multiplexes the additional elementary streams into an MPEG-2TS stream to generate an additional AV clip file MAV. At the same time, the multiplexing unit 304 generates an additional clip information file MCL for the additional AV clip file AV.

The difference extracting unit 306 compares the original scenario data 62 and the additional scenario data 62A stored in the storage unit 308 to extract difference DSD between the respective pieces of scenario data. The difference DSD includes, for example, a file not included in the original scenario data 62 and a file that is partially different from a file included in the scenario data 62. In particular, the difference DSD includes a file equivalent to the additional playlist file 2054C. Furthermore, the difference extracting unit 306 generates identification information DI of each file included in the difference DSD and passes the resulting identification information DI to the update kit creation unit 307.

The formatting unit 305 reads the additional BD-J scenario data 63A from the storage unit 308, receives the pair of additional AV clip file MAV and the additional clip information file MCL from the multiplexing unit 304, and receives the difference DSD of the scenario data from the difference extracting unit 306. Furthermore, the formatting unit 305 converts the data into UDF files and organizes the resulting files into the directory structure 206 shown in FIG. 19. As a result, the disc image 206 for the virtual package is generated. In the disc image 206, only the differential data 206A, which is different from the files included in the original disc image 204, has an entity, whereas the same files as the files included in the original disc image 204 are only recorded as path information to the files. The differential data 206A is composed of an additional AV clip file MAV, an additional clip information file MCL, difference DSD of scenario data, and additional BD-J scenario data 63A. Especially, the additional AV clip file MAV, the additional clip information file MCL, and the difference DSD of scenario data correspond to the additional content files 2054C-2054G shown in FIG. 17A.

The update kit creation unit 307 generates the merge management information file 2054A shown in FIG. 17B, using the identification information DI received from the difference extracting unit 306. Furthermore, the update kit creation unit 307 encrypts the hash of the merge management information file 2054A with a secrete key of the provider of the AV content recorded in the original disc image 204 to generate an electronic signature of the provider, and then generates a signature information file 2054B using the electronic signature. Subsequently, the update kit creation unit 307 organizes the differential data 206A, merge management information file 2054A and signature information file 2054B into the directory structure 205 shown in FIG. 17A, with the use of the Org ID of the provider and the Disc ID of the BD-ROM disc 101. The group of files 205 organized in the directory structure is used as the update kit 205.

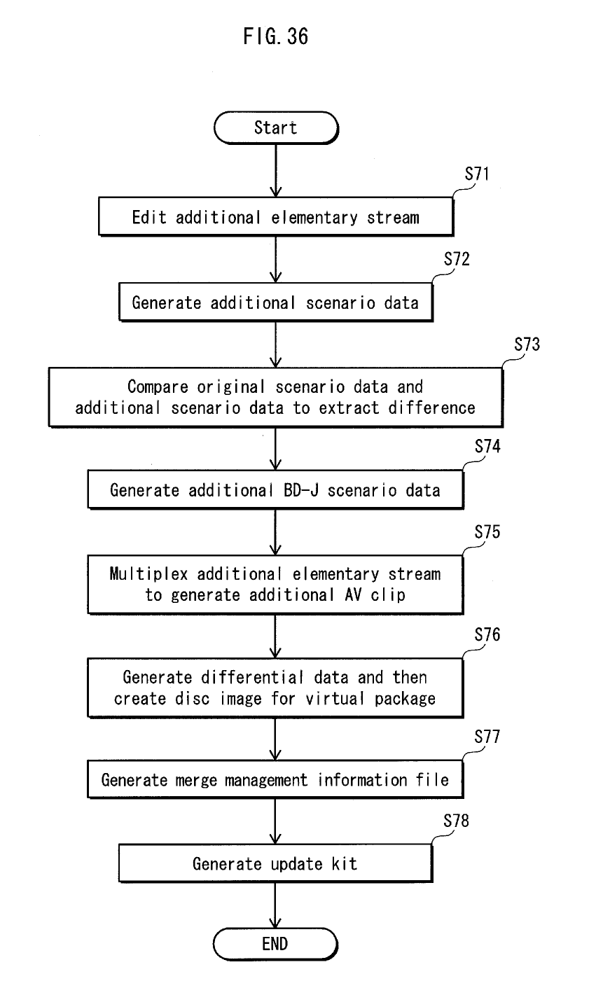

FIG. 36 is a flowchart of a method for generating the update kit 205.

Step S71: The material creation unit 301 edits one or more additional elementary streams according to user operations. In particular, the additional elementary streams include an elementary stream to be incorporated into a playitem representing a new advertisement.

Step S72: The scenario generation unit 302 generates the additional scenario data 62A according to the editing information of the additional elementary stream and also to user operations. In particular, regarding the additional playlist file 2054C, the playlist information is rewritten so that the playitem information representing the original advertisement is replaced by playitem information representing a new advertisement. The scenario generation unit 302 generates an additional parameter file MPF and passes the additional parameter file MPF to the multiplexing unit 304.

Step S73: The difference extracting unit 306 compares the original scenario data 62 with the additional scenario data 62A stored in the storage unit 308 to extract difference DSD between the respective pieces of scenario data. Furthermore, the difference extracting unit 306 generates identification information DI of each file included in the difference DSD and passes the resulting identification information DI to the update kit creation unit 307.

Step S74: In accordance with user operations, the BD-J creation unit 303 generates a BD-J application program to be used after a virtual package is created and further generates additional BD-J scenario data 63A.

Step S75: The multiplexing unit 304 reads the additional elementary streams from the storage unit 308 based on the additional parameter file MPF and multiplexes the additional elementary streams to generate a pair of an additional AV clip file MAV and national clip information file MCL.

Step S76: The formatting unit 305 converts, into UDF files, the additional BD-J scenario data 63A, the pair of the additional AV clip file MAV and the additional clip information file MCL, and the difference DSD of scenario data. Furthermore, the formatting unit 305 organizes the resulting files into the directory structure 206 in the virtual package and generate the disc image 206 for the virtual package.

Step S77: The update kit creation unit 3507 generates the merge management information file 2054A, using the identification information DI received from the difference extracting unit 306. Furthermore, the update kit creation unit 307 encrypts the merge management information file 2054A to generate an electronic signature of the provider and then generates a signature information file 2054B using the electronic signature.

Step S78: The update kit creation unit 307 organizes the differential data 206A, the merge management information file 2054A, and the signature information file 2054B into the directory structure 205, with the user of the Org ID of the provider and the Disc ID of the BD-ROM disc 101. In the manner described above, the update kit 205 is generated.

### <Supplemental>

(1) According to Embodiments 1-3 of the present invention, the service object file has a common structure with the BD-J object file, and the service object has a common format with the BD-J object 471 shown in FIG. 4B. Additionally, the service object file may have a common structure with the movie object file. In that case, the service object file generally includes a plurality of service objects, similarly to the movie object file 2042B shown in FIG. 4A. In addition, each service object includes a sequence of navigation commands, similarly to the movie objects 42B1 and 42B2 shown in FIG. 4A. The respective navigation commands are assigned with functions similar to the functions of the service object according to Embodiments 1-3 described above. In the playback control unit 1033, the DVD-like module 35 sequentially executes the navigation commands to realize the same functions as the service object according to Embodiments 1-3 described above.

(2) According to Embodiments 1-3 of the present invention described above, a playlist mark included in a playlist file is used as information indicating the position of an advertisement playitem in the playlist. Alternatively, the information may be included in a clip information file or service object file.

(3) According to Embodiments 2 and 3 of the present invention, a new service object file may be downloaded together with a JAR file if necessary in Step S47 and the service object file is virtually incorporated into the BD-ROM disc 101 in Step S48. In that case, the new service object file may include information to be attached to the AV clip of the new advertisement, such as information used to rewrite the stream selection table included in the playitem information. Such information is duly used by executing Step S49 and the subsequent steps according to the service object included in the new service object file.

(4) According to Embodiment 3 of the present invention, the settings of audio/subtitles are recorded in the playback history. In the process of presuming profile, in addition, the combination of the audio/subtitles which results in the longest total usage hours is determined as the user preferences. However, the playback history may be kept to record the settings other than the audio/subtitles settings as long as the settings can be identified from the player register 38. In addition, the user preferences may be determined based on the conditions different from the conditions described above. For example, the combination of the audio/subtitles settings having been used the largest number of times may be determined as the user preferences. The conditions of information items to be recorded in the playback history and the conditions for determining the user preferences in presuming the profile may be changed depending on the service object. Especially, in the case of modification described in (2) above, the service object file can be updated for each playback of a playlist, so that the conditions can be changed for each playback of a playlist.

(5) According to Embodiment 3 of the present invention, the playback device 102 receives the advertisement list 106C from the server device 106 and selects a new advertisement content from the advertisement list 106C based on the user preferences. Alternatively, the playback device 102 may send information about the user preferences to the server device 106 together with the content ID, so that the server device 106 selects an AV clip of a new advertisement based on the user preferences.

(6) According to Embodiment 3 of the present invention, similarly to Embodiment 2, an AV clip of a new advertisement is downloaded from the server device 106 together with necessary information attached to the AV clip and virtually incorporated into the BD-ROM disc 101. Alternatively, similarly to Embodiment 1, an update kit including a playitem representing a new advertisement may be downloaded from the server device 106 and a virtual package may be generated from the update kit, so that the playitem representing the new advertisement is incorporated into the virtual package.

(7) According to Embodiment 4 of the present invention, an AV clip of a new advertisement and information attached to the AV clip may be generated, instead of generating the update kit 205. Examples of information to be attached to the AV clip includes: information used to rewrite the stream selection table in the playitem information; information indicating an AV clip file having the network attribute; information indicating the allocation of the pairs of a clip information file and an AV clip file to the main path and a sub-path; information used to add a sub-path to the playlist information; and information used to add or overwrite sub-playitem information to a sub-path existing in the playlist information. Such information may be generated based on the additional parameter file MPF generated by the scenario generation unit 302 and the difference DSD extracted by the difference extracting unit 306 from the respective pieces of scenario data 62 and 62A.

### INDUSTRIAL APPLICABILITY

The present invention relates to a technology for playing back a playlist from an optical disc. As described above, when playing back a playlist from an optical disc, the present invention allows playback of a desired playitem in the playback section of a playitem representing an advertisement embedded in the playlist. Consequently, the present invention clearly has industrial applicability.

### REFERENCE SIGNS LIST

PL Original playlist
NPL New playlist
PI1, PI2 and PI3 Playback section of each playlist
CLP1 AV clip file storing playitem of original advertisement
CLP2 AV clip file storing playitem of new advertisement
P1, P2, P3 and P4 Portions of AV clip file to be played back in respective playback sections
IN Playback start time of playback section PI2
OUT Playback end time of playback section PI2
PLM1 Playlist mark
F1 Group of frames representing original advertisement
F2 Group of frames representing new advertisement

1-13. (canceled)

14. A playback device comprising:
an acquiring unit operable to acquire first advertisement data from an external source;
a reading unit operable to read a digital stream and playback path information from a recording medium, the playback path information including playback section information indicating at least one playback section of the digital stream;
a judging unit operable to judge whether or not the read digital stream includes second advertisement data;
a playback path replacing unit operable to rewrite playback section information included in the read playback path information when the judging unit judges affirmatively, so that the playback section information indicating a playback section of the second advertisement data is changed to indicate a playback section of the first advertisement data; and
a playback unit operable to play back the digital stream by using the playback path information, and when the playback path information is rewritten, play back the first advertisement data by using the rewritten playback path information.

15. The playback device according to claim 14, wherein
the judging unit makes the judgment according to a bytecode program, and
the playback path replacing unit performs the rewriting of the playback section information according to a bytecode program.

16. The playback device according to claim 14, wherein
the playback path information includes mark information indicating that a playback section of the digital stream is of the second advertisement data, and
the judging unit makes the judgment with reference to the mark information.

17. The playback device according to claim 14, further comprising:
a communications unit operable to communicate with a server device located on a network;
a playback history recording unit operable to record a history of states of playback of digital streams by the playback unit; and
a profile presuming unit operable to presume user preferences from the history of playback states, wherein
the acquiring unit uses the communications unit to download advertisement data depending on the user preferences from the server device and holds the downloaded data as the first advertisement data.

18. The playback device according to claim 17, wherein
the acquiring unit uses the communications unit to download a list of advertisement data from the server device and selects advertisement data depending on the user preferences from the list.

19. A playback method comprising the steps of:
acquiring first advertisement data from an external source;
reading a digital stream and playback path information from a recording medium, the playback path information including playback section information indicating at least one playback section of the digital stream;
judging whether or not the read digital stream includes second advertisement data;
rewriting playback section information included in the read playback path information when the judgment is affirmative, so that the playback section information indicating a playback section of the second advertisement data is changed to indicate a playback section of the first advertisement data; and
playing back the digital stream by using the playback path information, and when the playback path information is rewritten, playing back the first advertisement data by using the rewritten playback path information.

20. A program to cause a playback device to execute the steps of:
acquiring first advertisement data from an external source;
reading a digital stream and playback path information from a recording medium, the playback path information including playback section information indicating at least one playback section of the digital stream;
judging whether or not the read digital stream includes second advertisement data;
rewriting playback section information included in the read playback path information when the judgment is affirmative, so that the playback section information indicating a playback section of the second advertisement data is changed to indicate a playback section of the first advertisement data; and
playing back the digital stream by using the playback path information, and when the playback path information is rewritten, playing back the first advertisement data by using the rewritten playback path information.

21. A recording medium readable by a playback device and having a program recorded thereon, the program comprising the steps of:
acquiring first advertisement data from an external source;
reading a digital stream and playback path information from a recording medium, the playback path information including playback section information indicating at least one playback section of the digital stream;
judging whether or not the read digital stream includes second advertisement data;
rewriting playback section information included in the read playback path information when the judgment is affirmative, so that the playback section information indicating a playback section of the second advertisement data is changed to indicate a playback section of the first advertisement data; and
playing back the digital stream by using the playback path information, and when the playback path information is rewritten, playing back the first advertisement data by using the rewritten playback path information.

22. An integrated circuit to be incorporated into a playback device for playing back a digital stream, the integrated circuit comprising:
an acquiring unit operable to acquire first advertisement data from an external source;
a reading unit operable to read a digital stream and playback path information from a recording medium, the playback path information including playback section information indicating at least one playback section of the digital stream;
a judging unit operable to judge whether or not the read digital stream includes second advertisement data;
a playback path replacing unit operable to rewrite playback section information included in the read playback path information when the judging unit judges affirmatively, so that the playback section information indicating a playback section of the second advertisement data is changed to indicate a playback section of the first advertisement data; and
a playback unit operable to play back the digital stream by using the playback path information, and when the playback path information is rewritten, play back the first advertisement data by using the rewritten playback path information.
